(19) United States
(12) Patent Application Publication
(10) Pub. No.: US 2007/0250377 A1
(43) Pub. Date: Oct. 25, 2007

(54) Performance analysis support system

(75) Inventors: James J. Hill JR., Los Altos, CA (US); James L. Fuller JR., San Jose, CA (US); Thomas J. Moore, Denver, CO (US)

Correspondence Address: William C. Milks, III, 401 Florence Street, Palo Alto, CA, 94301, US

(73) Assignee: Proofpoint Systems, Inc.

(21) Appl. No.: 11/398,846

(22) Filed: Apr. 5, 2006

(51) Int. Cl. G06F 11/34

(52) U.S. Cl. 705/11

(57) ABSTRACT

A performance analysis support system is disclosed that provides one or more recommended solutions of a performance improvement project to management and the expected improvement benefit of each solution. The performance analysis support system guides a user through a detailed, consistent analysis process, helping organizational leaders accurately diagnose critical performance or productivity issues. Then, the performance analysis support system estimates the personnel and equipment requirements, time, costs, and return on investment associated with each solution generated based on the analysis results. In addition, the performance analysis support system provides management immediate access to ongoing and past analyses.

### BACKGROUND OF THE INVENTION

1. Field of the Invention

The present invention relates generally to analyzing problems related to the performance of organizations and individuals in achieving the objectives of a business or other enterprise and, more particularly, to a system and method for performance analysis support used in addressing one or more perceived performance issues and formulating goals and prospective solutions. One preferred embodiment of the present invention provides an integrated system and method for performance analysis support for analyzing an identified performance problem, establishing a goal to be achieved to correct the problem, obtaining the needed personnel approvals at predetermined stages of the analysis, documenting the analysis, and allocating budgetary requirements associated with the analysis and implementation of a prospective solution.

2. References

[1] Gilbert, T. F., (1996). “Human Competence: Engineering Worthy Performance.” Silver Spring, Md.: ISPI.

[2] Fuller, J. L., (1997). Managing Performance Improvement Projects. San Francisco: Jossey-Bass/Pfieffer.

[3] Stolovitch, H. D. and Keeps, E. J. (Eds.) (1999). Handbook of Human Performance Technology: Improving Individual and Organizational Performance Worldwide. San Francisco: Jossey-Bass/Pfieffer.

3. Description of the Prior Art

Today, one of the most intractable obstacles facing any enterprise is dealing with perceived problems that impede the enterprise from achieving a stated or desired objective. In many instances, the problems arise from the enterprise faltering in the performance of one or more tasks, projects, and/or programs that cause the shortfall in achieving the objective.

The typical approach to addressing the problem is for the enterprise to retain a consultant to evaluate the problematic situation and recommend one or more potential solutions for adoption by the enterprise. There are various disadvantages to this approach.

First, the consultant is typically not familiar with the problem to be addressed. The consultant has a steep learning curve to climb to become sufficiently apprised of the problem, and the consultant is dependent on the information provided by the enterprise to evolve an understanding of the problem. The process of supplying the information is intrusive and costly in terms of time spent by personnel employed by the enterprise in generating data for the consultant.

Second, certain personnel employed by the enterprise are typically assigned to work with the consultant. There is a risk that not all persons needed for approval for implementation of a solution are involved in the process. Additionally, not all enterprise personnel who are potentially needed to effect a recommended solution, or who are impacted by the potential solution, are involved in the process. Also, the consultant may not appreciate the intangible aspects of the problem, such as the culture of the enterprise or the ripple effect that a potential solution may have on other operations of the enterprise.

Third, there is typically no process to monitor participation of personnel at the enterprise that will be involved in implementing a recommended solution or impacted by the solution. If support from personnel who are not involved in the analysis process is absent, then the ultimate success of a potential solution is questionable.

Fourth, the procedures executed by the consultant do not necessarily comply with the procedures of the enterprise such as verification of the sources of data accessed to support the recommended solution. Verification of data after the fact is a time consuming and expensive procedure.

Fifth, to most businesses, performance analysis is a “black hole” with very little visibility into the status and progress of the process. This problem represents one of the largest challenges for modern enterprises to increase performance and manage costs.

The issue of understanding and managing the performance analysis process has been a daunting problem itself. To date, the problem has not been adequately addressed.

Thus, for all these reasons, it would be desirable to provide a performance analysis support system and method which overcome the above limitations and disadvantages of conventional approaches and provide an objective approach that can assess a performance problem and provide a recommended solution. It is to this end that the present invention is directed. The various embodiments of the present invention have many advantages over conventional approaches by providing solutions to identifying and selecting from among potential goals, obtaining the commitment of enterprise personnel needed to implement a potential solution, and providing procedures to require verification of data used to support a recommended solution.

### SUMMARY OF THE INVENTION

One embodiment of the performance analysis support system and method in accordance with the present invention provides many advantages over conventional approaches, which make the performance analysis support system and method in accordance with the present invention more useful to management decision makers. One embodiment of the present invention provides a performance analysis support system and method that provide one or more recommended solutions of a performance improvement project to management and the expected improvement benefit of each solution. A preferred embodiment of the performance analysis support system and method in accordance with the present invention guides a user through a detailed, consistent analysis process, helping organizational leaders accurately diagnose critical performance or productivity issues. Then, the performance analysis support system and method of the present invention estimate the personnel and equipment requirements, time, costs, and return on investment associated with each solution generated based on the analysis results. In addition, the performance analysis support system and method of the present invention provide management immediate access to ongoing and past analyses.

One embodiment of the performance analysis support system and method in accordance with the present invention provides a unique solution for enabling enterprises to perform a project initiation phase to document an original request for improvement of a performance issue; to set up an analysis team; to prioritize business goals that will be directly impacted when the performance issue is successfully addressed; to specify a specific purpose (for example, to decrease or increase a metric) to address the performance issue; and to establish a project intent to deal with the performance issue. The step of prioritizing the business goals preferably includes aligning business goals with strategic goals, and the step of specifying a purpose preferably assures that the purpose is consistent with aligned business and strategic goals. The performance analysis support system and method in accordance with a preferred embodiment of the present invention then enable enterprises to complete a readiness assessment of personnel and of the organization during a readiness review phase; and to collect supporting data used in the performance analysis during a performance analysis phase. The performance analysis support system and method then complete a cause analysis of the performance issue to determine the problem, to determine barriers to successful performance, to define a set of one or more recommended solutions to address the performance issue associated with the problem and its impact benefit to the organization, and preferably to document and validate the solutions during a cause analysis phase.

In accordance with a preferred embodiment of the performance analysis support system and method in accordance with the present invention, after a performance scoping matrix summary describing the complexity of the problem is provided in which project intent is defined during the project initiation phase, the performance analysis support system and method analyze organizational impact, cost of the problem, and priority placed on the project by the requestor/initiating sponsor, and once this is completed, assess the readiness of the project team to make the change by assessing the sponsors, stakeholders, and organization during the readiness review phase. Then, the performance analysis support system and method of the present invention preferably assess project risk and create a risk mitigation plan; estimate a budget; project constraints that may prevent performing an analysis; and estimate costs for performing the analysis during the readiness review phase. The performance analysis support system and method of the present invention orchestrate determining data used in the performance analysis.

In accordance with an exemplary implementation of the preferred embodiment of the present invention, a performance analysis support system and method provide a comprehensive, web-based software tool that helps an enterprise effectively analyze and improve its most critical performance issues. Preferably, the performance analysis support system and method are not loaded on a client computer, and no other software component or plug-in is loaded on the client computer. The only requirement is that the application is accessed via the Web or Internet using Microsoft Internet Explorer 6.0+ or equivalent. Another implementation of the performance analysis support system in accordance with the present invention is a hosted application developed with active server page(s) (ASP) code together with a SQL server database hosted and accessed via Microsoft Internet Explorer 6.0 or greater and available for Microsoft XP® and other operating systems. The performance analysis support system is easily integrated into existing environments and works with a centralized management layer. Using a step-by-step approach, the performance analysis support system and method guide enterprise personnel to the results needed through an orderly, repeatable process. The enterprise moves easily from project inception and team alignment, through data collection and assessment, to a validated set of solution recommendations.

The performance analysis support system preferably comprises built-in calculators, on-demand guidance, and graphic displays of automatically generated measures and metrics to aid making the decisions that are needed, quickly and effectively. Auto-generated reports and summaries are provided for easy distribution to team members and executives. The performance analysis support system and method standardize a complex process and provide easy access to critical information from across the organization with a single mouse click. Additionally, the performance analysis support system and method directly lead to dramatic reductions in the costs often associated with major improvement initiatives. Throughout the analysis, the performance analysis support system and method in accordance with the present invention provide unprecedented visibility into the actual progress of the process.

Accordingly, the preferred embodiment of the performance analysis support system in accordance with the present invention provides a tool for objectively analyzing a performance issue and generating a proposed solution. The performance analysis support system and method in accordance with one embodiment of the present invention facilitate the collection of the data needed to analyze the performance issue defined in the project intent. The performance analysis support system preferably uses an expert reasoning subsystem to evaluate the data to arrive at a recommended set of potential solutions.

The performance analysis support system in accordance with a preferred embodiment of the present invention provides a tool to be used by executives, project stakeholders, and project managers for enabling a real-time view, preferably at a highly granular level, into the status of the project. Preferably, the tool also pinpoints which members of the team and what processes are causing a project to deviate from the planned completion date and/or budget. This allows a highly accurate projection of when the analysis will finish, what ultimate budget is to be expected, and how each milestone of the project is progressing. The performance analysis support system and method in accordance with a preferred embodiment of the present invention provide an aggregate view.

Advantageously, the performance analysis support system and method in accordance with the present invention expertly reason a recommended solution of a performance problem in business terms. The performance analysis support system and method facilitate positive communications with, and responsive management of, local and remote problem solvers, in real time without interfering in the effort of the team.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is a diagram of an exemplary performance analysis support system in accordance with a preferred embodiment of the present invention implemented on a personal computer coupled to a Web or Internet server;

FIG. 2 is a diagram of an exemplary performance analysis support system in accordance with an alternative embodiment of the present invention implemented on a local area network personal computer;

FIGS. 3-99 are screens displayed during operation of the performance analysis support system and method in accordance with a preferred embodiment of the present invention. More particularly:

FIG. 3 is a dashboard screen displayed by the performance analysis support system in accordance with the embodiment of the present invention shown in FIG. 1;

FIG. 4 is an “Introduction” screen displayed during a “Project Initiation” phase by the performance analysis support system in accordance with the embodiment of the present invention shown in FIG. 1;

FIG. 5 is a “Project Team Setup” screen displayed during the “Project Initiation” phase by the performance analysis support system in accordance with the embodiment of the present invention shown in FIG. 1;

FIG. 6 is a “Team Member Setup” screen displayed when a new team member is created from a link on the “Project Team Setup” page shown in FIG. 5 during the “Project Initiation” phase by the performance analysis support system in accordance with the embodiment of the present invention shown in FIG. 1;

FIG. 7 is a “Goal Alignment” screen displayed during the “Project Initiation” phase by the performance analysis support system in accordance with the embodiment of the present invention shown in FIG. 1;

FIG. 8 is a “Project Setup” screen displayed during the “Project Initiation” phase by the performance analysis support system in accordance with the embodiment of the present invention shown in FIG. 1;

FIG. 9 is an “Impacted Business or Organizational Goals” screen displayed during the “Project Initiation” phase by the performance analysis support system in accordance with the embodiment of the present invention shown in FIG. 1;

FIG. 10 is a “Strategic Goals” screen displayed during the “Project Initiation” phase by the performance analysis support system in accordance with the embodiment of the present invention shown in FIG. 1;

FIG. 11 is a “Prioritized Business or Organizational Goals” screen displayed during the “Project Initiation” phase by the performance analysis support system in accordance with the embodiment of the present invention shown in FIG. 1;

FIG. 12 is a “Project Purpose” screen displayed during the “Project Initiation” phase by the performance analysis support system in accordance with the embodiment of the present invention shown in FIG. 1;

FIG. 13 is a “Current Performance Measure” screen displayed during the “Project Initiation” phase by the performance analysis support system in accordance with the embodiment of the present invention shown in FIG. 1;

FIG. 14 is a “Desired Performance Improvement” screen displayed during the “Project Initiation” phase by the performance analysis support system in accordance with the embodiment of the present invention shown in FIG. 1;

FIG. 15 is an “Impact of Current Situation” screen displayed during the “Project Initiation” phase by the performance analysis support system in accordance with the embodiment of the present invention shown in FIG. 1;

FIG. 16 is a “Corporate Scorecard” screen displayed during the “Project Initiation” phase by the performance analysis support system in accordance with the embodiment of the present invention shown in FIG. 1;

FIG. 17 is a “Project Scope” screen displayed during the “Project Initiation” phase by the performance analysis support system in accordance with the embodiment of the present invention shown in FIG. 1;

FIG. 18 is a “Performer Group and Dates for Analysis” screen displayed during the “Project Initiation” phase by the performance analysis support system in accordance with the embodiment of the present invention shown in FIG. 1;

FIG. 19 is an “Organizational Impact” screen displayed during the ” Project Initiation” phase by the performance analysis support system in accordance with the embodiment of the present invention shown in FIG. 1;

FIG. 20 is a “Scoping Matrix” screen displayed during the “Project Initiation” phase by the performance analysis support system in accordance with the embodiment of the present invention shown in FIG. 1;

FIG. 21 is a “Relative Project Priority” screen displayed during the “Project Initiation” phase by the performance analysis support system in accordance with the embodiment of the present invention shown in FIG. 1;

FIG. 22 is a “Project Priority Matrix” screen displayed during the “Project Initiation” phase by the performance analysis support system in accordance with the embodiment of the present invention shown in FIG. 1;

FIG. 23 is a “Financials” screen displayed during the “Project Initiation” phase by the performance analysis support system in accordance with the embodiment of the present invention shown in FIG. 1;

FIG. 24 is a “Performance Cost Estimates” screen displayed during the “Project Initiation” phase by the performance analysis support system in accordance with the embodiment of the present invention shown in FIG. 1;

FIG. 25 is a “Conclusions” screen displayed during the “Project Initiation” phase by the performance analysis support system in accordance with the embodiment of the present invention shown in FIG. 1;

FIG. 26 is a “Summary” screen displayed during the “Project Initiation” phase by the performance analysis support system in accordance with the embodiment of the present invention shown in FIG. 1;

FIG. 27 is an “Approvals” screen displayed during the “Project Initiation” phase by the performance analysis support system in accordance with the embodiment of the present invention shown in FIG. 1;

FIG. 28 is an “Introduction” screen displayed during a “Readiness Review” phase by the performance analysis support system in accordance with the embodiment of the present invention shown in FIG. 1;

FIG. 29 is a “Readiness Assessments” screen displayed during the “Readiness Review” phase by the performance analysis support system in accordance with the embodiment of the present invention shown in FIG. 1;

FIG. 30 is a “Sponsors” screen displayed during the “Readiness Review” phase by the performance analysis support system in accordance with the embodiment of the present invention shown in FIG. 1;

FIG. 31 is a “Stakeholders” screen displayed during the “Readiness Review” phase by the performance analysis support system in accordance with the embodiment of the present invention shown in FIG. 1;

FIG. 32 is an “Organization” screen displayed during the “Readiness Review” phase by the performance analysis support system in accordance with the embodiment of the present invention shown in FIG. 1;

FIG. 33 is a “Risk Assessments” screen displayed during the “Readiness Review” phase by the performance analysis support system in accordance with the embodiment of the present invention shown in FIG. 1;

FIG. 34 is a “Data Source Risks” screen displayed during the “Readiness Review” phase by the performance analysis support system in accordance with the embodiment of the present invention shown in FIG. 1;

FIG. 35 is a “Project Risks” screen displayed during the “Readiness Review” phase by the performance analysis support system in accordance with the embodiment of the present invention shown in FIG. 1;

FIG. 36 is a “Risk Reduction Plans” screen displayed during the “Readiness Review” phase by the performance analysis support system in accordance with the embodiment of the present invention shown in FIG. 1;

FIG. 37 is a “Project Constraint Details” screen displayed during the “Readiness Review” phase by the performance analysis support system in accordance with the embodiment of the present invention shown in FIG. 1;

FIG. 38 is a “Financials” screen displayed during the “Readiness Review” phase by the performance analysis support system in accordance with the embodiment of the present invention shown in FIG. 1;

FIG. 39 is an “Estimated Budget” screen displayed during the “Readiness Review” phase by the performance analysis support system in accordance with the embodiment of the present invention shown in FIG. 1;

FIG. 40 is an “Estimated Cost of Analysis” screen displayed during the “Readiness Review” phase by the performance analysis support system in accordance with the embodiment of the present invention shown in FIG. 1;

FIG. 41 is a “Conclusions” screen displayed during the “Readiness Review” phase by the performance analysis support system in accordance with the embodiment of the present invention shown in FIG. 1;

FIG. 42 is a “Proof of Concept” screen displayed during the “Readiness Review” phase by the performance analysis support system in accordance with the embodiment of the present invention shown in FIG. 1;

FIG. 43 is a “Summary” screen displayed during the “Readiness Review” phase by the performance analysis support system in accordance with the embodiment of the present invention shown in FIG. 1;

FIG. 44 is an “Approvals” screen displayed during the “Readiness Review” phase by the performance analysis support system in accordance with the embodiment of the present invention shown in FIG. 1;

FIG. 45 is an “Introduction” screen displayed during a “Performance Analysis” phase by the performance analysis support system in accordance with the embodiment of the present invention shown in FIG. 1;

FIG. 46 is a “Data Source Details” screen displayed during the “Performance Analysis” phase by the performance analysis support system in accordance with the embodiment of the present invention shown in FIG. 1;

FIG. 47 is a “Performance Cost” screen displayed during the “Performance Analysis” phase by the performance analysis support system in accordance with the embodiment of the present invention shown in FIG. 1;

FIG. 48 is a “Conclusions” screen displayed during the “Performance Analysis” phase by the performance analysis support system in accordance with the embodiment of the present invention shown in FIG. 1;

FIG. 49 is a “Summary” screen displayed during the “Performance Analysis” phase by the performance analysis support system in accordance with the embodiment of the present invention shown in FIG. 1;

FIG. 50 is an “Approvals” screen displayed during the “Performance Analysis” phase by the performance analysis support system in accordance with the embodiment of the present invention shown in FIG. 1;

FIG. 51 is an “Introduction” screen displayed during a “Cause Analysis” phase by the performance analysis support system in accordance with the embodiment of the present invention shown in FIG. 1;

FIG. 52 is an “Actual Budget” screen displayed during the “Cause Analysis” phase by the performance analysis support system in accordance with the embodiment of the present invention shown in FIG. 1;

FIG. 53 is a “Task Analysis” screen displayed during the “Cause Analysis” phase by the performance analysis support system in accordance with the embodiment of the present invention shown in FIG. 1;

FIG. 54 is a “Define Tasks” screen displayed during the “Cause Analysis” phase by the performance analysis support system in accordance with the embodiment of the present invention shown in FIG. 1;

FIG. 55 is a “Prioritize Tasks” screen displayed during the “Cause Analysis” phase by the performance analysis support system in accordance with the embodiment of the present invention shown in FIG. 1;

FIG. 56 is a “Verify Tasks” screen displayed during the “Cause Analysis” phase by the performance analysis support system in accordance with the embodiment of the present invention shown in FIG. 1;

FIG. 57 is a “Supporting Data” screen displayed when validating data is to be entered using a link on the “Verify Tasks” page shown in FIG. 56 during the “Cause Analysis” phase by the performance analysis support system in accordance with the embodiment of the present invention shown in FIG. 1;

FIG. 58 is a “Define Steps” screen displayed during the “Cause Analysis” phase by the performance analysis support system in accordance with the embodiment of the present invention shown in FIG. 1;

FIG. 59 is an “Order Steps” screen displayed during the “Cause Analysis” phase by the performance analysis support system in accordance with the embodiment of the present invention shown in FIG. 1;

FIG. 60 is a “Verify Steps” screen displayed during the “Cause Analysis” phase by the performance analysis support system in accordance with the embodiment of the present invention shown in FIG. 1;

FIG. 61 is a “First Level Assessment” screen displayed during the “Cause Analysis” phase by the performance analysis support system in accordance with the embodiment of the present invention shown in FIG. 1;

FIG. 62 is a “Second Level Assessment” screen displayed during the “Cause Analysis” phase by the performance analysis support system in accordance with the embodiment of the present invention shown in FIG. 1;

FIG. 63 is a “Deficiency Review” screen displayed during the “Cause Analysis” phase by the performance analysis support system in accordance with the embodiment of the present invention shown in FIG. 1;

FIG. 64 is a “Deficiency Priority” screen displayed during the “Cause Analysis” phase by the performance analysis support system in accordance with the embodiment of the present invention shown in FIG. 1;

FIG. 65 is a “Barrier Identification” screen displayed during the “Cause Analysis” phase by the performance analysis support system in accordance with the embodiment of the present invention shown in FIG. 1;

FIG. 66 is a “Barrier Analysis” screen displayed during the “Cause Analysis” phase by the performance analysis support system in accordance with the embodiment of the present invention shown in FIG. 1;

FIG. 67 is a “Verify Barriers” screen displayed during the “Cause Analysis” phase by the performance analysis support system in accordance with the embodiment of the present invention shown in FIG. 1;

FIG. 68 is a “Solutions” screen displayed during the “Cause Analysis” phase by the performance analysis support system in accordance with the embodiment of the present invention shown in FIG. 1;

FIG. 69 is an “Estimated Solutions” screen displayed during the “Cause Analysis” phase by the performance analysis support system in accordance with the embodiment of the present invention shown in FIG. 1;

FIG. 70 is a “Solutions Impact Benefit” screen displayed during the “Cause Analysis” phase by the performance analysis support system in accordance with the embodiment of the present invention shown in FIG. 1;

FIG. 71 is a “Conclusions” screen displayed during the “Cause Analysis” phase by the performance analysis support system in accordance with the embodiment of the present invention shown in FIG. 1;

FIG. 72 is a “Summary” screen displayed during the “Cause Analysis” phase by the performance analysis support system in accordance with the embodiment of the present invention shown in FIG. 1;

FIG. 73 is an “Approvals” screen displayed during the “Cause Analysis” phase by the performance analysis support system in accordance with the embodiment of the present invention shown in FIG. 1;

FIG. 74 is an “Estimated vs. Actual” screen displayed in association with a “Results Tracker” by the performance analysis support system in accordance with the embodiment of the present invention shown in FIG. 1;

FIG. 75 is a “Summary” screen displayed in association with the “Results Tracker” by the performance analysis support system in accordance with the embodiment of the present invention shown in FIG. 1;

FIG. 76 is a “Data Entry Forms” screen displayed by the performance analysis support system in accordance with the embodiment of the present invention shown in FIG. 1;

FIG. 77 is a “Participant Information” form provided by the performance analysis support system in accordance with the embodiment of the present invention shown in FIG. 1;

FIG. 78 is a “Goal Alignment” form provided by the performance analysis support system in accordance with the embodiment of the present invention shown in FIG. 1;

FIG. 79 is a “Project Scope” form provided by the performance analysis support system in accordance with the embodiment of the present invention shown in FIG. 1;

FIG. 80 is a “Financials” form provided by the performance analysis support system in accordance with the embodiment of the present invention shown in FIG. 1;

FIG. 81 is a “Sponsorship Assessment” form provided by the performance analysis support system in accordance with the embodiment of the present invention shown in FIG. 1;

FIG. 82 is a “Stakeholder Assessment” form provided by the performance analysis support system in accordance with the embodiment of the present invention shown in FIG. 1;

FIG. 83 is an “Organization Readiness Assessment” form provided by the performance analysis support system in accordance with the embodiment of the present invention shown in FIG. 1;

FIG. 84 is a “Project Risks Assessment” form provided by the performance analysis support system in accordance with the embodiment of the present invention shown in FIG. 1;

FIG. 85 is a “Data Sources” form provided by the performance analysis support system in accordance with the embodiment of the present invention shown in FIG. 1;

FIG. 86 is an “Analysis Summary” form provided by the performance analysis support system in accordance with the embodiment of the present invention shown in FIG. 1;

FIG. 87 is an “Approval Status” report provided by the performance analysis support system in accordance with the embodiment of the present invention shown in FIG. 1;

FIG. 88 is a “Constraints” report provided by the performance analysis support system in accordance with the embodiment of the present invention shown in FIG. 1;

FIG. 89 is a “Corporate Scorecard” report provided by the performance analysis support system in accordance with the embodiment of the present invention shown in FIG. 1;

FIG. 90 is an “Impact” report provided by the performance analysis support system in accordance with the embodiment of the present invention shown in FIG. 1;

FIG. 91 is a “List of Projects” report provided by the performance analysis support system in accordance with the embodiment of the present invention shown in FIG. 1;

FIG. 92 is a “Project Scope” report provided by the performance analysis support system in accordance with the embodiment of the present invention shown in FIG. 1;

FIG. 93 is a “Project Status” report provided by the performance analysis support system in accordance with the embodiment of the present invention shown in FIG. 1;

FIG. 94 is a “Selected Solution Breakout” report provided by the performance analysis support system in accordance with the embodiment of the present invention shown in FIG. 1;

FIG. 95 is a “Strategic Alignment” report provided by the performance analysis support system in accordance with the embodiment of the present invention shown in FIG. 1;

FIG. 96 is a “Support” report provided by the performance analysis support system in accordance with the embodiment of the present invention shown in FIG. 1;

FIG. 97 is a “Help” screen displayed by the performance analysis support system in accordance with the embodiment of the present invention shown in FIG. 1;

FIG. 98 is a “Consulting” screen displayed by the performance analysis support system in accordance with the embodiment of the present invention shown in FIG. 1;

FIG. 99 is a “Messages” screen displayed by the performance analysis support system in accordance with the embodiment of the present invention shown in FIG. 1; and

FIG. 100 illustrates the relationship between identified barriers and solutions recommended by the performance analysis support system and method in accordance with one embodiment of the present invention.

### DETAILED DESCRIPTION OF THE PREFERRED EMBODIMENTS

The present invention is particularly applicable to computer software to support projects for the analysis of performance problems, and it is in this context that the preferred embodiment of the present invention will be described. It will be appreciated, however, that the performance analysis support system and method in accordance with the present invention have greater utility, since they may be used for other types of analysis projects not specifically described herein. Accordingly, the embodiment of the performance analysis support system and method in accordance with the present invention as described in connection with a problem performance analysis is an example only, and is not intended to limit the scope of the present invention to analysis of performance problems, as the principles of the present invention apply generally to monitoring the progress of analysis for any type of project. Generally, the performance analysis support system and method in accordance with the various embodiments of the present invention provide substantially real-time monitoring of the progress of an analysis project and a projection of completion of the project based on established criteria, which can be tracked against the planned time to completion and budget for a project.

In accordance with various embodiments of the performance analysis support system of the present invention, there are two approaches for software implementation. Preferably, the performance analysis support system is implemented via a hosted Web server and alternatively with a client-hosted Web server.

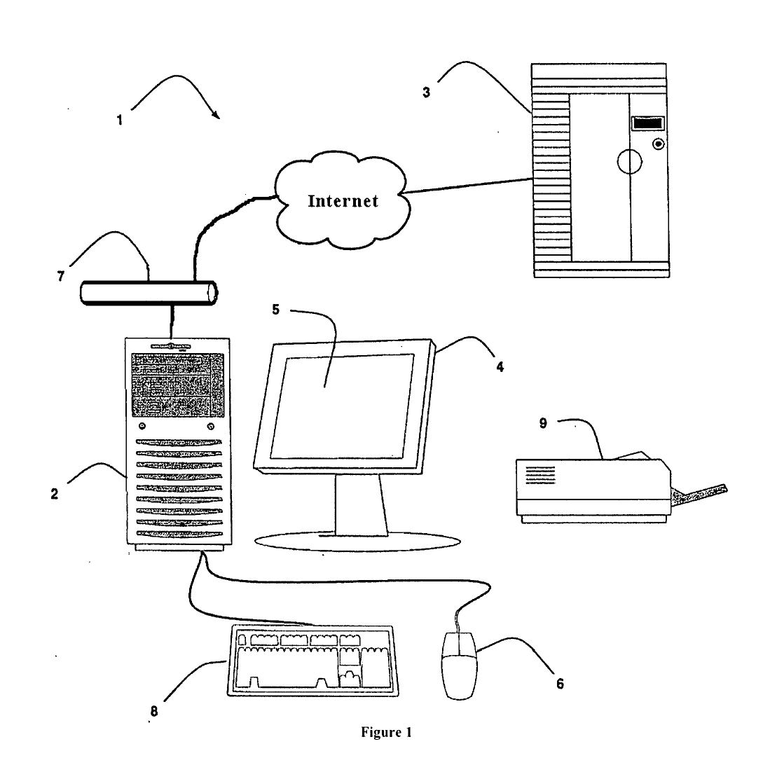

A performance analysis support system using a hosted Web server for performing analysis based on validated data, generally indicated by the numeral 1, is shown in FIG. 1. The performance analysis support system 1 preferably comprises a Web-based application accessed by a personal computer 2, as shown in FIG. 1. For example, the personal computer 2 may be any personal computer having at least 256 megabytes of random access memory (RAM) and preferably includes one gigabyte of RAM, using a Web browser, preferably Microsoft Internet Explorer 6.0 or greater. In this example, the performance analysis support system 1 is a 128-bit SSL encrypted secure application running on a Microsoft Windows Server 2003 or Windows Server 2000 or later operating system available from Microsoft Corporation located in Redmond, Wash. The personal computer 2 also comprises a hard disk drive preferably having at least 40 gigabytes of free storage space available. The personal computer 2 is coupled to a network 7. For example, the network 7 may be implemented using an Internet connection. In one implementation of the performance analysis support system 1, the personal computer 2 can be ported to the Internet or Web, and analysis is performed by a server 3. The network 7 may be implemented using a broadband data connection, such as, for example, a DSL or greater connection, and is preferably a T1 or faster connection.

The graphical user interface of the performance analysis support system 1 is preferably displayed on a monitor 4 connected to the personal computer 2. The monitor 4 comprises a screen 5 for displaying the graphical user interface provided by the performance analysis support system 1. The monitor 4 may be a 15″ color monitor and is preferably a 1024×768, 24-bit (16 million colors) XGA monitor or better. The personal computer 2 further comprises a 256 or more color graphics video card installed in the personal computer. As shown in FIG. 1, a mouse 6 is provided for mouse-driven navigation between screens or windows comprising the graphical user interface of the performance analysis support system 1. The personal computer 2 is also preferably connected to a keyboard 8. The mouse 6 and keyboard 8 enable a user utilizing the performance analysis support system 1 to perform a performance analysis based on validated data and to generate a set of recommended solutions. Preferably, the user can print the results using a printer 9.

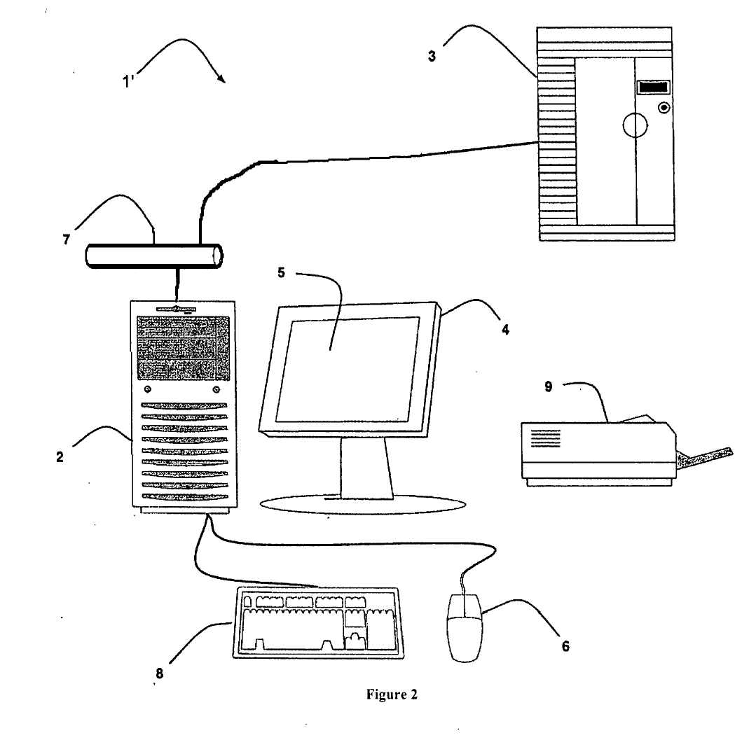

In another implementation of the performance analysis support system 1′, analysis is preformed by an application installed on a local area network Web server 3, as shown in FIG. 2. The application is a hosted application developed with active server page(s) (ASP) code together with a SQL server database hosted and accessed via Microsoft Internet Explorer 6.0 or greater and available for Microsoft XP® and other operating systems.

The performance analysis support system 1 or 1′ is implemented as a Web-based application, and data may be shared with additional software (e.g., a word processor, spreadsheet, or any other business application). One skilled in the art will appreciate that the systems and techniques described herein are applicable to a wide array of business and personal applications.

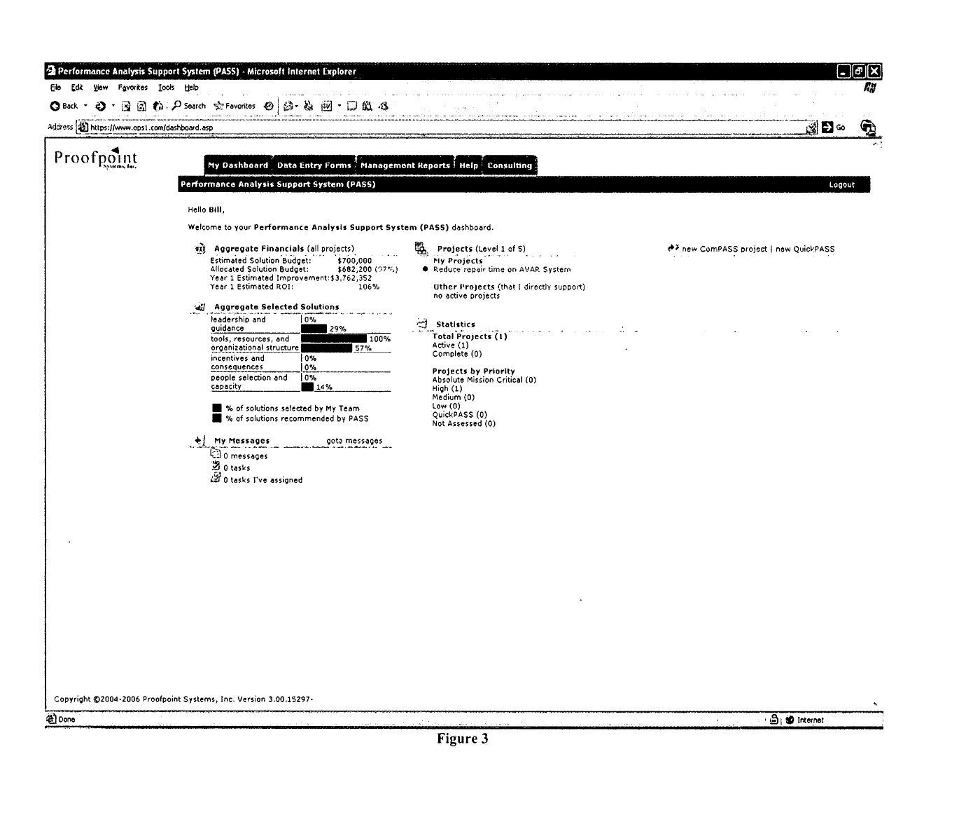

In accordance with a preferred embodiment of the present invention, one or more performance problems may be analyzed using the performance analysis support system I or 1′ of the present invention. For example, as shown in FIG. 3, the performance analysis support system 1 displays a dashboard that lists “Projects” for a particular individual user (“My Projects”), if any. The “Projects” list also lists “Other Projects” that are directly supported by the individual user. For purposes of explanation, as shown in FIG. 3, there is one listed “Project,” namely, “Reduce repair time on AVAR System.” Referring to the exemplary project, “AVAR” is an acronym for “Authorized Value-Added Reseller.” The dashboard also comprises a region labeled “Statistics” for the listed projects, including the number of projects and the priority categories for the listed projects. If the user hovers the mouse over the project title, a popup message displays the full project purpose and target date for implementation. As shown in FIG. 3, a project status indicator is displayed to the left of the project title and signifies green for “on schedule,” yellow for “behind schedule,” and red for “off schedule.” Preferably, any critical tasks or pending actions required of the individual user are listed under the heading “My Messages,” for example, “approve/disapprove the Project Initiation Phase for Reduce repair time on AVAR System.”

The dashboard also preferably provides additional information regarding the listed projects. The additional information is particularly important to management level personnel, and preferably includes “Aggregate Financials.” The “Aggregate Financials” may include, for example, “Estimated Solution Budget,” “Allocated Solution Budget,” “Year 1 Estimated Improvement,” and “Year 1 Estimated ROI.” Additionally, the prospective impact on the organization or enterprise is also specified under ” Aggregate Selected Solutions,” including “leadership and guidance,” tools, resources, and organizational structure,” incentives and consequences,” and “people selection and capacity.” As shown in FIG. 3, bar graphs are used to indicate the percentage of solutions recommended by the performance analysis support system 1 and the percentage of solutions selected by the project team.

As shown in FIG. 3 in the “Projects” section, “Level 1 of 5” indicates the project and information access authority and viewing permission level. This level is assigned via an administration function.

As shown in FIG. 3, the individual user may position the cursor of the mouse 6 on “new ComPASS project” and click the left mouse button to commence a new project. The various phases of a project will now be described in detail.

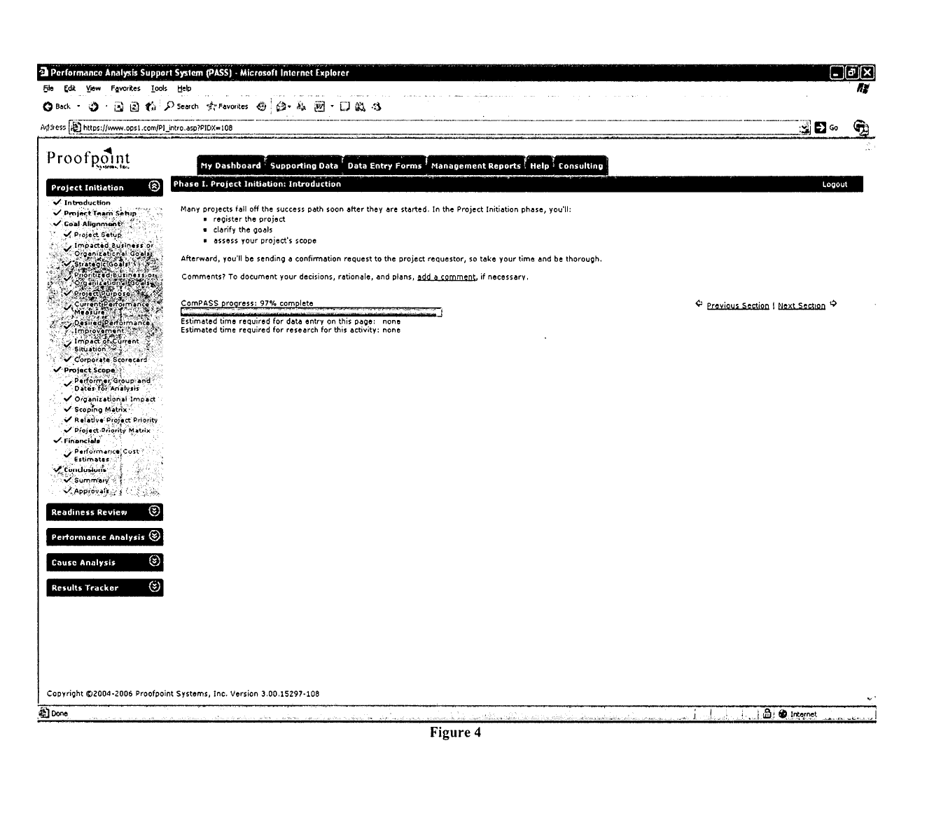

The first phase of a project is a “Project Initiation” phase, as shown in FIG. 4. The “Project Initiation” preferably comprises a series of screens that is displayed by the performance analysis support system and method to lead or instruct a user through the Project Initiation phase during which the system and method assemble and display results. The screens that are displayed preferably comprise an “Introduction” screen, as shown in FIG. 4. The “Introduction” screen informs the individual user of the objective for the “Project Initiation” phase, namely, register the project, clarify the goals, and assess the project's scope. As shown in the navigation menu at the left-hand side of the “Introduction” screen, related tasks are grouped under a main heading. For example, nine tasks related to project goals are grouped beneath the “Goal Alignment” heading. A check mark appears next to “Introduction” after the individual user accesses the “Introduction” screen. To navigate to the next screen, the user positions the cursor of the mouse 6 on “Next Section” and clicks the left mouse button or alternatively-locates the cursor of the mouse on “Project Team Setup” in the left-hand navigation menu and clicks the left mouse button.

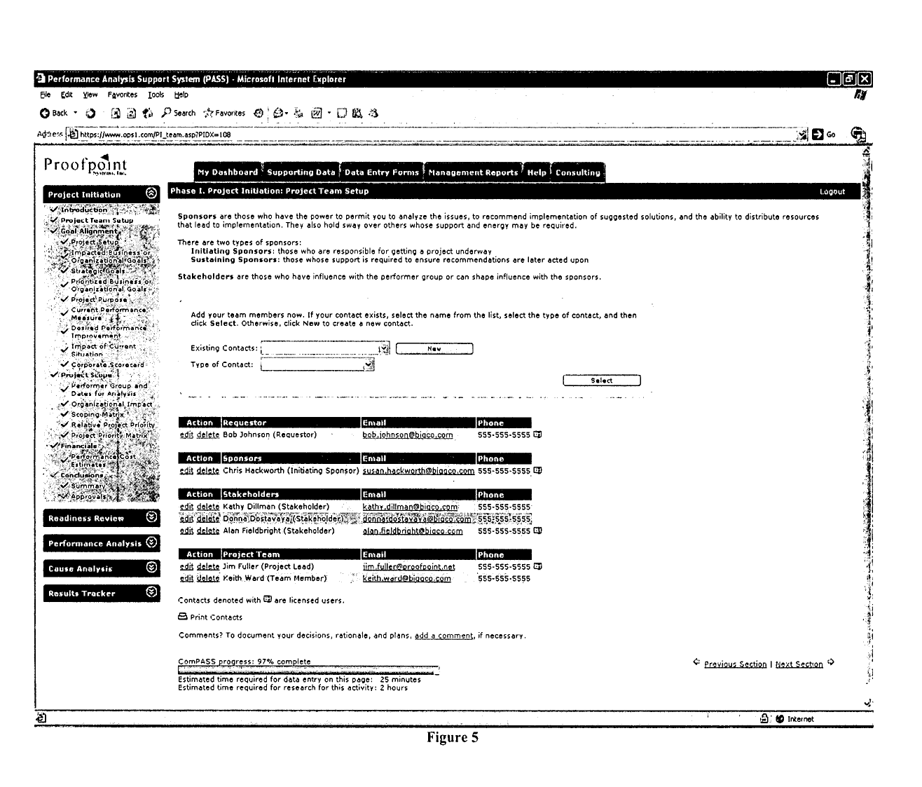

The next screen in the sequence of screens displayed to the user during the “Project Initiation” phase is a “Project Team Setup” screen, as shown in FIG. 5. The user selects each contact person for the project by positioning the cursor of the mouse 6 on the down arrow of the “Existing Contacts” box if the name of the person has previously been entered by the user in conjunction with the current or a previous project, next selecting the “Type of Contact,” which consists of requester, sponsor, stakeholder, or project member options, and then clicking on the “Select” button.

The requestor is the person launching the project. There are preferably two types of sponsors, namely, initiating sponsors and sustaining sponsors. An initiating sponsor is a person who is responsible for getting a project underway. A sustaining sponsor is a person whose support is required for implementation of recommendations. A stakeholder is a person who has influence with the sponsors and the action performer group. A project team member is a person who is involved in the project.

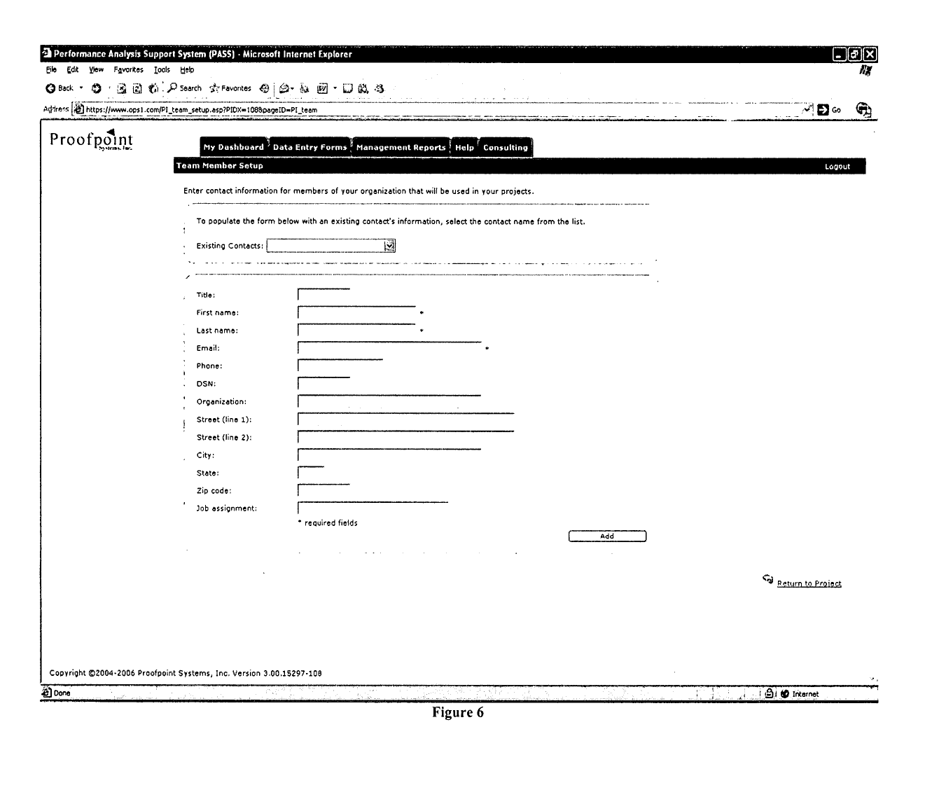

If the contact is not on the list of existing contacts, using the left mouse button, the user clicks on the “New” button to display a “Team Member Setup” page, as shown in FIG. 6. “First name,” “Last name,” and “Email” address are required fields when defining a new contact. After entering all relevant information, the user positions the cursor of the mouse 6 over the “Add” button and clicks the left mouse button. The user then positions the cursor of the mouse 6 on the “Return to Project” link and clicks the left mouse button to return to the “Project Team Setup” page.

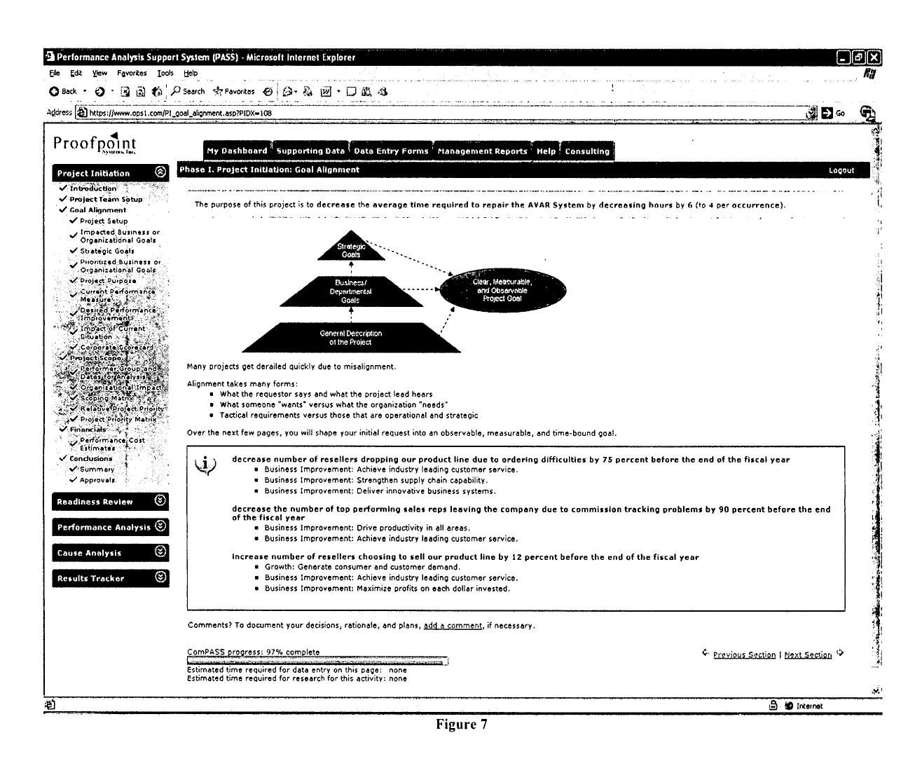

The next screen accessed during the “Project Initiation” phase is the “Goal Alignment” screen, as shown in FIG. 7. The “Goal Alignment” screen displays information to be collected during goal alignment.

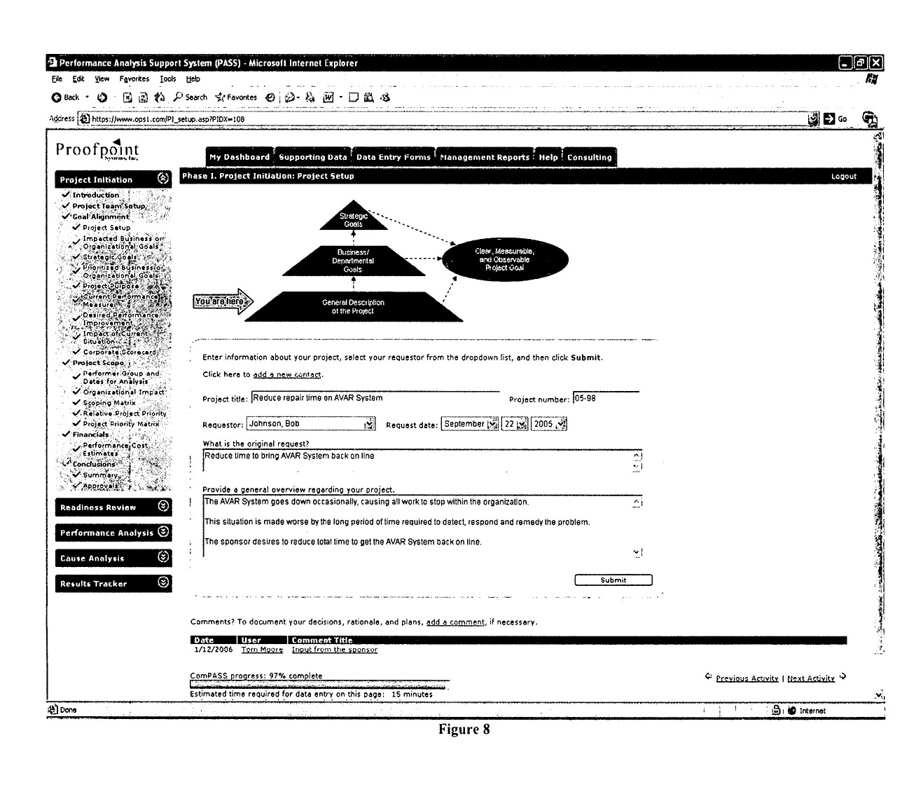

The next screen accessed during the “Project Initiation” phase is the “Project Setup” screen, as shown in FIG. 8. The “Project Setup” screen comprises a data entry box in which the user enters a project number, for example, “05-98.” The user enters a project title in another data entry box, which for the present example is “Reduce repair time on AVAR System.” The user is provided with respective data entry boxes to enter a project request date and an “original request” corresponding to an initial formulation of the performance problem to be solved; for example, the “original request” is “Reduce time to bring AVAR System back on line.” Next, the user enters a general description of the purpose of the project in another data entry box. Following entry of the data, the user positions the cursor of the mouse 6 on the submit button and clicks the left mouse button to input the project setup data to the performance analysis support system 1.

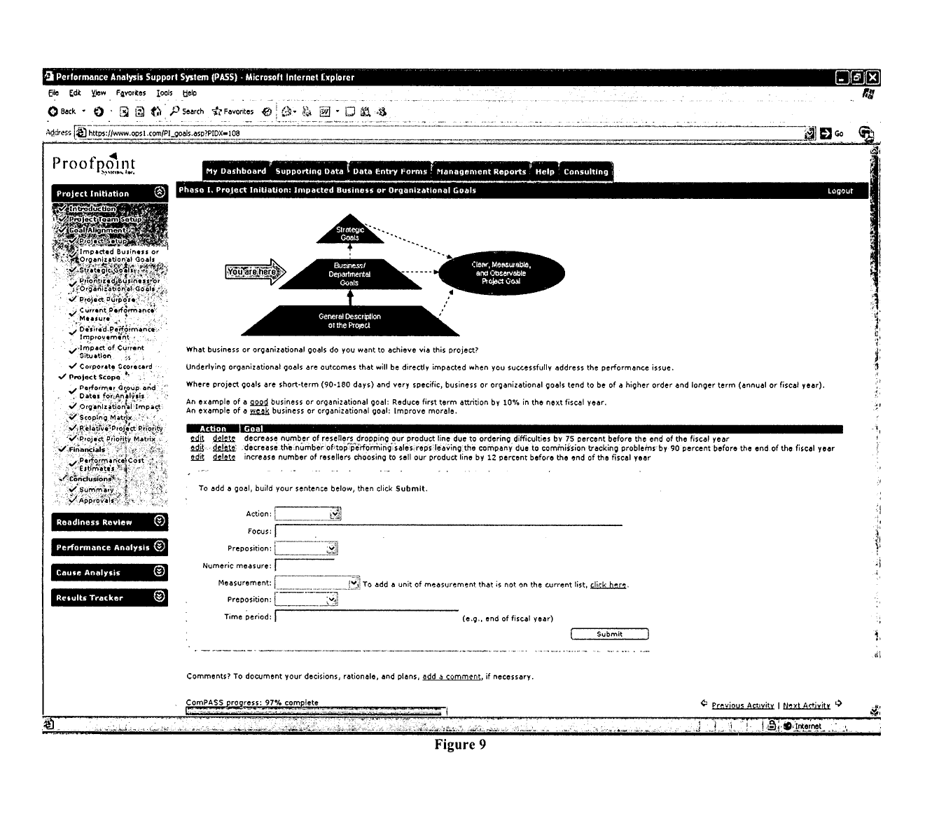

Preferably, the performance analysis support system and method also elicit business or organizational goals that are sought to be achieved by the project using an “Impacted Business or Organizational Goals” screen, as shown in FIG. 9. The user may list one or more business or organizational goals that need to be accommodated by the project. The user enters one or more business and/or organizational goals using the “Action” data entry box. For example, one such goal is “decrease number of resellers dropping our product line due to ordering difficulties by 75 percent before the end of the fiscal year.”

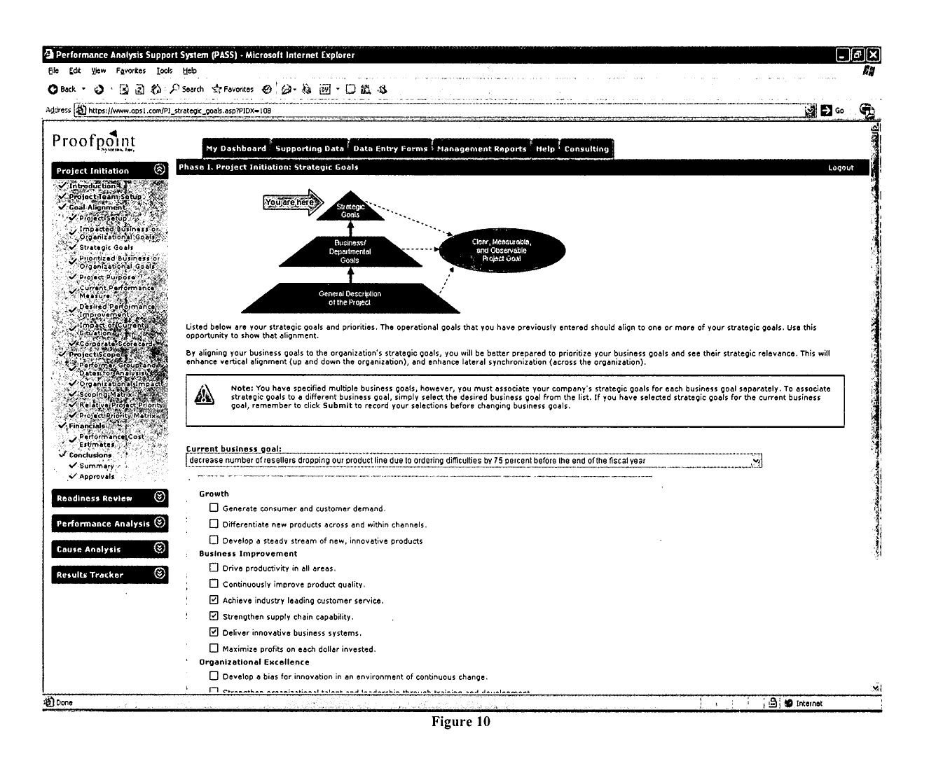

Next, the user is also solicited to select strategic goals associated with the project using a “Strategic Goals” screen, as shown in FIG. 10. The performance analysis support system and method in accordance with the present invention enable the user to assure that the business/organizational goals of the project are aligned with the strategic goals by positioning the cursor of the mouse 6 on each applicable strategic-goal check box and clicking the left mouse button. The procedure is repeated for each business/organizational goal that the user specified earlier.

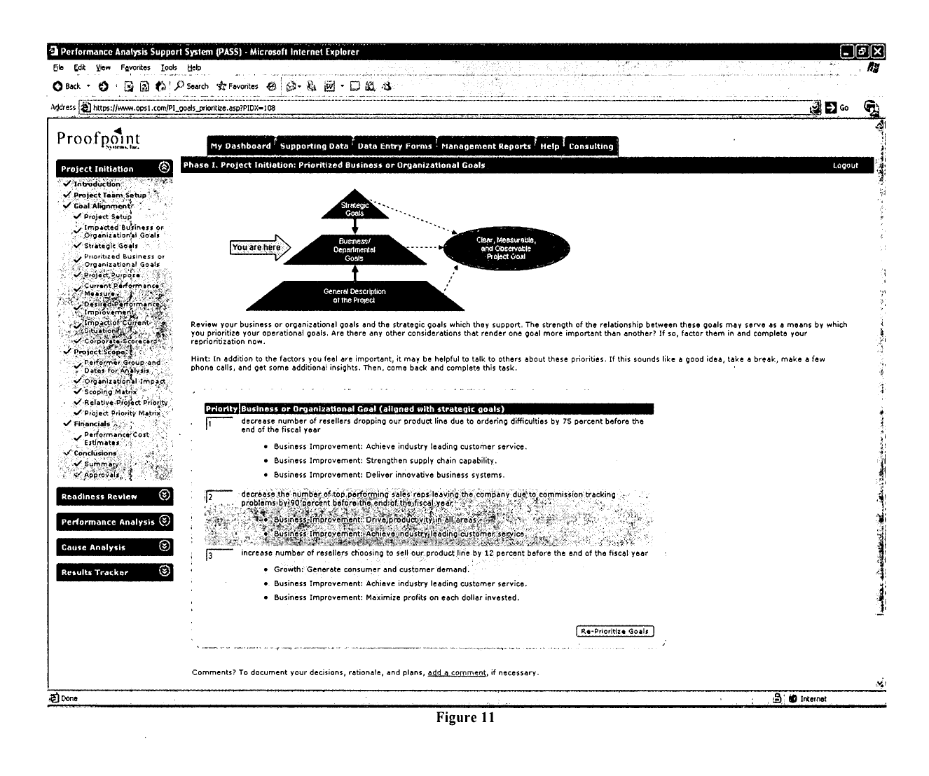

The next screen displayed to the user by the performance analysis support system 1 is shown in FIG. 11 consisting of a “Prioritized Business or Organizational Goals” screen. Using the “Prioritized Business or Organizational Goals” screen, the user prioritizes the business/organizational goals in view of the strategic goals aligned with those business/organizational goals by entering a number in an associated data entry box using “1” corresponding to the highest priority, “2” corresponding to the next highest priority, etc., as shown in FIG. 11.

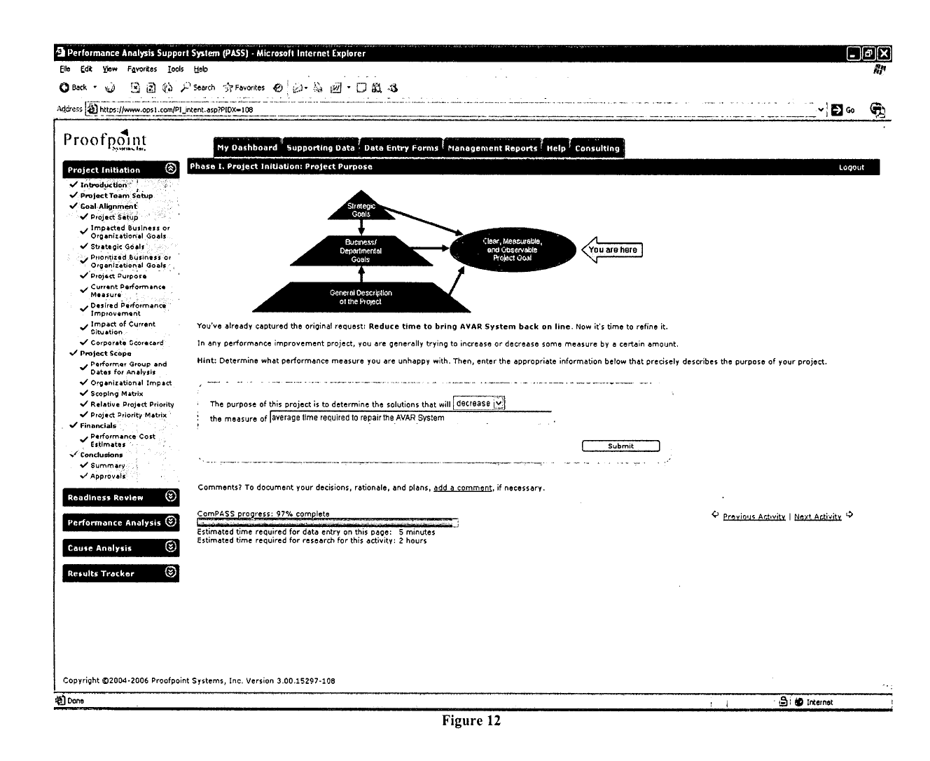

After the user has completed the procedure of prioritizing the business/organizational goals, the next in the series of screens displayed by the performance analysis support system 1 is a “Project Purpose” screen, as shown in FIG. 12. The user is guided to refine the original request by the performance analysis support 5 system and method to state the project purpose in terms that incorporate metrics typically by increasing or decreasing some measure by a certain amount. This provides a statement of the performance improvement goal that serves as the objective, that is, a clear, measurable, and observable goal for the project.

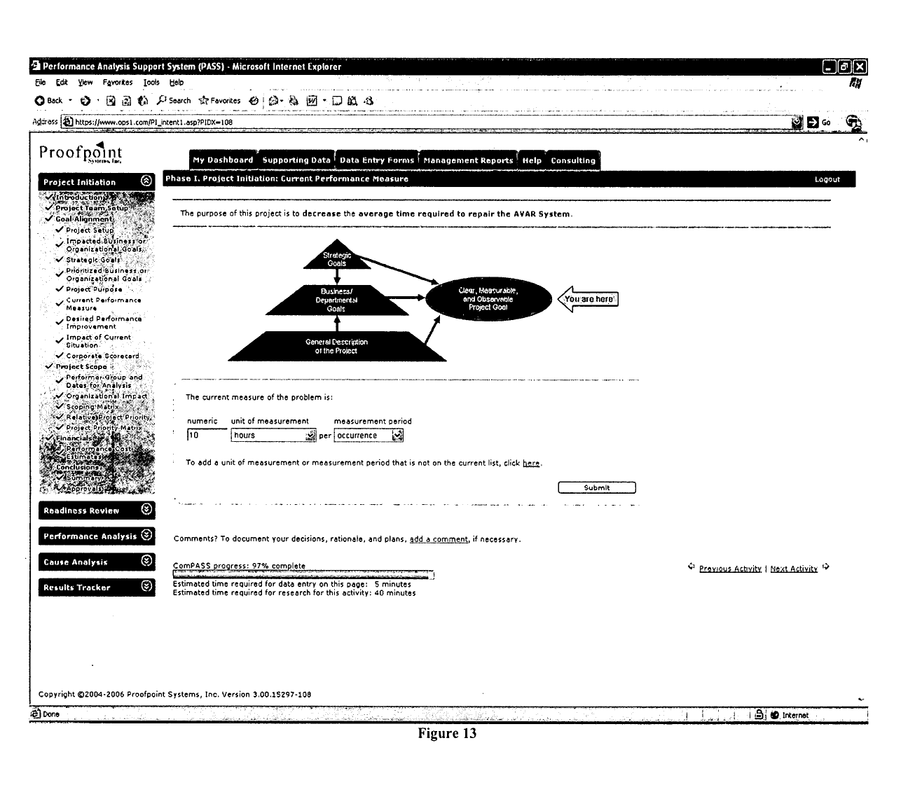

Following concise definition of the project purpose, the user enters the current measure of the performance problem using a “Current Performance Measure” screen, as shown in FIG. 13. Referring to FIG. 13, the user enters a numeric value, a unit of measurement for the numeric value, and a period over which the entered measurement applies, for example, “10 hours per occurrence” of downtime for the AVAR System. The user then positions the cursor of the mouse 6 on the submit button and clicks the left mouse button to input the current performance measurement to the performance analysis support system 1.

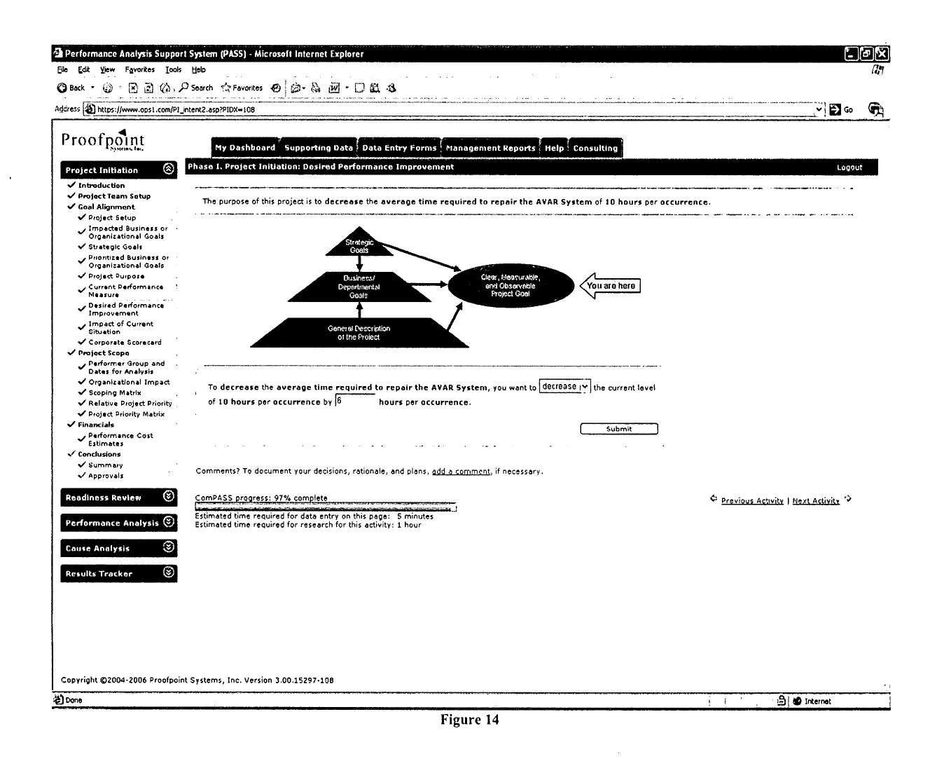

In order to specify the performance improvement wanted by the user, the user enters the desired performance improvement as a decrease or increase in the current performance measure by a specified amount (i.e., decrease the average time required to repair the AVAR System from the current level of 10 hours by 6 hours). The user enters whether to “decrease” or “increase” the current measure and the amount of change using the pull down menu and data entry box in a “Desired Performance Improvement” screen shown in FIG. 14 and then positions the cursor of the mouse 6 on the submit button and clicks the left mouse button. Subsequently, the purpose of the project is stated in terms of the desired performance improvement, for example, “The purpose of this project is to decrease the average time required to repair the AVAR System by decreasing hours by 6 (to 4 per occurrence).”

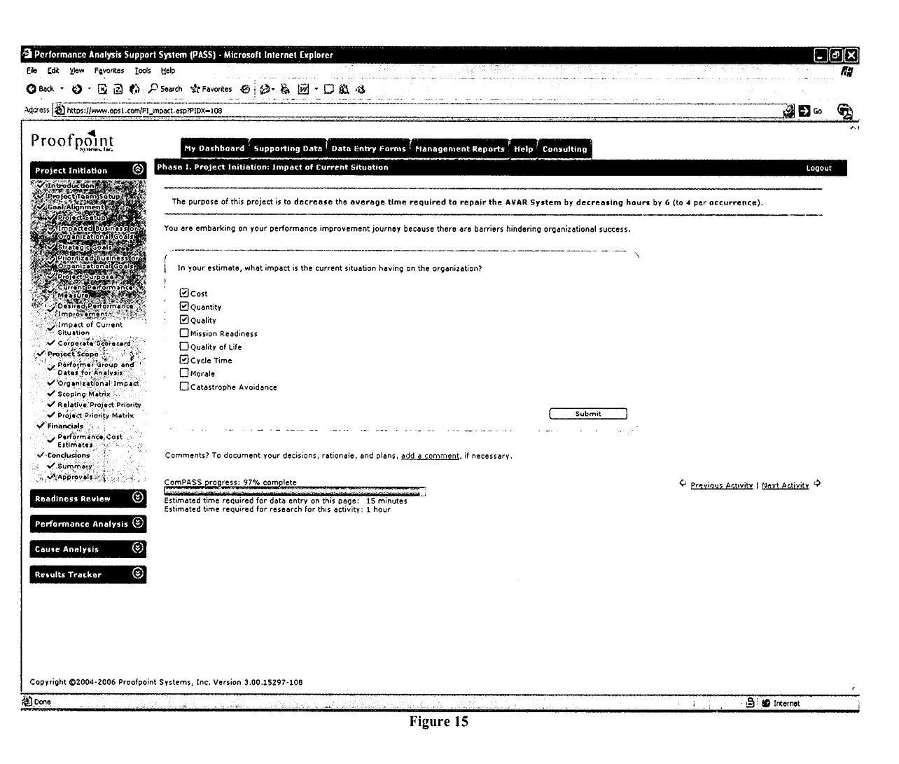

The next screen in the sequence displayed by the performance analysis support system 1 is an “Impact of Current Situation” screen, as shown in FIG. 15. Using the “Impact of Current Situation” screen shown in FIG. 15, the user assesses the impact of the current performance on the business/organization. The impact is specified by the user positioning the cursor of the mouse 6 and clicking the left mouse button on one or more check boxes corresponding to impact factors comprising “Cost,” “Quantity,” “Quality,” “Mission Readiness,” “Quality of Life,” “Cycle Time,” “Morale,” and/or “Catastrophe Avoidance,” although other or additional impact criteria may be included as well. The user then positions the cursor of the mouse 6 on a submit button and clicks the left mouse button to input the applicable impact factors to the performance analysis support system 1.

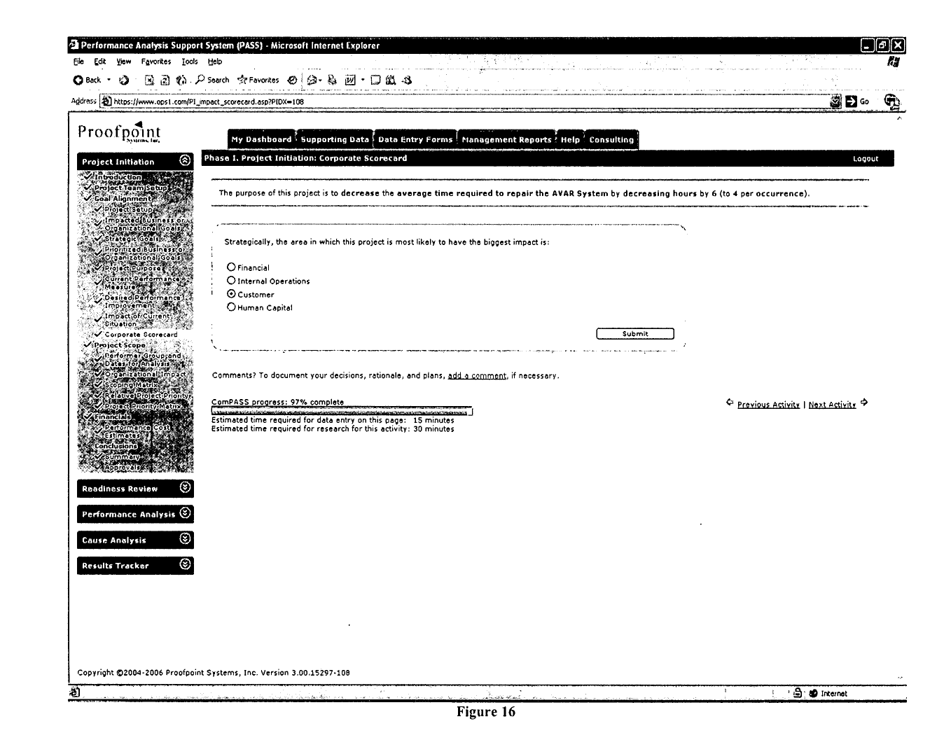

Based on the data and selections entered by the user, the performance analysis support system and method determine the area that will likely be most significantly impacted by the project vis-á-vis 1) “Financial,” 2) “Internal Operations,” 3) “Customer,” or “Human Capital” and display the result in a “Corporate Scorecard” screen, as shown in FIG. 16. In the illustrated example of decreasing the repair time for the AVAR System, the most significantly impacted area is the “Customer” area, as shown in FIG. 16.

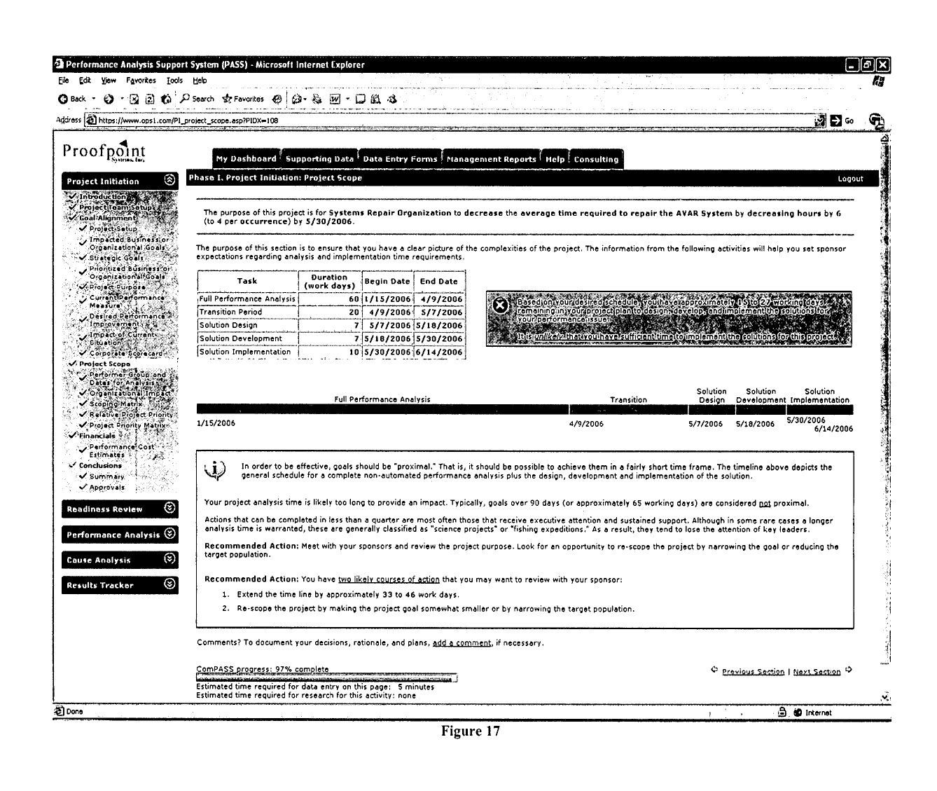

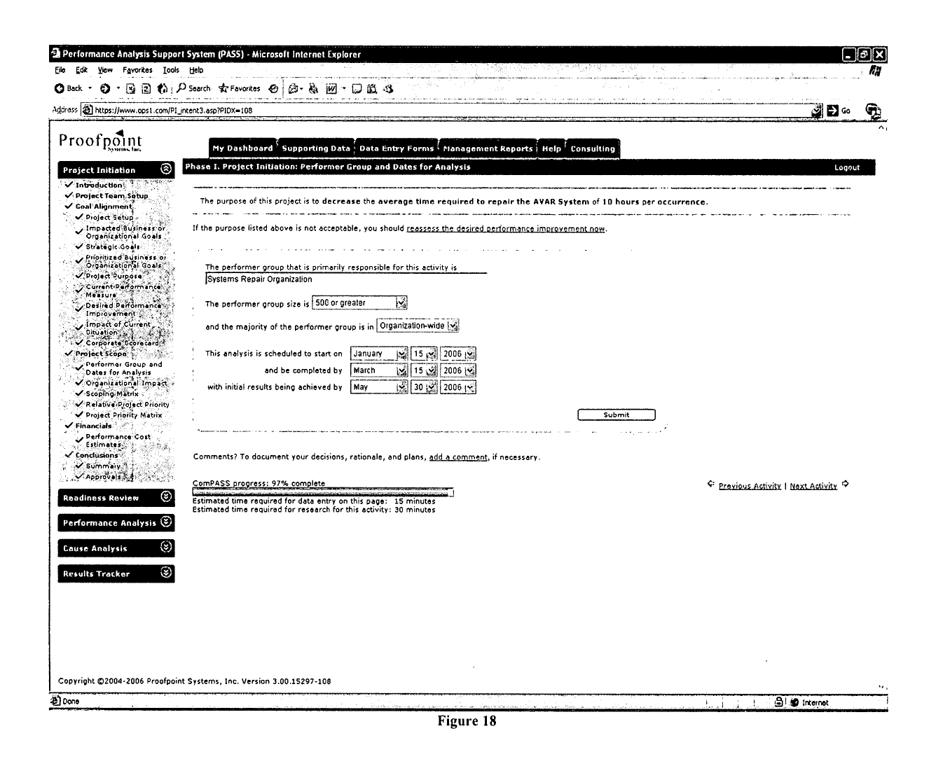

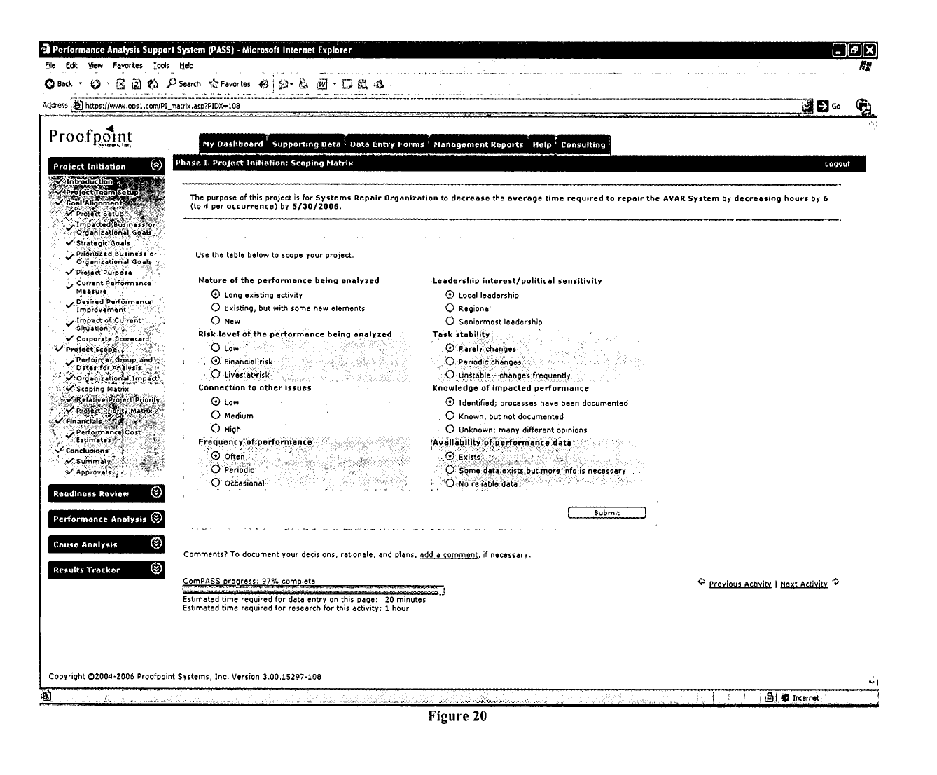

The performance analysis support system and method then provide a summary in a “Project Scope” screen, as shown in FIG. 17. Initially, this screen displays instructions for completing the “Project Scope” section. After the section has been completed (specifically, as will be described below in conjunction with FIGS. 18 and 20), the information on the screen is updated, as shown in FIG. 17. The performance analysis support system and method summarize the various dates and time periods for analysis and estimated available solution development and implementation period and determine whether or not the allocated time periods are adequate, as well as the level of risk associated with completion of the performance improvement project, for example, “It is unlikely that you have sufficient time to implement the solutions for this project.”

Given the purpose of the project based on the desired performance improvement, the user enters data required by a “Performer Group and Dates for Analysis” screen, as shown in FIG. 18. Specifically, the user identifies the performer group required to effect the performance improvement, for example, the “Systems Repair Organization,” in a data entry box. The user also enters the size of the performer group and the number of locations of the performer group using respective drop down lists, as shown in FIG. 18. Finally, the user enters the following dates: 1) the scheduled start date for the analysis to commence, the scheduled completion date of the analysis, and the date by which initial results of implementation of the performance improvement are to be achieved, using respective drop down lists, as shown at the bottom of FIG. 18. The user then positions the cursor of the mouse 6 on the submit button and clicks the left mouse button to input the entered data to the performance analysis support system 1.

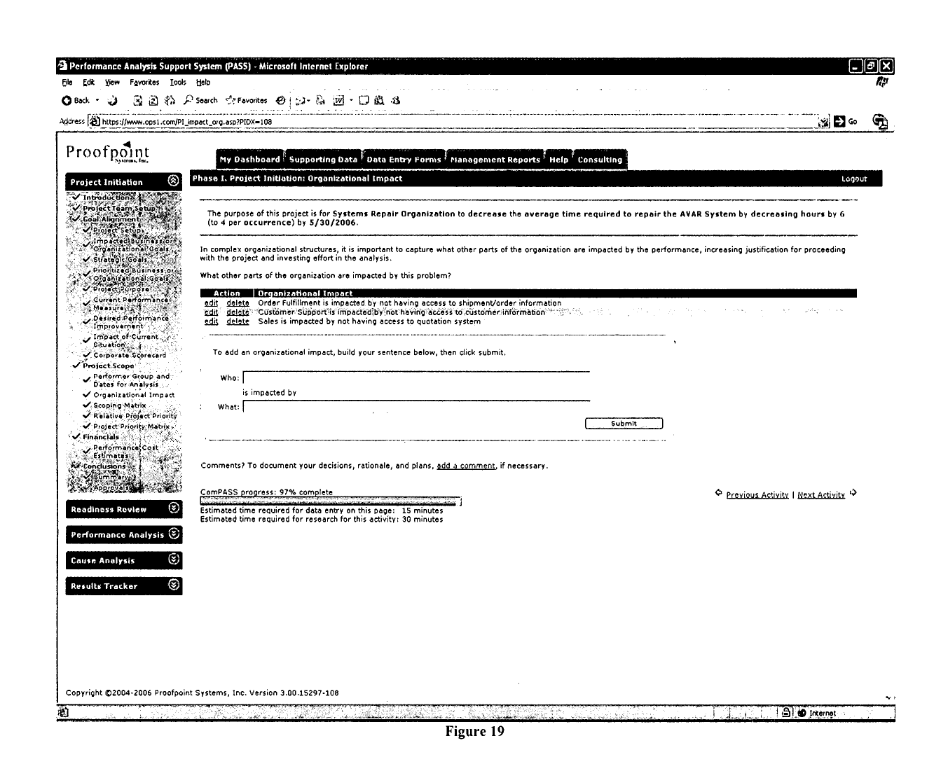

Additionally, the performance analysis support system and method enable the user to delineate what other parts of the business/organization are impacted by the performance problem. To this end, the user enters “Who” within the business/organization is impacted by “What” by entering one or more impact statements in the “Who” and “What” data entry boxes in an “Organizational Impact” screen, as shown in FIG. 19.

Based on the data entered by the user using the “Performer Group and Dates for Analysis” screen shown in FIG. 18, the purpose of the project is restated in terms of the performer group and date data, for example, “The purpose of this project is for Systems Repair Organization to decrease the average time required to repair the AVAR System by decreasing hours by 6 (to 4 per occurrence) by May 30, 2006.” The performance analysis support system 1 then displays a “Scoping Matrix” screen, as shown in FIG. 20. The “Scoping Matrix” screen shown in FIG. 20 enables the user to select the metrics for the scoping matrix, comprising the “Nature of the performance being analyzed,” “Risk level of the performance being analyzed,” “Connection to other issues,” “Frequency of performance,” “Leadership interest/political sensitivity,” “Task stability,” “Knowledge of impacted performance,” and “Availability of performance data.”

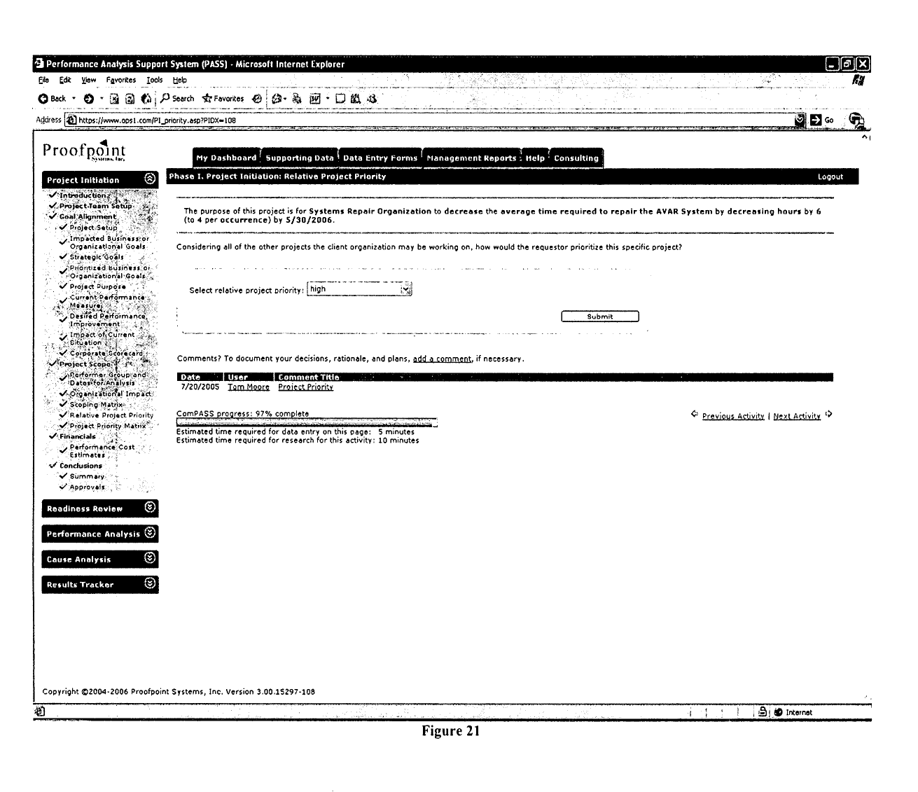

As shown in FIG. 21, a “Relative Project Priority” screen is also displayed to enable the user to select a relative priority for the project using a drop down list. For example, the priority assigned to the current example of decreasing the repair time for the AVAR System is “high.”

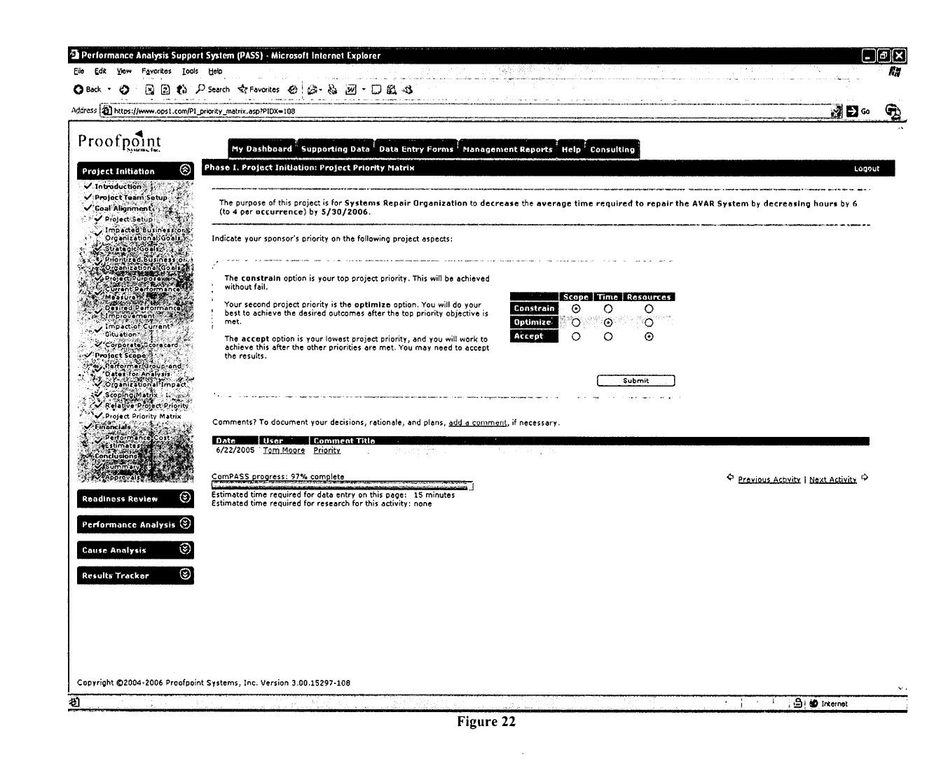

The next screen in the series of screens displayed by the performance analysis support system 1 is a “Project Priority Matrix” screen, as shown in FIG. 22. As indicated by the table shown in FIG. 22, the user positions the cursor of the mouse 6 on respective bubbles and clicks the left mouse button to indicate the sponsor's priority respecting the project aspects of “Scope,” “Time,” and “Resources.” The user positions the cursor of the mouse 6 on the submit button and clicks the left mouse button to input the sponsor's priorities to the performance analysis support system 1.

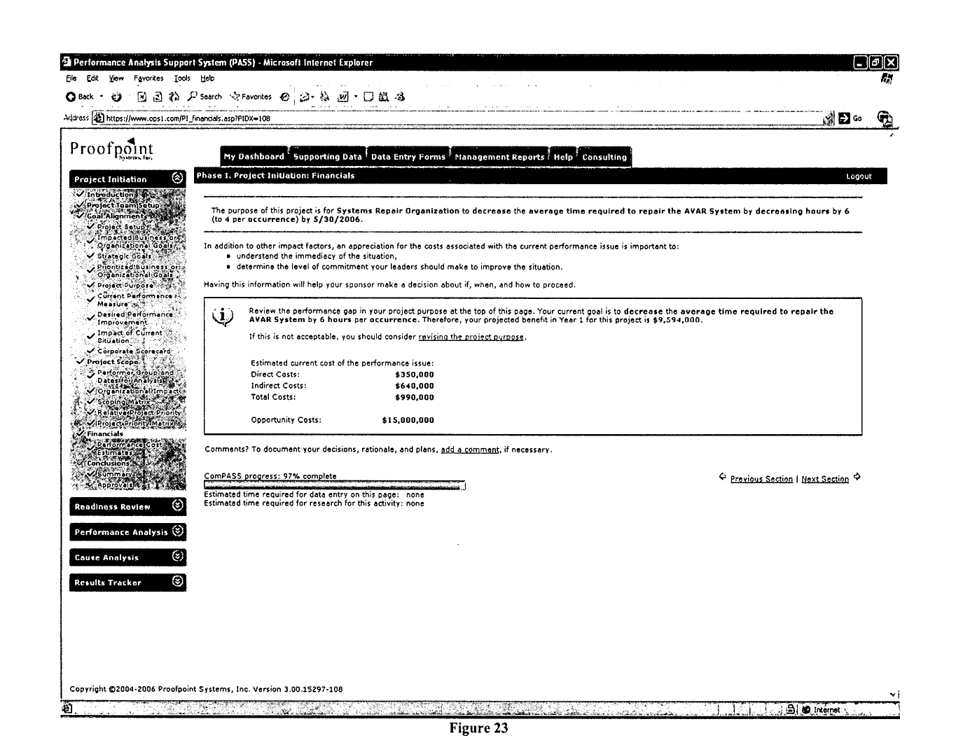

In conjunction with specification of the performance improvement project, the user enters financial information regarding “Direct Costs,” “Indirect Costs,” and “Opportunity Costs,” the data for which are displayed in a “Financials” screen, as shown in FIG. 23.

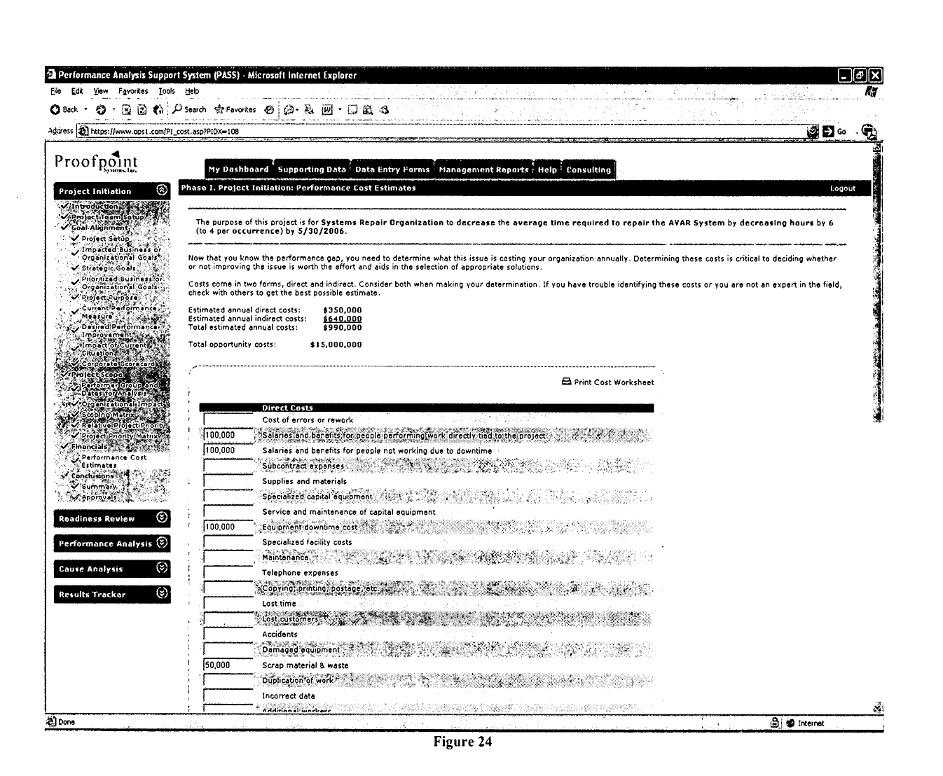

The user is elicited to estimate the cost of the performance problem that is the focus of the project using a “Performance Cost Estimates” screen, as shown in FIG. 24. Accordingly, the user enters both the estimated direct and indirect costs, preferably on an annual basis, as shown in FIG. 24, using the data entry boxes that appear in FIG. 24. Based on the cost data entered by the user, the performance analysis support system and method calculate both a projected one-year benefit and total opportunity costs. A spreadsheet application is accessed by the performance analysis support system 1 to effect the calculations. The estimated projected one-year benefit that is calculated may serve as the financial justification for the project.

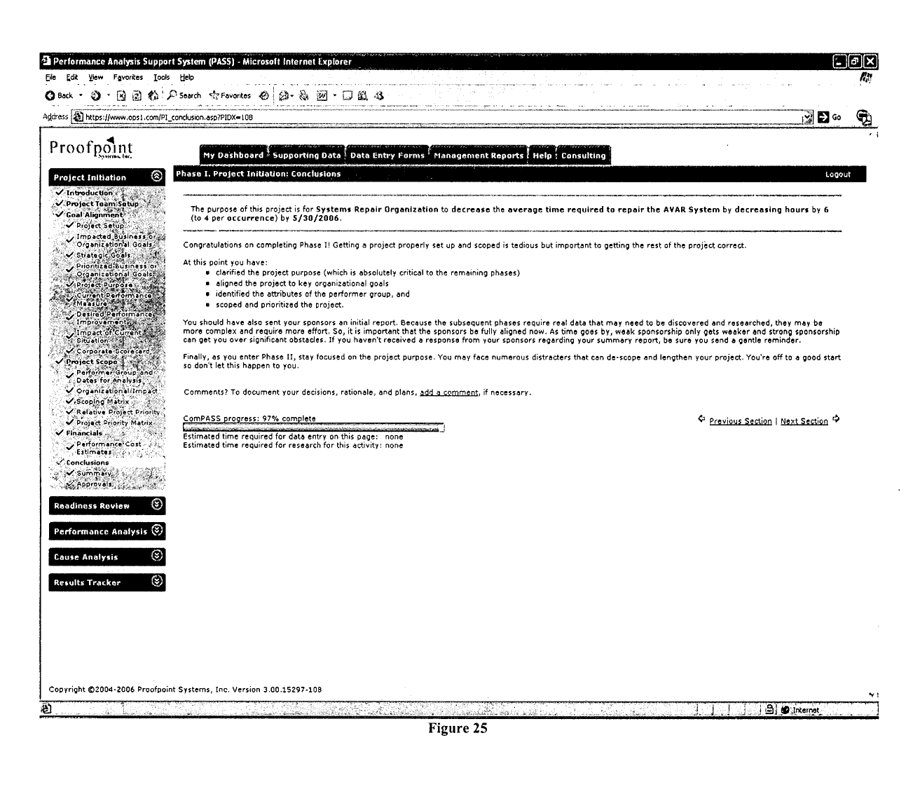

A “Conclusions” screen informs the user of the completion of the Project Initiation phase and is shown in FIG. 25.

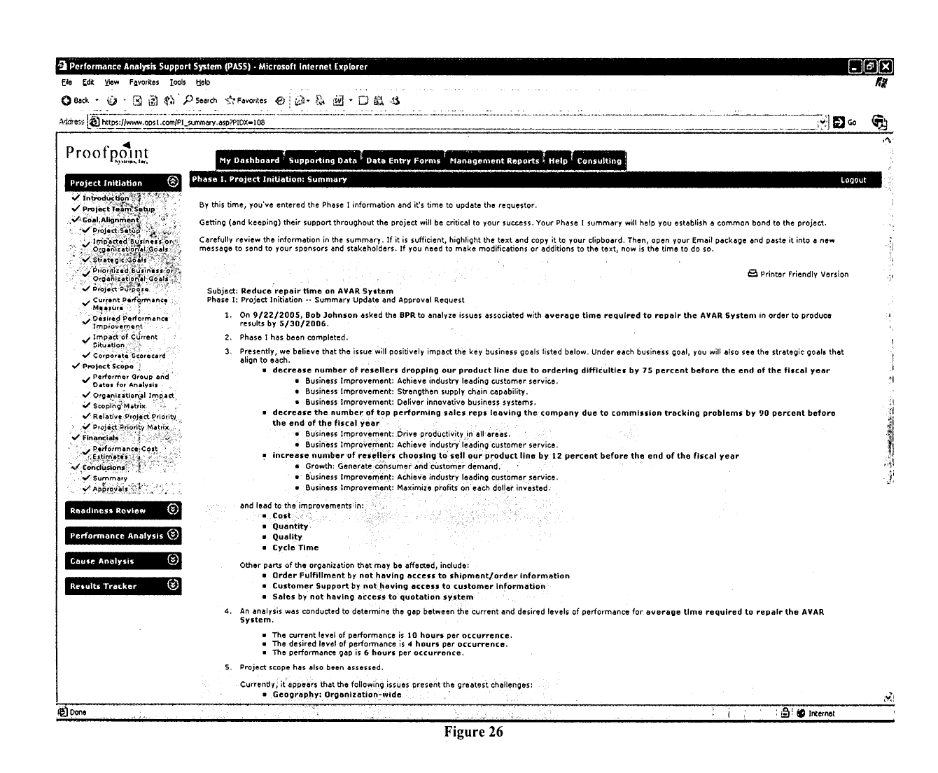

The performance analysis support system and method then assemble a summary of the Project Initiation phase in a “Summary” screen, as shown in FIG. 26. The information assembled in the “Summary” screen shown in FIG. 26 is then preferably forwarded to the project sponsor(s) and other stakeholders. For example, the “Summary” may be included in an email and sent to the project sponsor(s) and stakeholders for review.

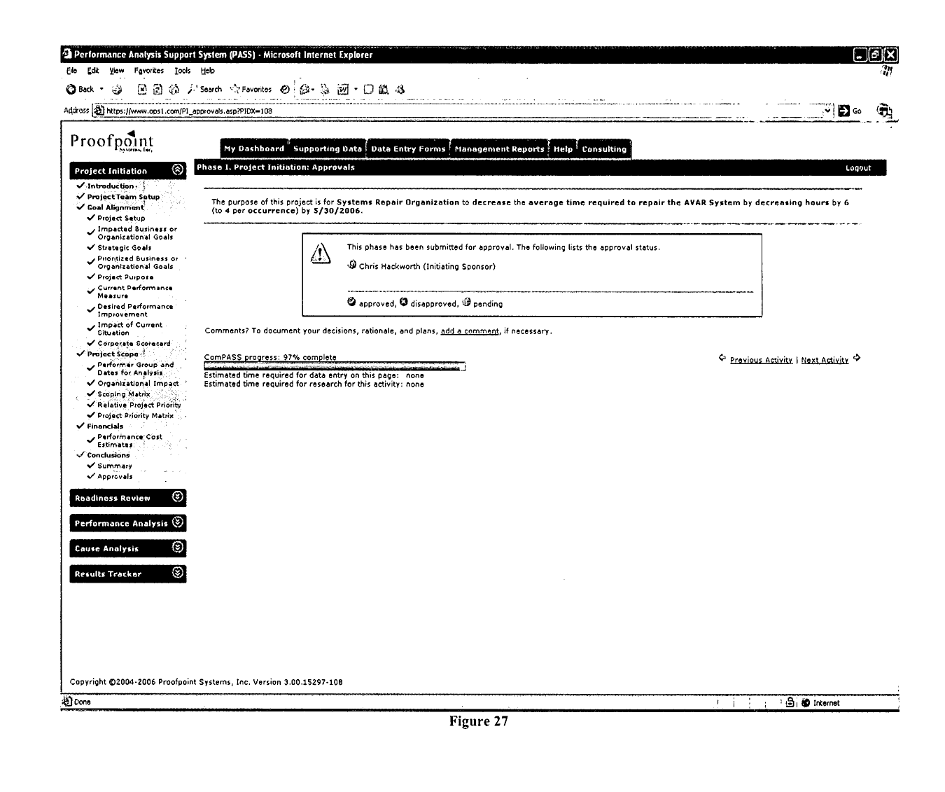

The performance analysis support system and method then display an “Approvals” screen for the Project Initiation phase, as shown in FIG. 27. The “Approvals” screen includes check box(es) on which the user positions the cursor of the mouse 6 and clicks the left mouse button to indicate which sponsor(s) and stakeholders will receive a task in the “My Messages” area of their dashboard shown in FIG. 3 directing them to approve or disapprove the status of Project Initiation phase. Once the request for approval has been submitted, the “Approvals” screen shown in FIG. 27 displays the current approval status by the sponsor(s) and stakeholders.

It is to be noted that although a series of screens and sequence of data entry and selections by the user have been described in connection with the Project Initiation phase, the screens may be accessed in any order and at different times according to when the user accesses the performance analysis support system 1 and enters the data. The performance analysis support system and method track the entry of data and discern when the user has completed all of the required inputs to complete the Project Initiation phase.

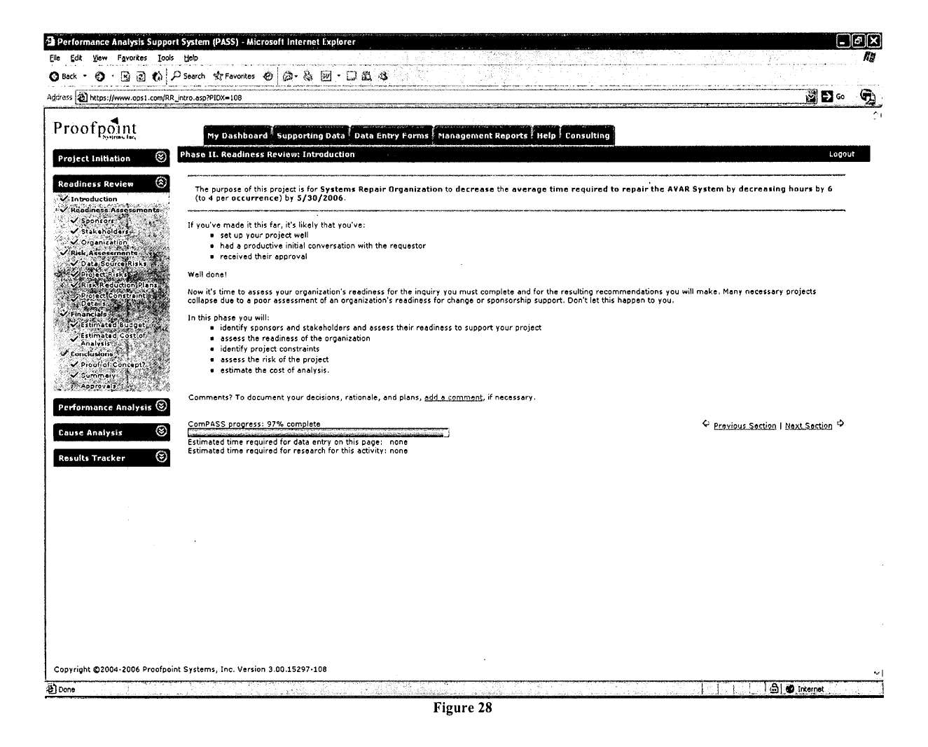

The second phase of the performance improvement project is the “Readiness Review” phase. As described in an “Introduction” screen shown in FIG. 28, the focus of the “Readiness Review” phase is to complete readiness assessments, identify project constraints, complete risk assessments, and estimate the cost of analysis.

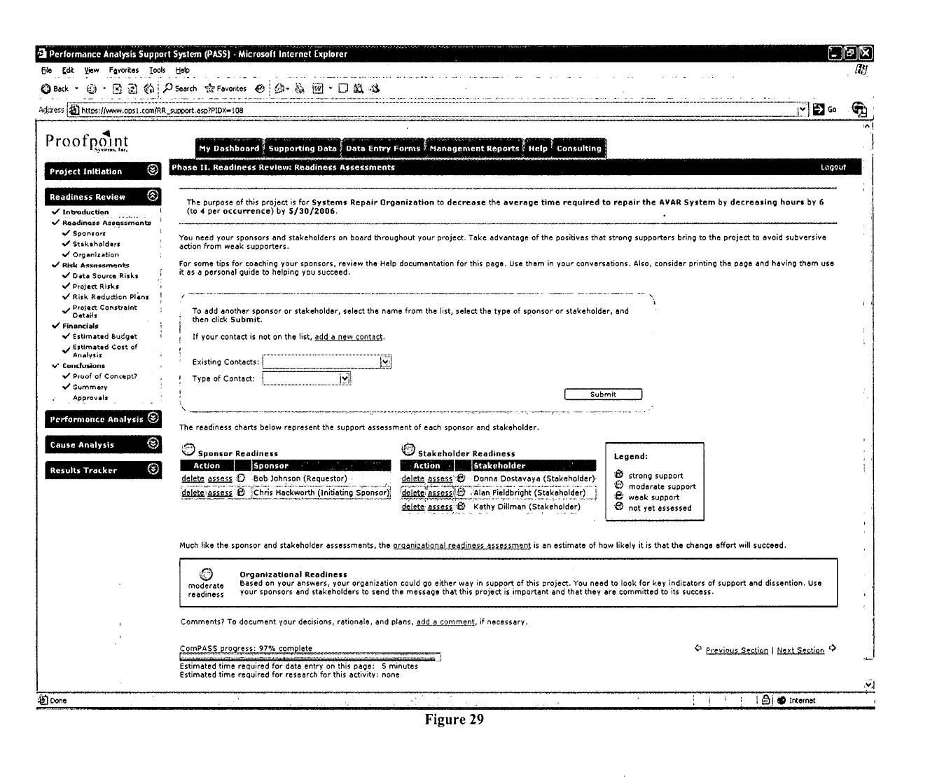

The readiness review preferably provides an indication of the level of support by each of the individuals involved in the performance problem improvement project, including the requestor, sponsor(s), and stakeholders, indicated in a “Readiness Assessments” screen, as shown in FIG. 29. In a preferred embodiment of the performance analysis support system and method, the levels of support comprise “strong support,” “moderate support,” “weak support,” and “not yet assessed.” Preferably, a color code is associated with each support level, for example, green for “strong support,” yellow for “moderate support,” red for “weak support,” and gray for “not yet assessed.” In the present example of decreasing the repair time for the AVAR System, the requestor, Bob Johnson, is indicated to have moderate support, and the initiating sponsor, Chris Hackworth, is indicated to have strong support. The “Readiness Assessments” screen also provides an indication of the overall readiness of the business/organization to change to be proposed by the recommendations for performance improvement, for example, “moderate readiness,” as shown in FIG. 29.

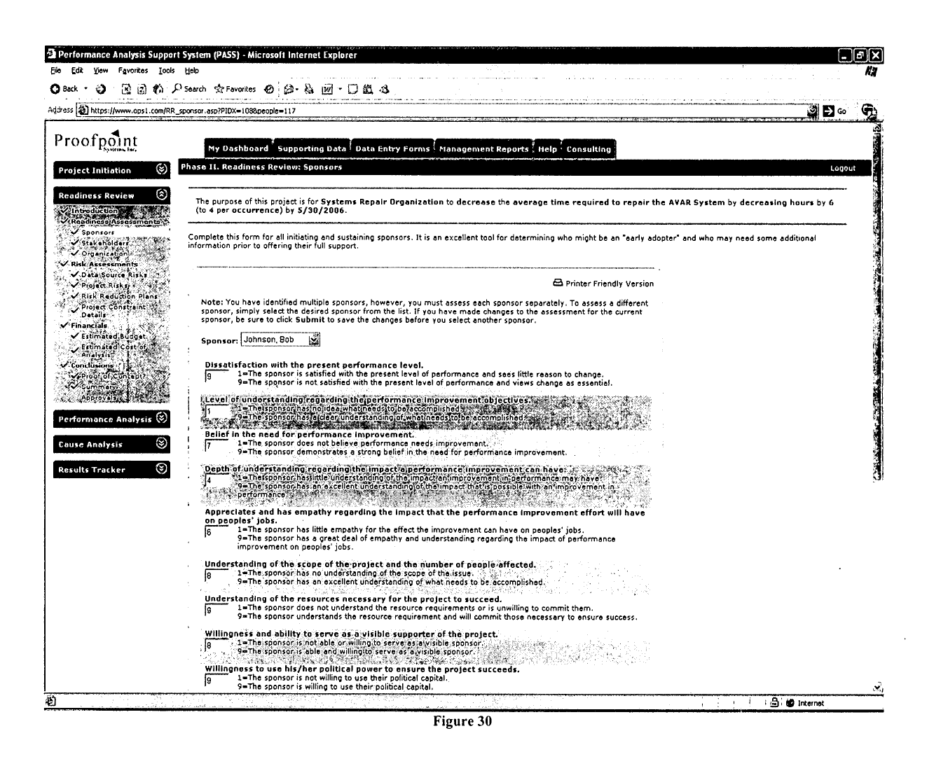

In order to determine the level of support of each sponsor, the user completes a readiness assessment form for each individual sponsor using a “Sponsors” screen, as shown in FIG. 30. The user enters a numerical rating in each of the data entry boxes associated with specified criteria for evaluating the level of support by each sponsor. For example, the criteria for assessing sponsor support may include “Dissatisfaction with the present performance level,” “Level of understanding regarding the performance improvement objectives,” “Belief in the need for performance improvement,” “Depth of understanding regarding the impact a performance improvement can have,” “Appreciates and has empathy regarding the impact that the performance improvement effort will have on peoples' jobs,” etc. After assessing each issue, the user positions the cursor of the mouse 6 on the submit button and clicks the left mouse button to input the support level data to the performance analysis support system 1. If more than one sponsor exists for the project, then the user selects another sponsor name from the drop down list and then repeats this procedure until all sponsors have been assessed. The performance analysis support system and method determine the sponsor readiness based on the numerical ratings entered by the user.

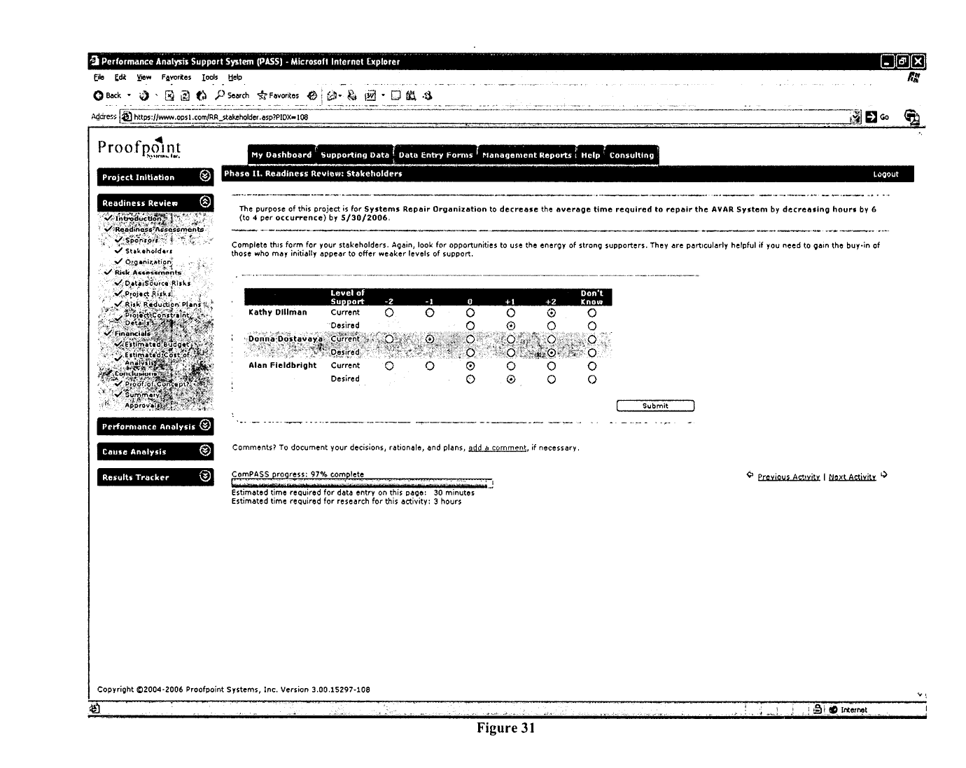

The user additionally performs a stakeholder readiness assessment using a “Stakeholders” screen, as shown in FIG. 31. The user preferably rates each stakeholder “−2,” “−1,” “0,” “+1,” or “+2” for the perceived current level of support and rates each stakeholder “0,” “+1,” or “+2” for the desired level of support by positioning the cursor of the mouse 6 on an applicable bubble and clicking the left mouse button. After each stakeholder is assessed by the user, the user positions the cursor of the mouse 6 on the submit button and clicks the left mouse button to input the support level data to the performance analysis support system 1. The performance analysis support system and method determine the stakeholder readiness based on the numerical ratings entered by the user.

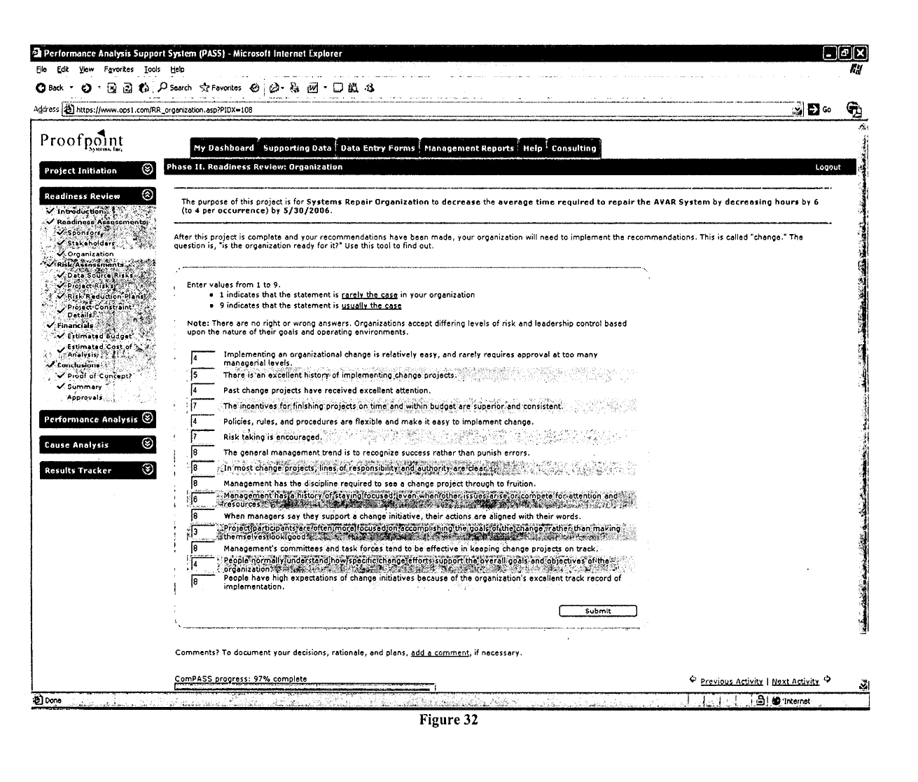

The user then proceeds to assess the readiness of the business/organization to implement recommendations for performance improvement using an “Organization” screen, as shown in FIG. 32. The user enters a numerical rating for each of a plurality of criteria preferably including “Implementing an organizational change is relatively easy, and rarely requires approval at too many managerial levels,” “There is an excellent history of implementing change projects,” “Past change projects have received excellent attention,” “The incentives for finishing projects on time and within budget are superior and consistent,” “Policies, rules, and procedures are flexible and make it easy to implement change,” “Risk taking is encouraged,” “The general management trend is to recognize success rather than punish errors,” “In most change projects, lines of responsibility and authority are clear,” “Management has the discipline required to see a change project through to fruition,” “Management has a history of staying focused, even when other issues arise or compete for attention and resources,” etc. After the user completes the entry of ratings for the business/organization readiness criteria, the user positions the cursor of the mouse 6 on the submit button and clicks the left mouse button to input the business/organization readiness data to the performance analysis support system 1. The performance analysis support system and method determine the business/organization readiness based on the numerical ratings entered by the user.

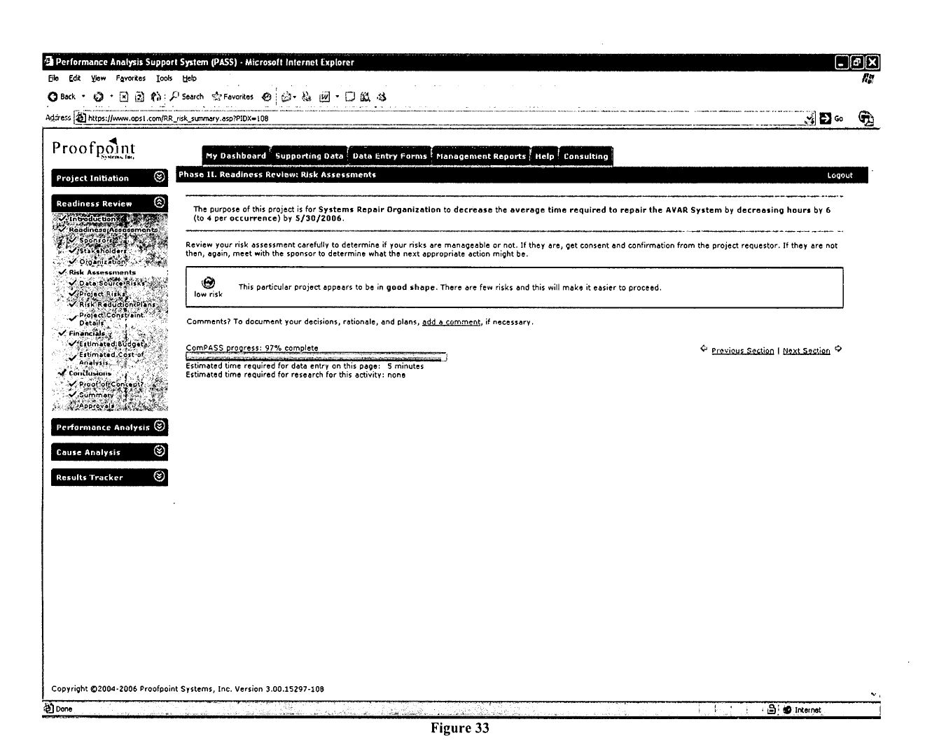

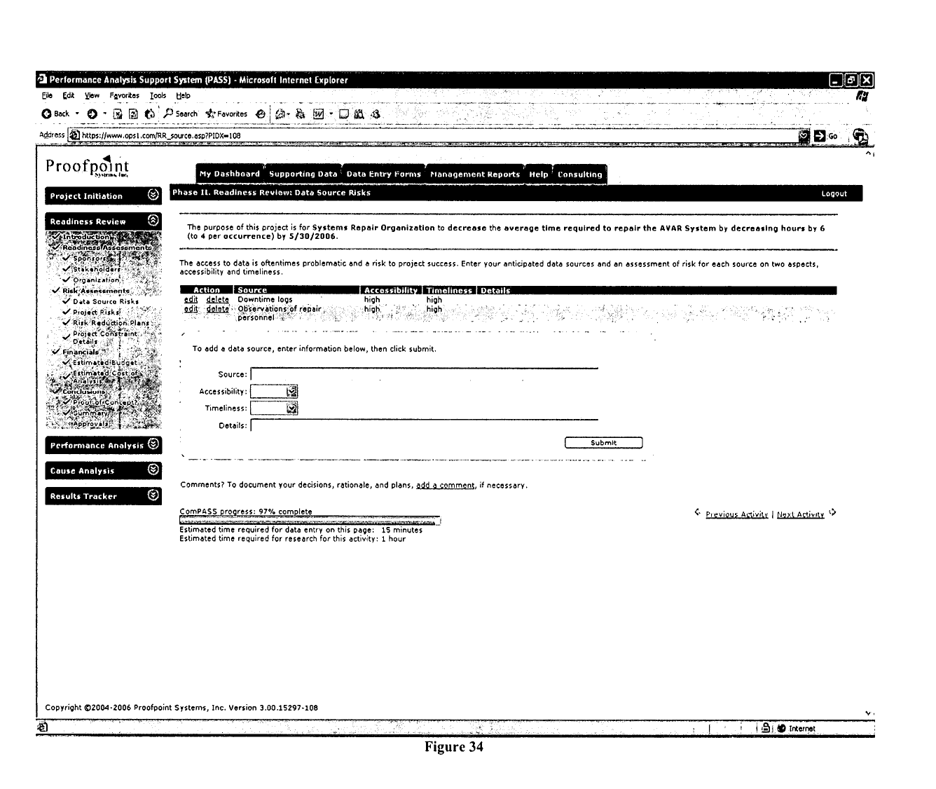

In order to assess risk associated with the performance improvement project, the user then catalogues sources of data risks, identifies project risks, develops risk reduction plans, and identifies project constraints. Following entry by the user of the perceived overall risks associated with the performance improvement project and the risk reduction plan using the screens shown in FIGS. 34-37, the performance analysis support system and method determine the level of risk to successful completion of the project to be displayed in a “Risk Assessments” screen, as shown in FIG. 33.

Considered in more detail, the user identifies the data source by entering the source of the data in a data entry box in a “Data Source Risks” screen, as shown in FIG. 34. The user also assesses the risk associated with each data source on the basis of two criteria, namely, accessibility and timeliness, and then enters any relevant details. These criteria are specified by a risk factor such as “high,” as shown in FIG. 34. The user positions the cursor of the mouse 6 on the submit button and clicks the left mouse button to input the data source and associated risk assessment to the performance analysis support system 1.

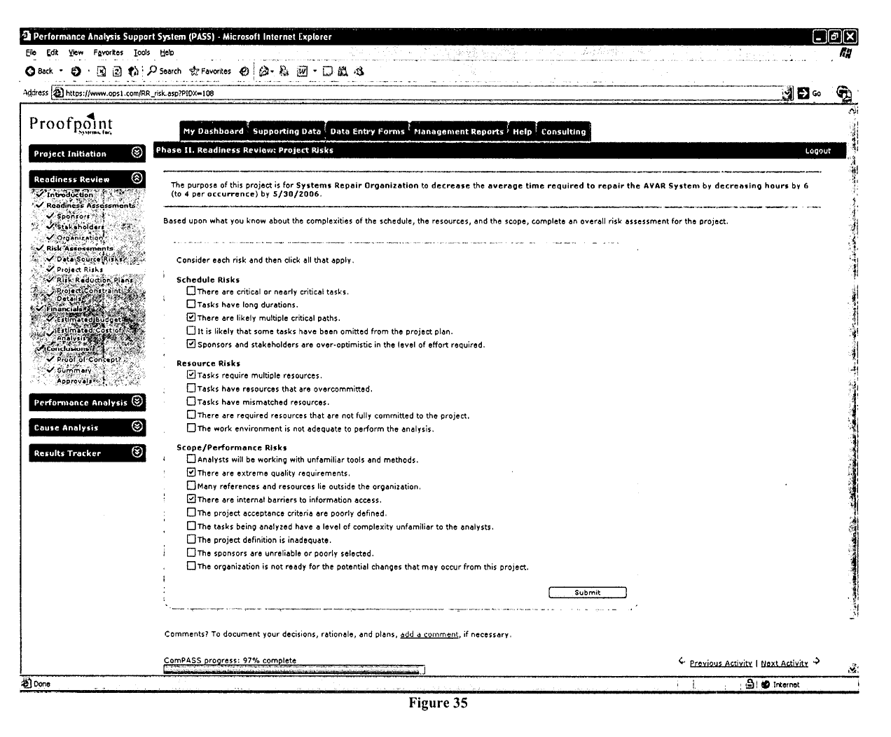

As shown in FIG. 35, the performance analysis support system and method then display a “Project Risks” screen having a form that the user completes to yield an overall risk assessment for the performance improvement project. The user assesses various categories of risks, including, for example, “Schedule Risks,” “Resource Risks,” and “Scope/Performance Risks.” The user positions the cursor of the mouse 6 on each applicable risk within each indicated category and clicks the left mouse button to identify the anticipated project risks. After the user has identified all of the potential project risks, the user positions the cursor of the mouse 6 on the submit button and clicks the left mouse button to input the overall project risk assessment data to the performance analysis support system 1.

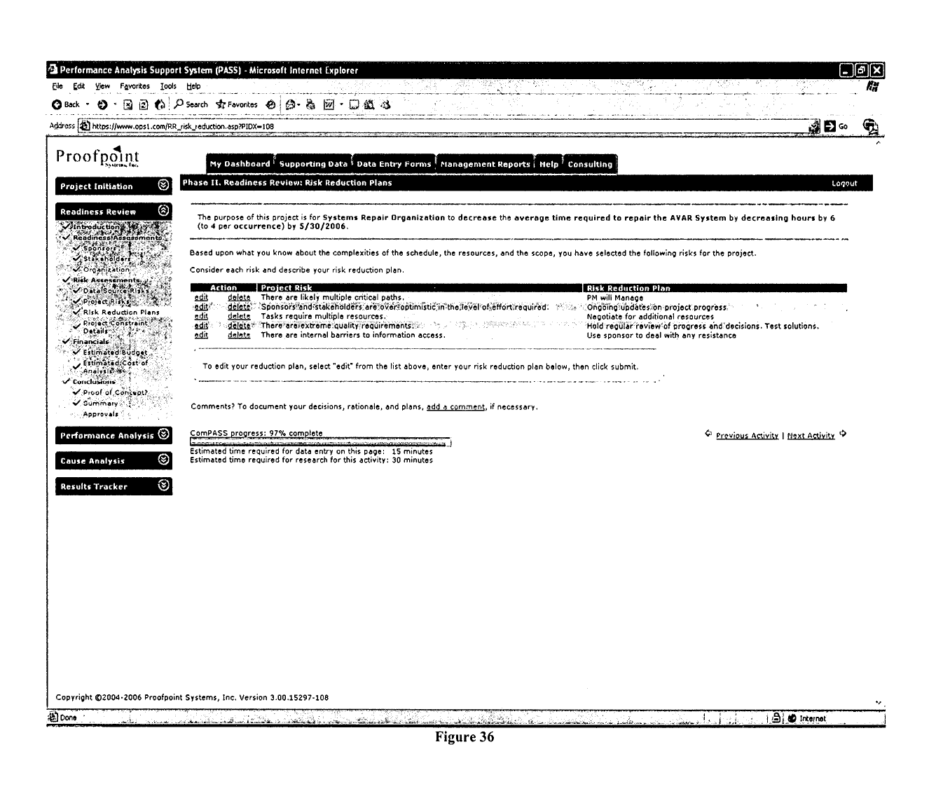

Having identified the risks to the potential success of the performance improvement project, the user is guided by the performance analysis support system and method to formulate a mitigation plan using a “Risk Reduction Plan” screen, as shown in FIG. 36. The user describes the risk mitigation plan for each project risk previously selected using the “Project Risks” screen shown in FIG. 35. To effect entry of the risk reduction plans, the user positions the cursor of the mouse 6 on each project risk and clicks the left mouse button. This enables the user to enter a statement of the risk reduction plan. After the user completes entry of the risk reduction plan, he or she positions the cursor of the mouse 6 on the submit button and clicks the left mouse button to input the project risk reduction plan to the performance analysis support system 1.

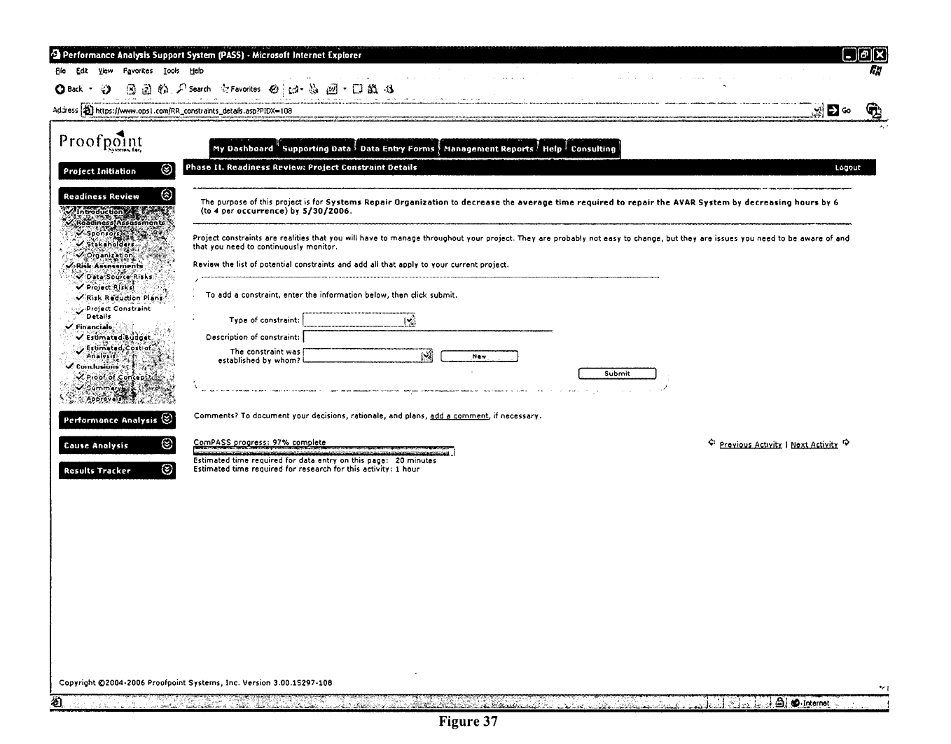

The user is also required by the performance analysis support system and method to enter each type of constraint that applies to the performance improvement project, describe the constraint, and identify the source of the constraint using the drop down lists and data entry box in a “Project Constraint Details” screen, as shown in FIG. 37. After each constraint is denominated by the user, the user positions the cursor of the mouse 6 on the submit button and clicks the left mouse button to input the constraint data to the performance analysis support system 1.

The result of the risk assessment is displayed in the “Risk Assessments” screen shown in FIG. 33. For example, the performance improvement project may have “low risk,” as shown in FIG. 33. Conversely, if the risk is determined to be substantial, the user is informed of the risk and advised to meet with the sponsor(s) to ascertain what the next appropriate action may be. Based on the result of the risk assessment, the user is preferably provided guidance on how to proceed with the project and how to advise the sponsor(s) to determine what appropriate steps may be undertaken next.

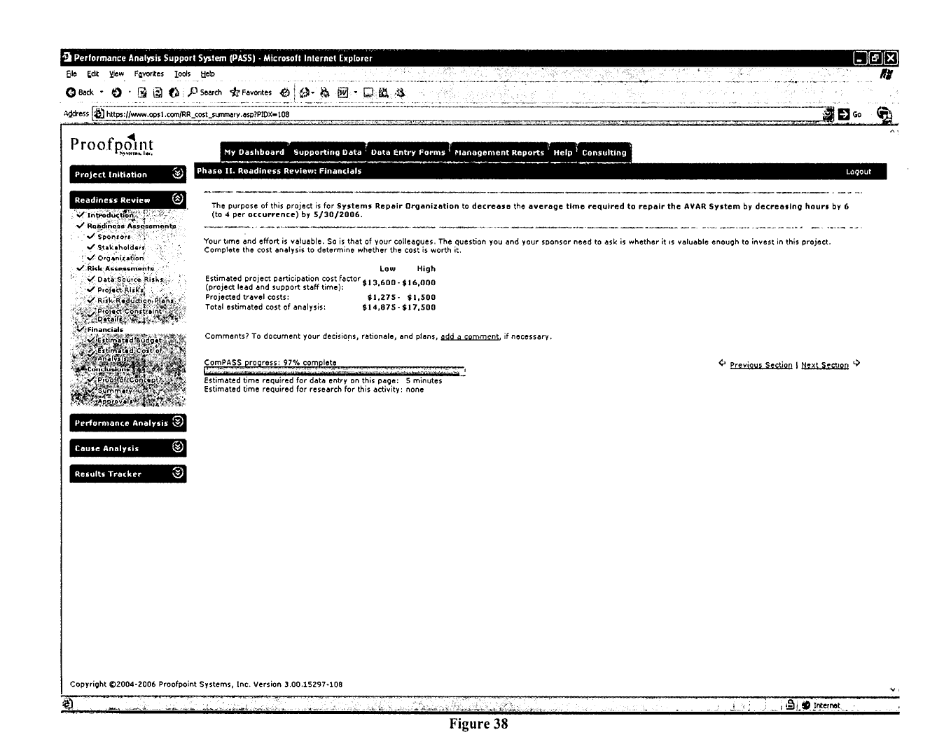

Based on the analysis cost data, the performance analysis support system and method also calculate the total estimated cost of analysis and display a cost range in a “Financials” screen, as shown in FIG. 38. Preferably, the performance analysis support system and method break down the analysis cost into the costs for staff and travel costs, which are preferably displayed as ranges, as shown in FIG. 38.

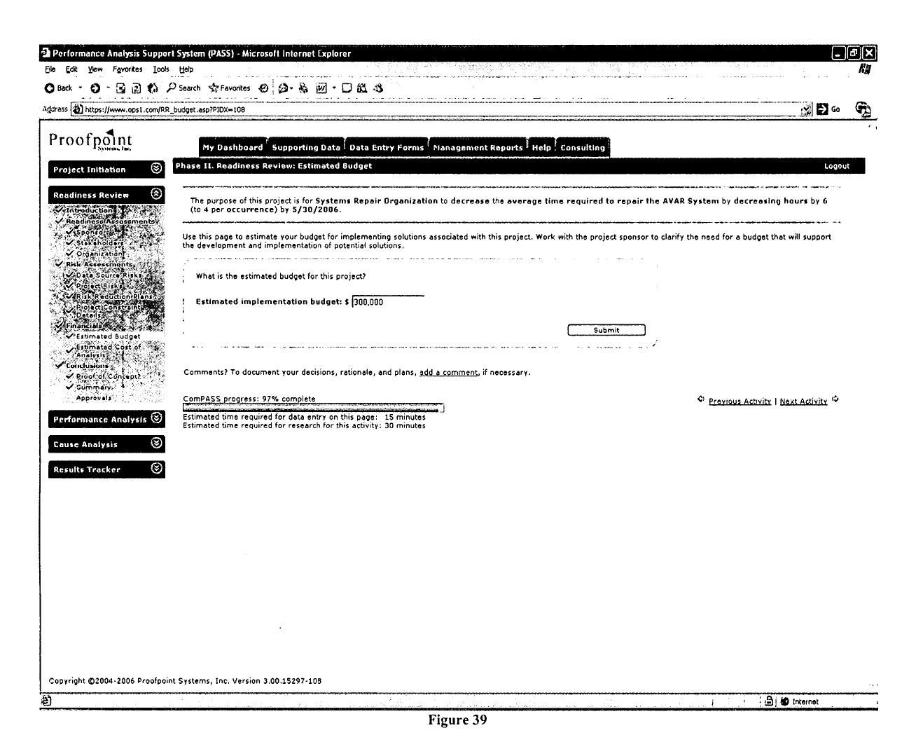

The performance analysis support system and method additionally require the user to enter the estimated budget for the performance improvement project using an “Estimated Budget” screen, as shown in FIG. 39. The user estimates the budget based on the information collected and reviewed by the user. The user then enters the total amount in a data entry box, for example, $300,000, and positions the cursor of the mouse 6 on the submit button and clicks the left mouse button to input the monetary budget to the performance analysis support system 1.

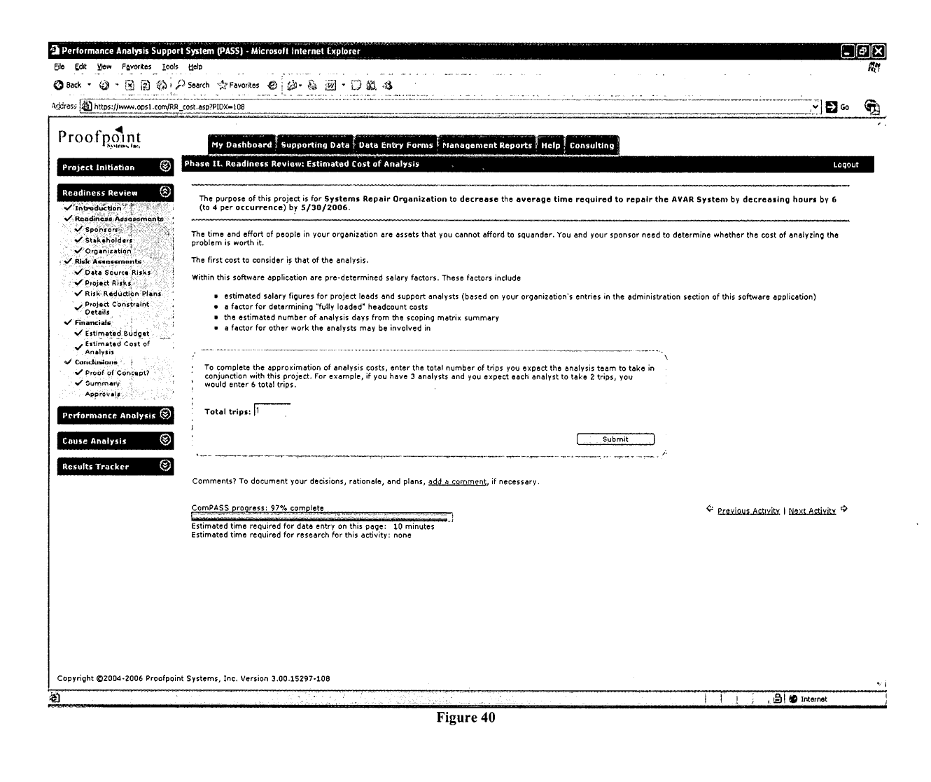

The performance analysis support system and method also calculate an estimate of the cost of the analysis for the performance improvement project. The analysis cost is based on various factors, preferably comprising: 1) estimated salary figures for project leads and support analysts entered in an administration module of the performance analysis support system 1; 2) a factor for determining fully loaded headcount costs; 3) the estimated number of analysis days from the scoping matrix summary described earlier; and 4) a factor for other work in which the analysts may be involved. To complete the approximation of the analysis cost, the user enters the total number of “trips” that he or she anticipates that the analysis team will require in connection with the project. For example, if there are three analysts, and each is expected to require two trips, the total is six trips. The user enters the total number of trips in a data entry box in an “Estimated Cost of Analysis” screen, as shown in FIG. 40. The user then positions the cursor of the mouse 6 on the submit button and clicks the left mouse button to input the analysis cost estimate data to the performance analysis support system 1.

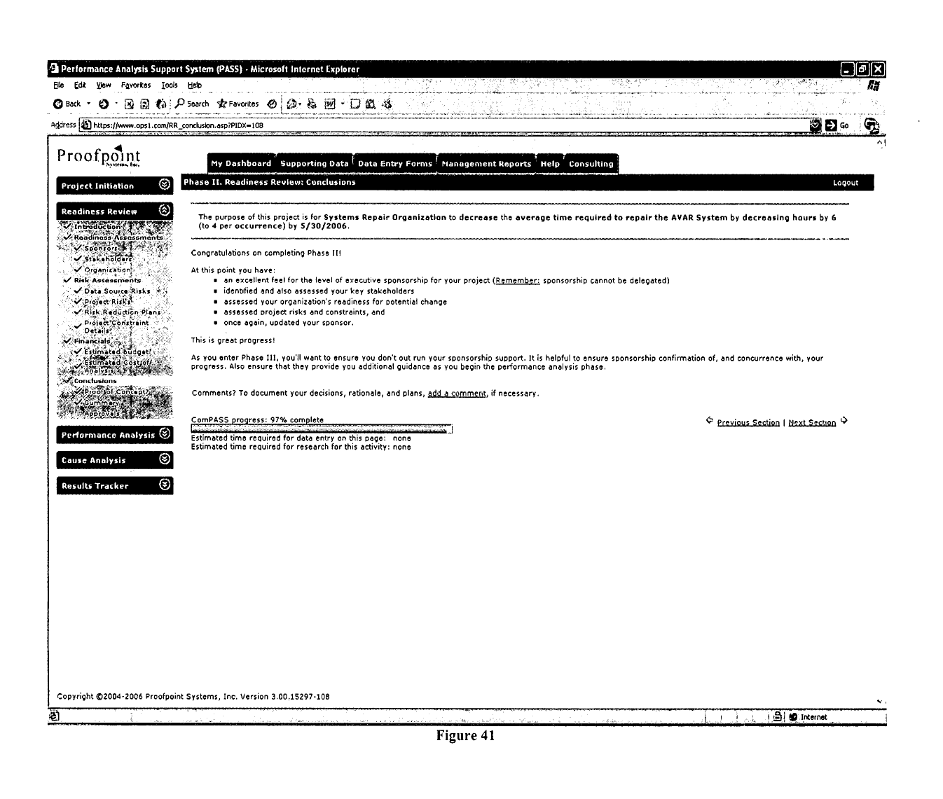

It is to be noted that although a series of screens and sequence of data entry and selections by the user have been described in connection with the Readiness Review phase, the screens may be accessed in any order and at different times according to when the user accesses the performance analysis support system 1 and enters the data. The performance analysis support system and method track the entry of data and discern when the user has completed all of the required inputs to complete the Readiness Review phase and displays a “Conclusions” screen, as shown in FIG. 41.

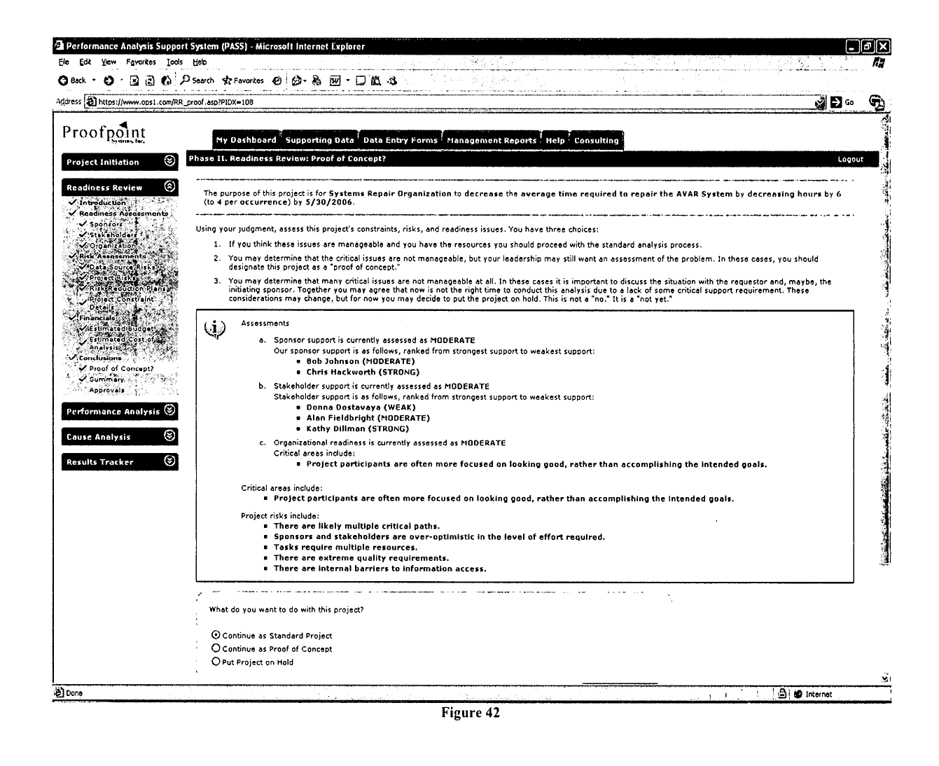

The performance analysis support system and method additionally display a “Proof of Concept” screen, as shown in FIG. 42, to query the user whether or not critical issues are manageable. If so, the user is advised to proceed with the project. If not, the user is advised to determine whether or not the business/organization wants to continue with the analysis of the problem, in which case the project becomes a “proof of concept.” If many critical issues appear to be unmanageable, the user is advised to place the project on hold.

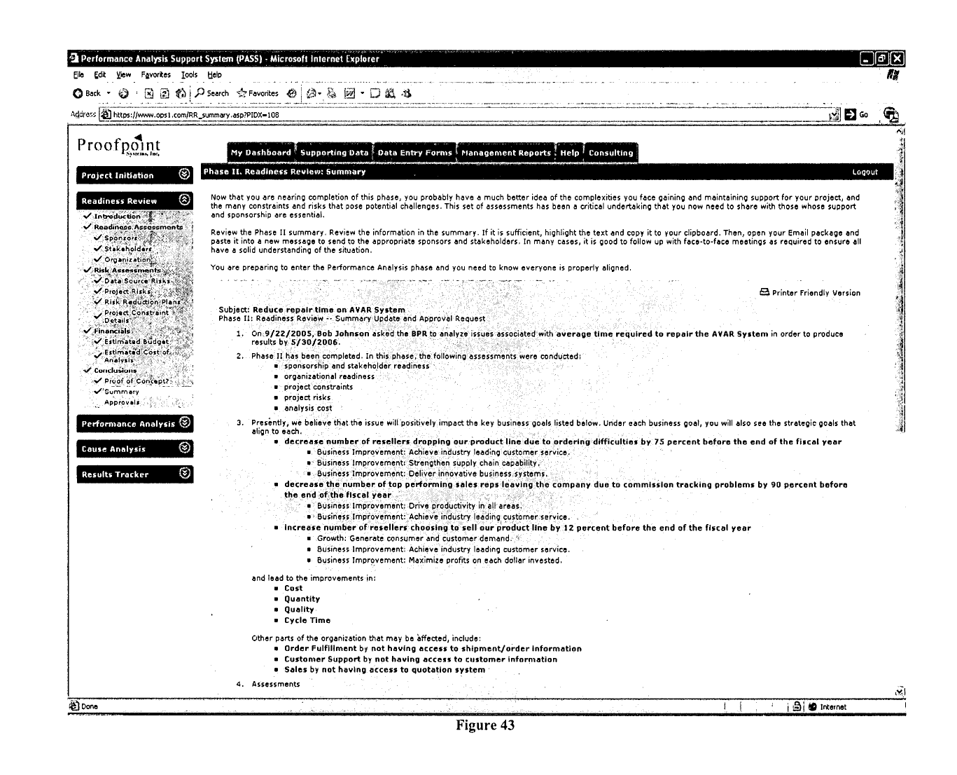

The performance analysis support system and method then assemble a summary of the Readiness Review phase in a “Summary” screen, as shown in FIG. 43. The information assembled in the “Summary” screen shown in FIG. 43 is then preferably forwarded to the project sponsor(s) and other stakeholders. For example, the “Summary” may be included in an email and sent to the project sponsor(s) and stakeholders for review.

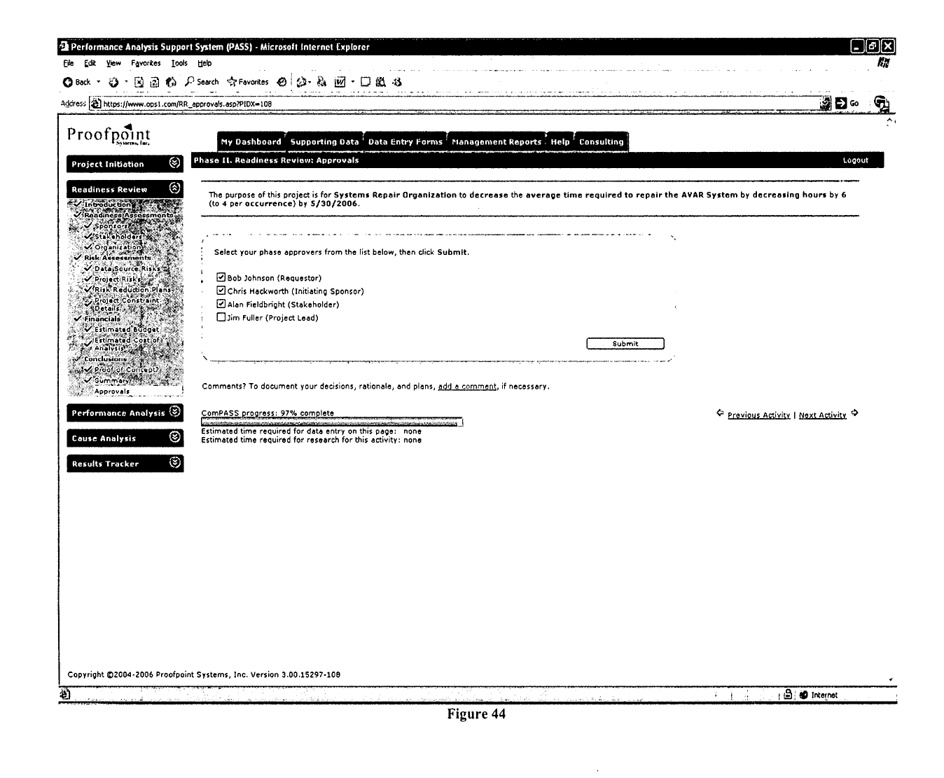

The performance analysis support system and method then display an “Approvals” screen for the Readiness Review phase, as shown in FIG. 44. The “Approvals” screen includes a check box(es) on which the user positions the cursor of the mouse 6 and clicks the left mouse button to indicate which sponsor(s) and stakeholders will receive a task in the “My Messages” area of their dashboard shown in FIG. 3 directing them to approve or disapprove the status of the Readiness Review phase. Once the request for approval has been submitted, the “Approvals” screen shown in FIG. 44 displays the current approval status by the sponsor(s) and stakeholders.

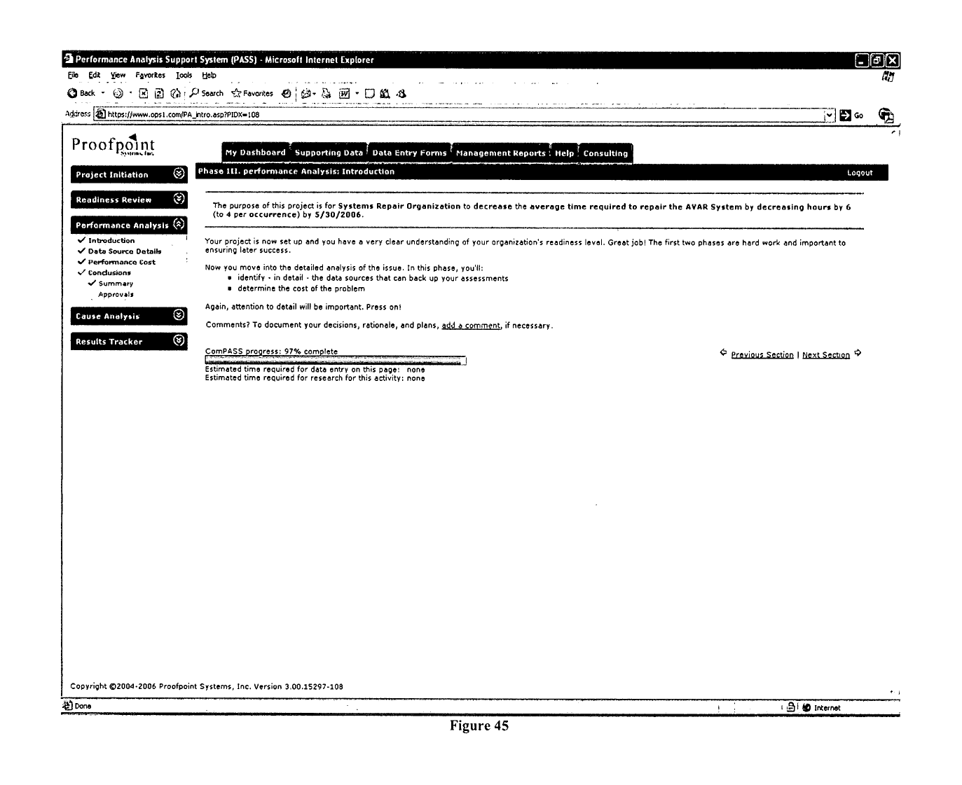

The third phase of the performance improvement project is the “Performance Analysis” phase. As described in an “Introduction” screen shown in FIG. 45, the focus of the “Performance Analysis” phase entails identifying, in detail, the data sources that validate the assessments and determining the cost of the performance problem.

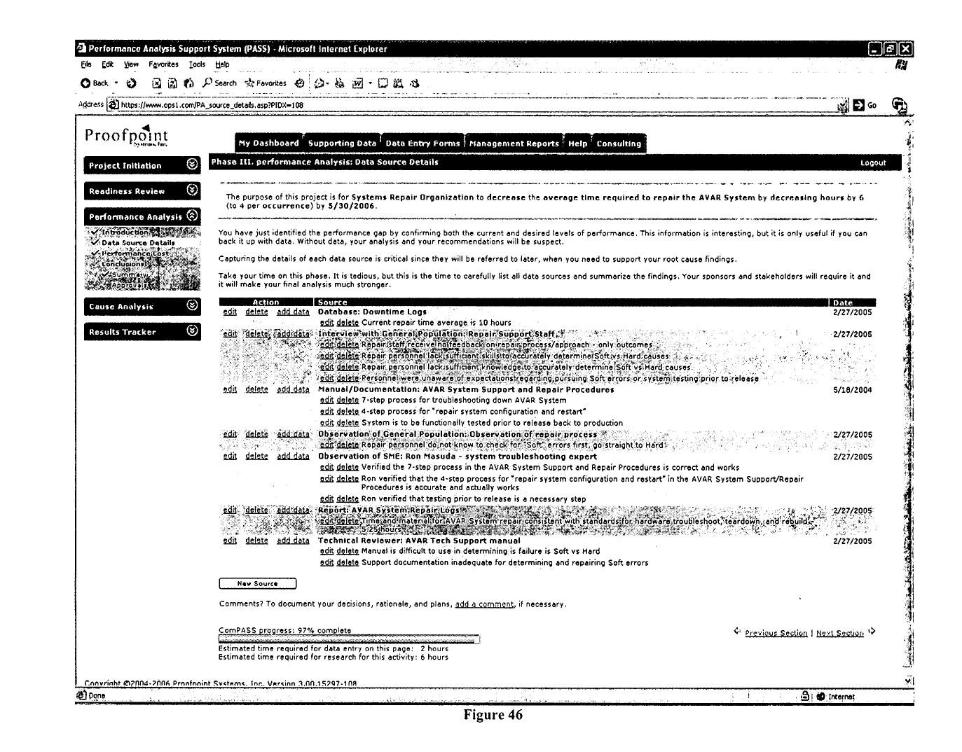

The performance analysis support system and method guide the user to validate the analysis and subsequent recommendations with verifiable data. Capturing the details of each data source is critical, because the user will reference the data sources later, when the user needs to support the root cause findings relating to the performance problem. In order to enable the user to enter the sources of data, the performance analysis support system and method display a “Data Source Details” screen, as shown in FIG. 46. The user can add new data sources or add data to existing data sources. To add a new source, the user positions the cursor of the mouse 6 on a “New Source” button and clicks the left mouse button. The user then selects the type of source from the drop down list, enters the name of the data source, and enters the date of the data source. The user then positions the cursor of the mouse 6 on the submit button and clicks the left mouse button to input the new data source to the performance analysis support system 1. To add data to an existing data source, the user positions the cursor of the mouse 6 on “add data” under the “Action” heading and clicks the left mouse button to enter data. The user uses the keyboard 8 to enter the source of data, for example, “Database: Downtime Logs.” As data is collected, the user positions the cursor of the mouse 6 on “add data” under the “Action” heading corresponding to the data source and uses the keyboard 8 to enter specific data, for example, “Current repair time average is 10 hours” under the identified “Database: Downtime Logs” data source. The user then positions the cursor of the mouse 6 on the submit button and clicks the left mouse button to input the detailed data to the performance analysis support system 1.

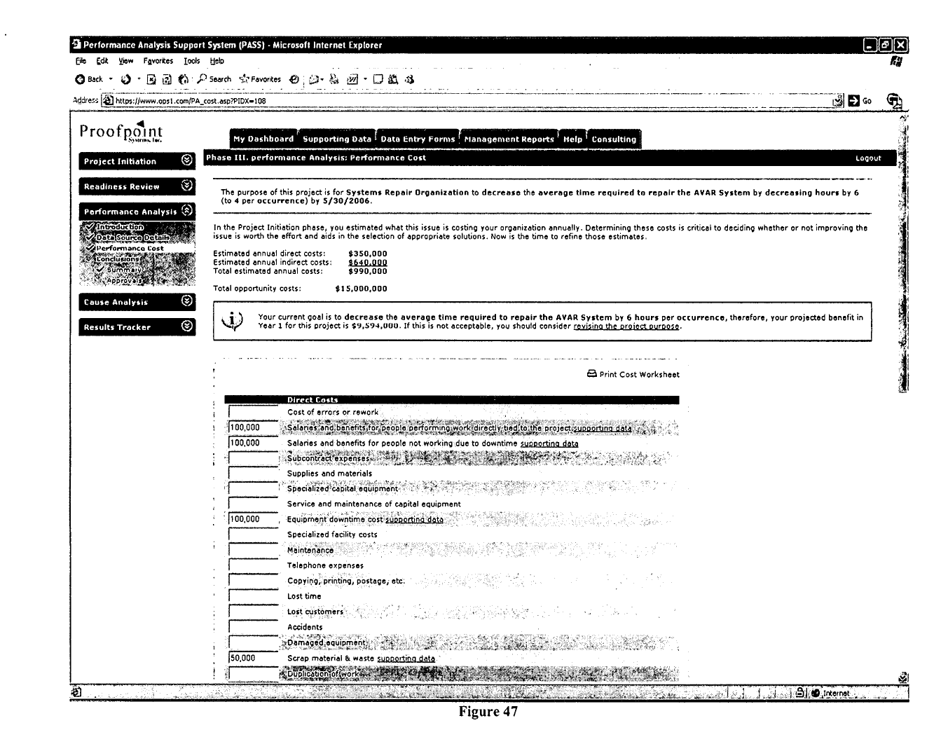

The performance analysis support system and method also enable the user to revise his or her estimate of the cost of the performance problem entered during the Project Initiation phase. See FIG. 24. If the user needs to change the cost estimate, he or she revises the entries in the data entry boxes of a “Performance Cost” screen, as shown in FIG. 47.

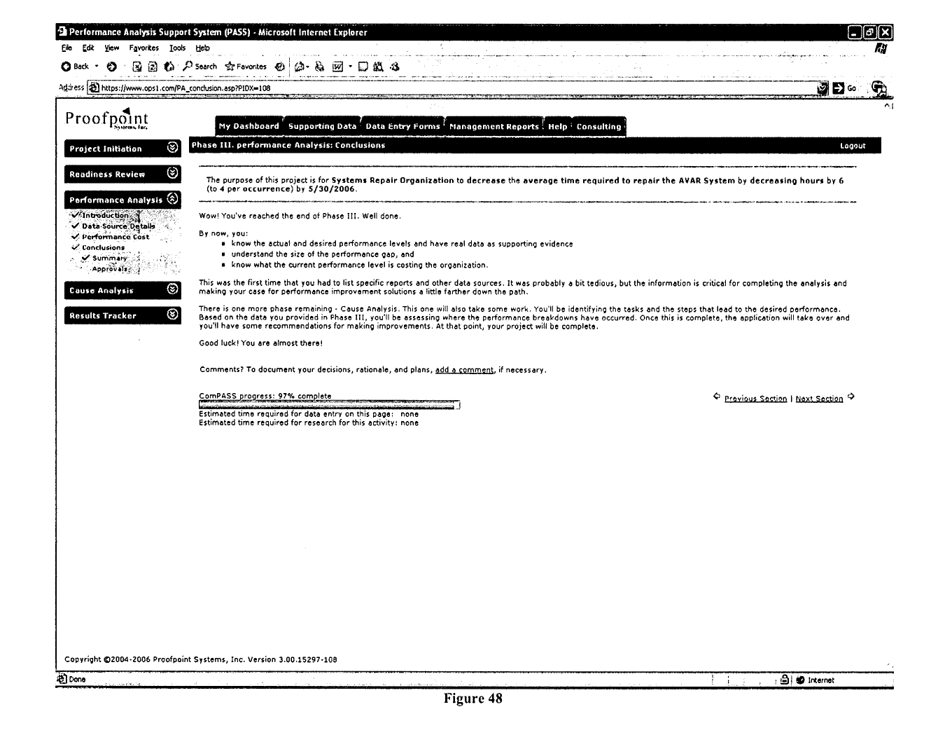

It is to be noted that although a series of screens and sequence of data entry and selections by the user have been described in connection with the Performance Analysis phase, the screens may be accessed in any order and at different times according to when the user accesses the performance analysis support system 1 and enters the data. The performance analysis support system and method track the entry of data and discern when the user has completed all of the required inputs to complete the Performance Analysis phase and displays a “Conclusions” screen, as shown in FIG. 48.

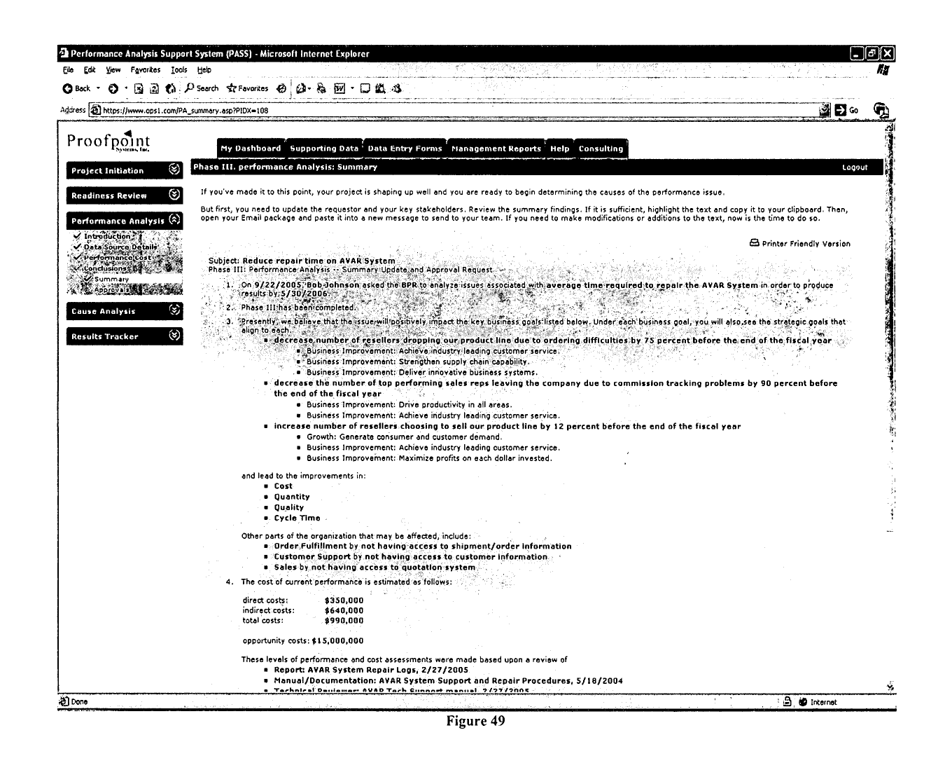

The performance analysis support system and method then assemble a summary of the Performance Analysis phase in a “Summary” screen, as shown in FIG. 49. The information assembled in the “Summary” screen shown in FIG. 49 is then preferably forwarded to the project sponsor(s) and other stakeholders. For example, the “Summary” may be included in an email and sent to the project sponsor(s) and stakeholders for review.

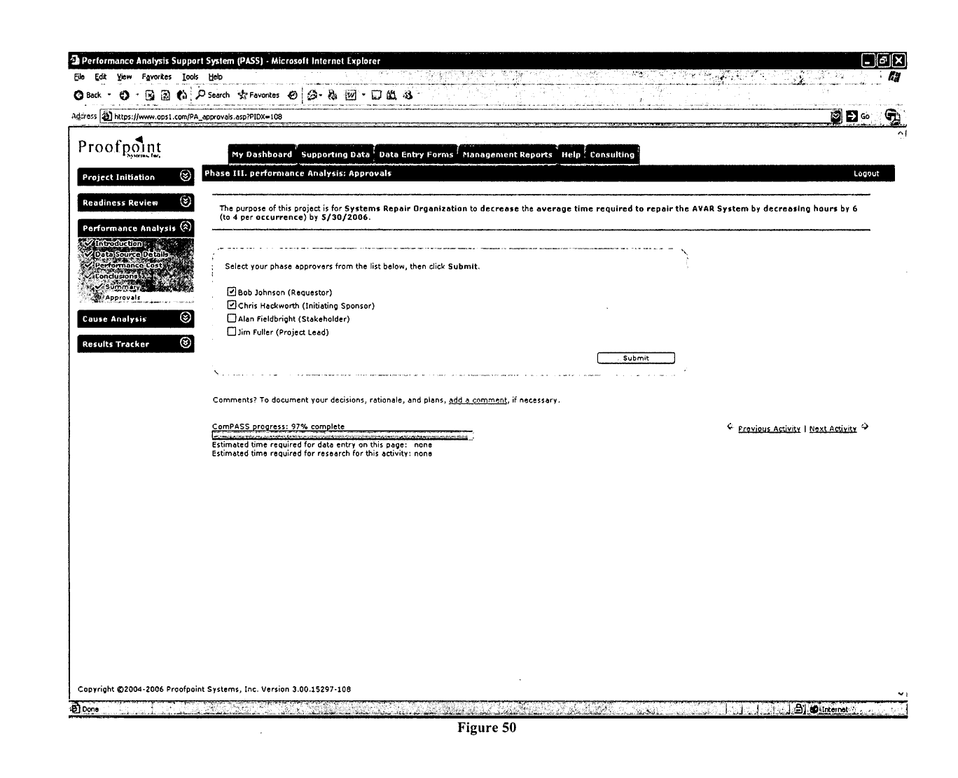

The performance analysis support system and method then display an “Approvals” screen for the Performance Analysis phase, as shown in FIG. 50. This “Approvals” screen includes a check box(es) on which the user positions the cursor of the mouse 6 and clicks the left mouse button to indicate which sponsor(s) and stakeholders will receive a task in the “My Messages” area of their dashboard shown in FIG. 3 directing them to approve or disapprove the status of the Performance Analysis phase. Once the request for approval has been submitted, the “Approvals” screen shown in FIG. 50 displays the current approval status by the sponsor(s) and stakeholders.

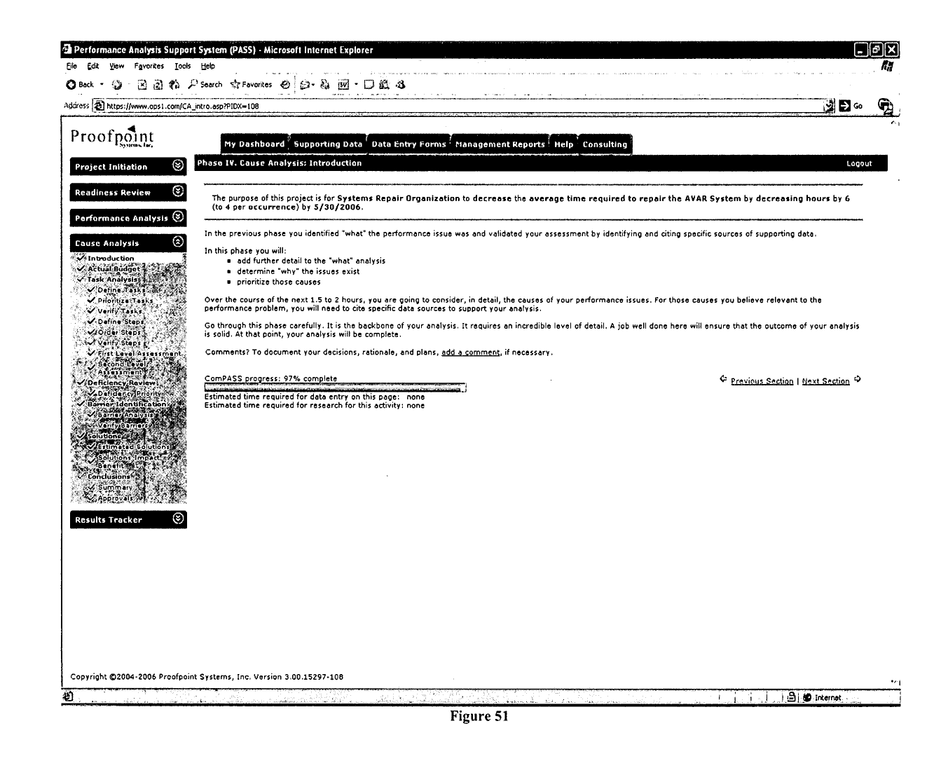

The fourth phase of the performance improvement project is the “Cause Analysis” phase. As described in an “Introduction” screen shown in FIG. 51, the focus of the “Cause Analysis” phase is to identify the tasks and the steps that lead to the desired performance improvement and assess where the performance breakdowns have occurred based on the data entered during the Performance Analysis phase. As is the case during the Performance Analysis phase, the user is guided by the performance analysis support system and method during the Cause Analysis phase to reference specific data sources to support the analysis of the causes that relate to the performance problem. The performance analysis support system and method then generate recommendations for effecting the performance improvement.

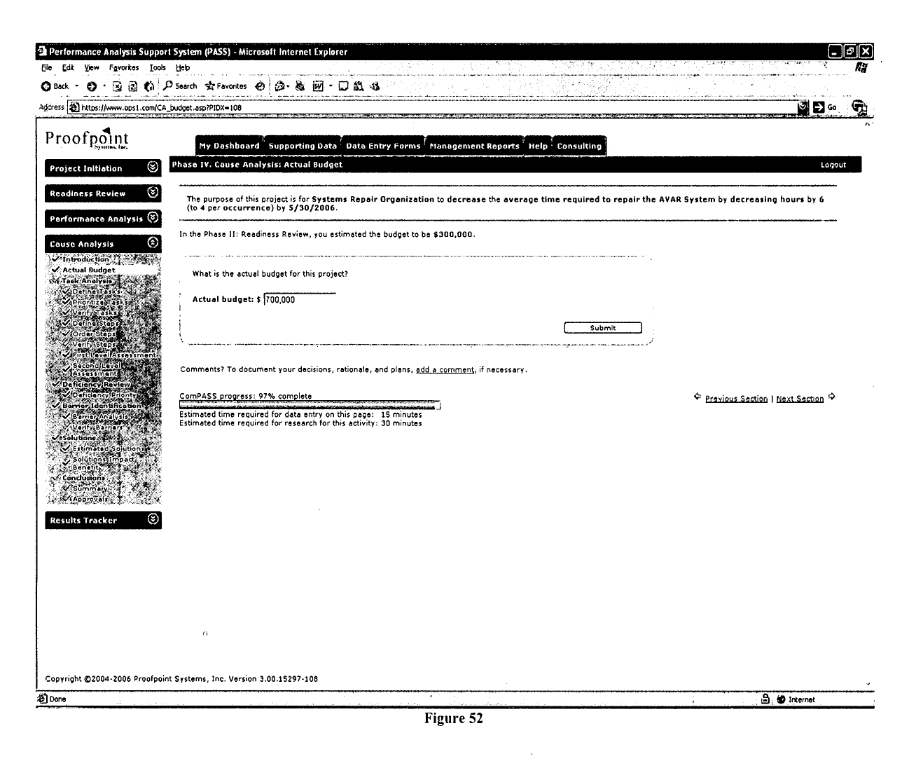

Referring to FIG. 52, the user reviews the initially projected budget for the performance project that he or she entered during the Readiness Review phase. See FIG. 39. Based on data collected by the user, the user either confirms the budget or revises the budget for the performance improvement project by entering the appropriate monetary cost, for example, $700,000, in a data entry box in an “Actual Budget” screen displayed by the performance analysis support system 1, as shown in FIG. 52. After the actual budget is entered, the user positions the cursor of the mouse 6 on the submit button and clicks the left mouse button to input the actual budget to the performance analysis support system 1.

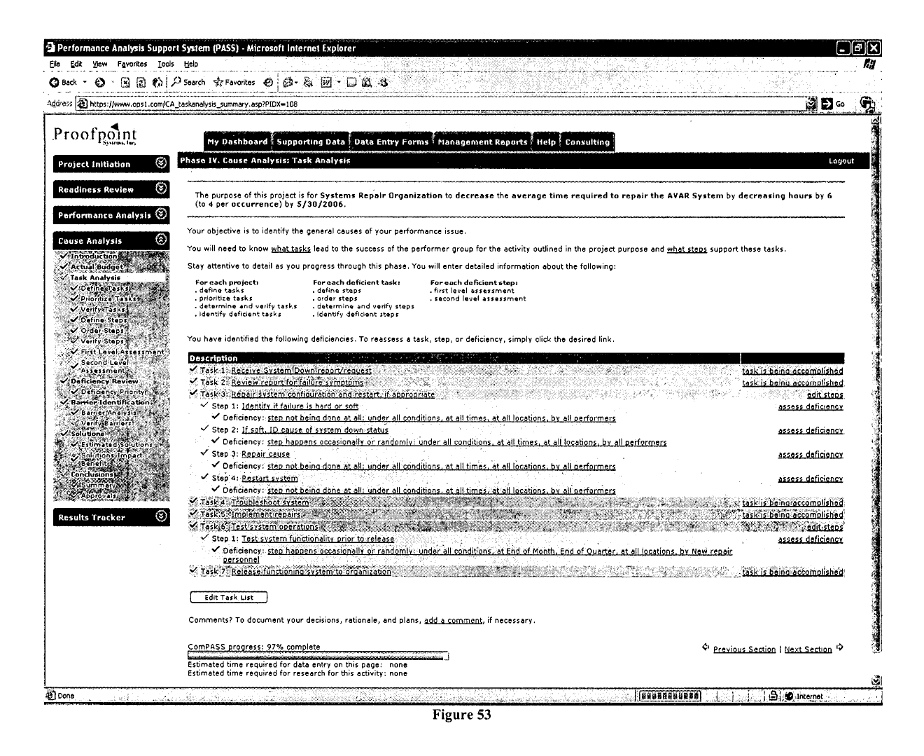

The user then initiates the procedure of investigating the general causes of the performance problem. To do so, the user identifies the tasks that lead to the success of the performer group and the one or more steps that the performer group executes to accomplish each task. The user also notes any deficiency in the execution. The entries are assembled in a “Task Analysis” screen, as shown in FIG. 53. The following describes the entry of the associated information by the user.

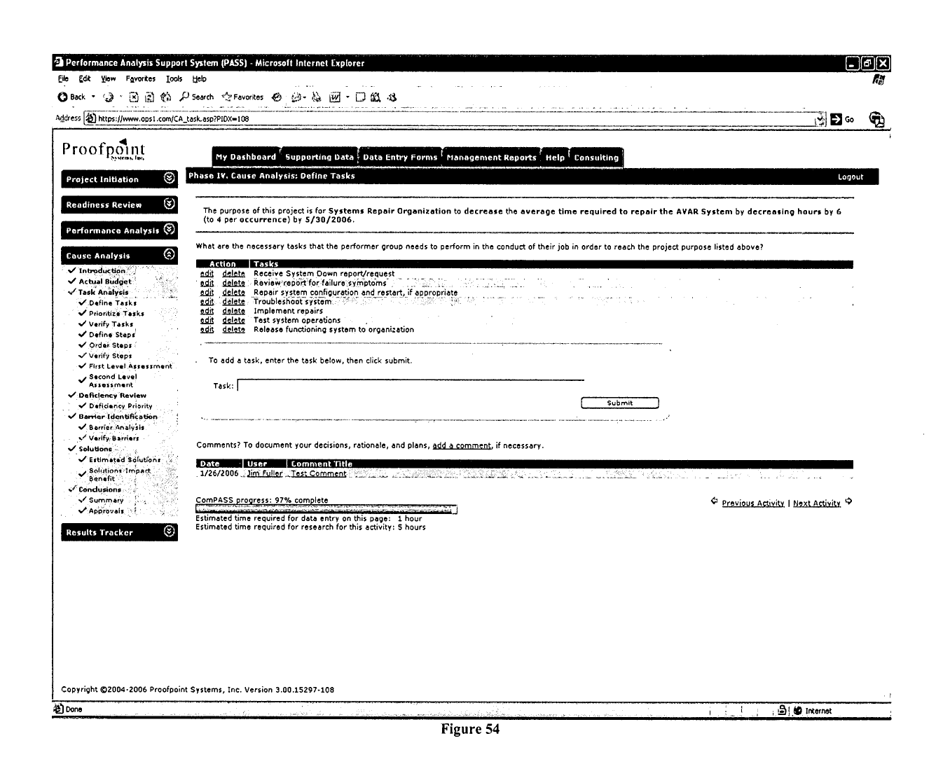

In order to identify the tasks of the performer group that are necessary to accomplish the performance improvement intended by the project, the performance analysis support system and method display a “Define Tasks” screen, as shown in FIG. 54. The user performs a breakdown of the tasks that must be completed by the performer group and enters each task in a data entry box and then positions the cursor of the mouse 6 on the submit button and clicks the left mouse button to compile the list of tasks.

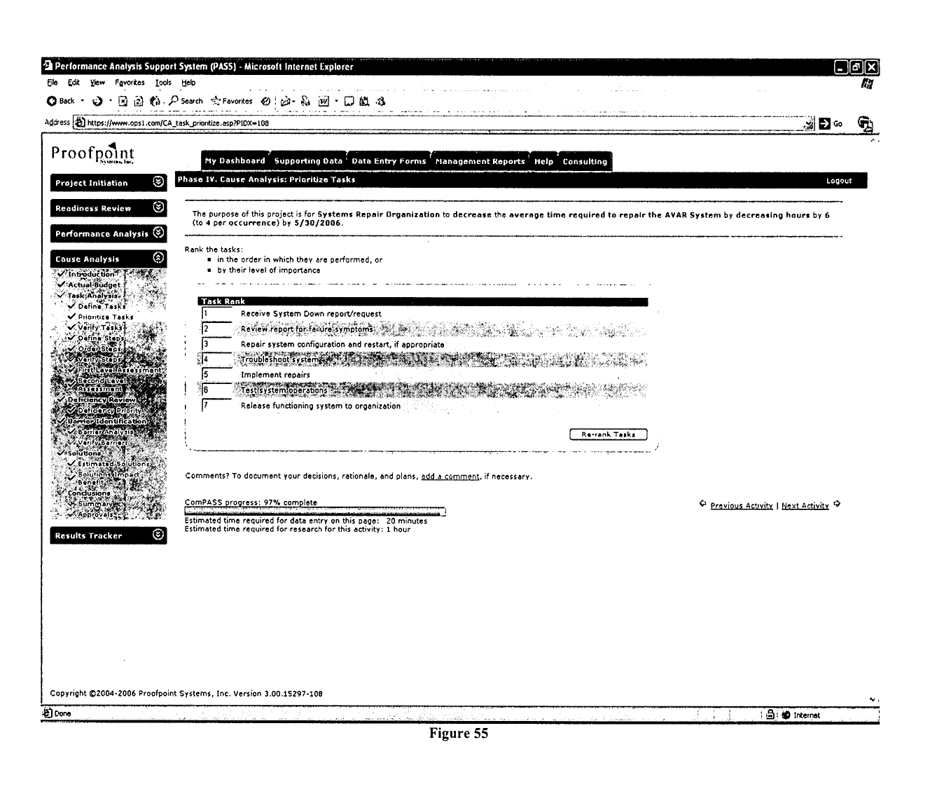

After the user has entered a complete list of the tasks that must be accomplished for a successful outcome, the user ranks the tasks using a “Prioritize Tasks” screen displayed by the performance analysis support system 1, as shown in FIG. 55. By default, the tasks are prioritized in the order in which they were entered by the user, as is apparent from a comparison of FIG. 54 to FIG. 55. The “Prioritize Tasks” screen facilitates the user re-ranking the tasks according to different priorities by enabling the user to alter the “Task Rank” and thereby assign a different set of priorities. After the user has completed prioritizing the tasks, he or she positions the cursor of the mouse 6 on a “Re-rank Tasks” button and clicks the left mouse button to input the appropriate priorities to the performance analysis support system 1.

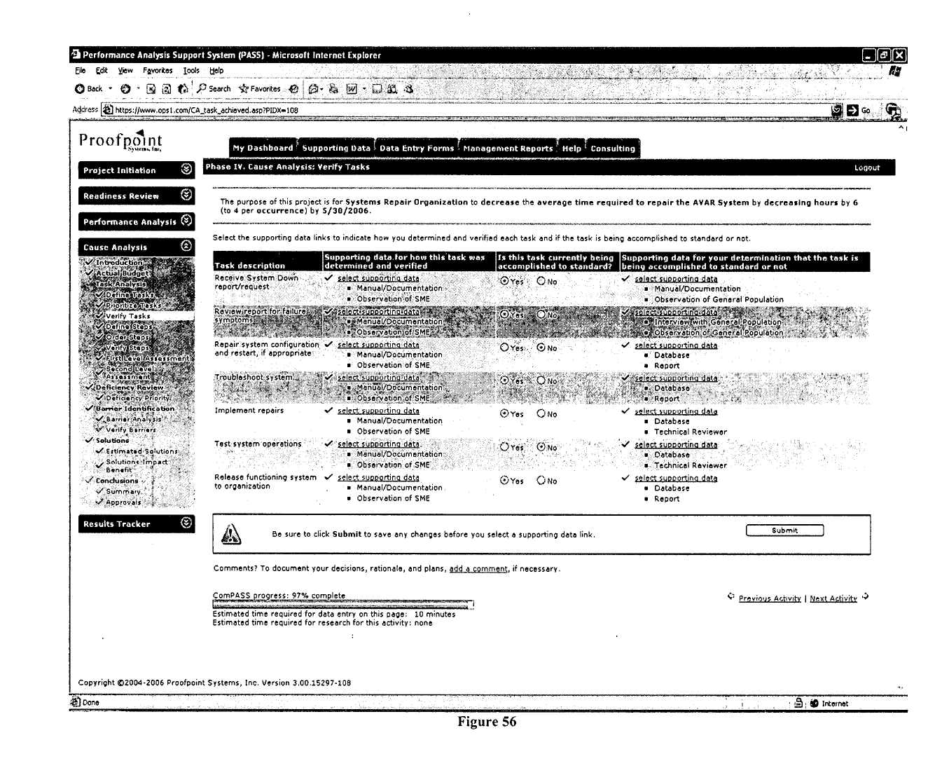

In accordance with the principles underlying the present invention, the performance analysis support system and method require the user to enter the basis on which the tasks were determined and provide verification. As shown in FIG. 56, a “Verify Tasks” screen is displayed by the performance analysis support system 1 to enable the user to indicate how he or she determined and verified the tasks, as well as to add comments to document his or her decisions, rationale, and plans.

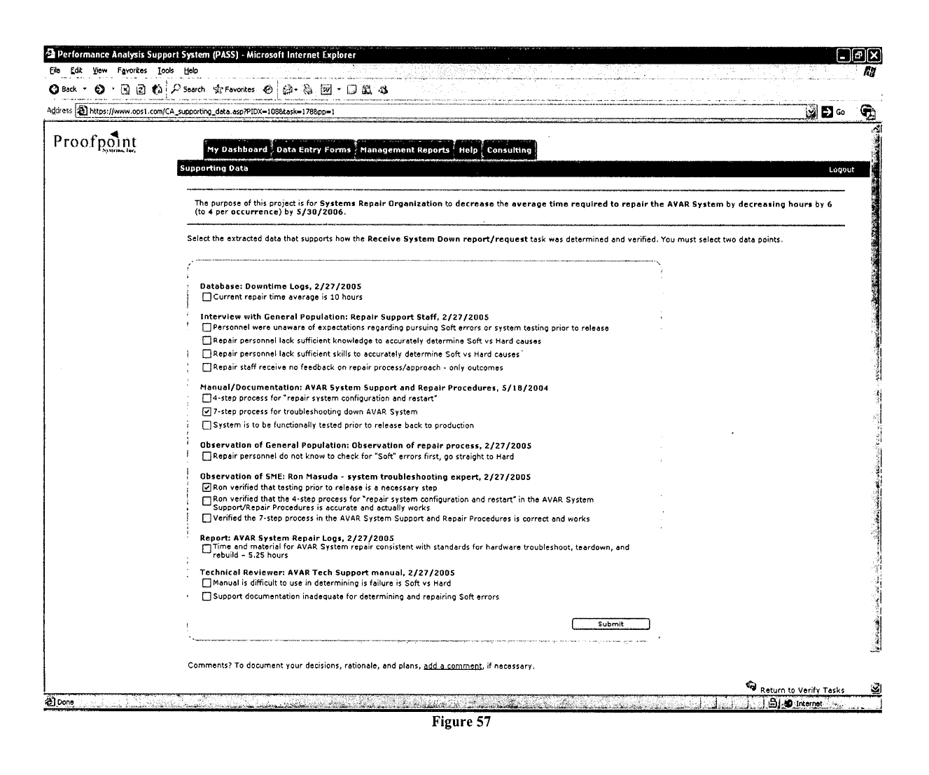

As shown in FIG. 57, the user positions the cursor of the mouse 6 on each of the check boxes corresponding to the applicable bases for determination and clicks the left mouse button to document how the tasks were determined. For example, in the example in which the purpose of the project is for the Systems Repair Organization to decrease the average time required to repair the AVAR System by decreasing hours by 6 (to 4 per occurrence) by May 30, 2006, the task of “Receive System Down report/request” was determined by reference to “Manual/Documentation” and “Observation of SME.” After all bases are appropriately checked for all identified tasks, the user positions the cursor of the mouse 6 on the submit button and clicks the left mouse button to input the task determination information to the performance analysis support system 1. As shown in FIG. 57, the user may also add comments to document his or her decisions, rationale, and plans. Preferably, at least two data sources must be identified to signify that the determination has been verified.

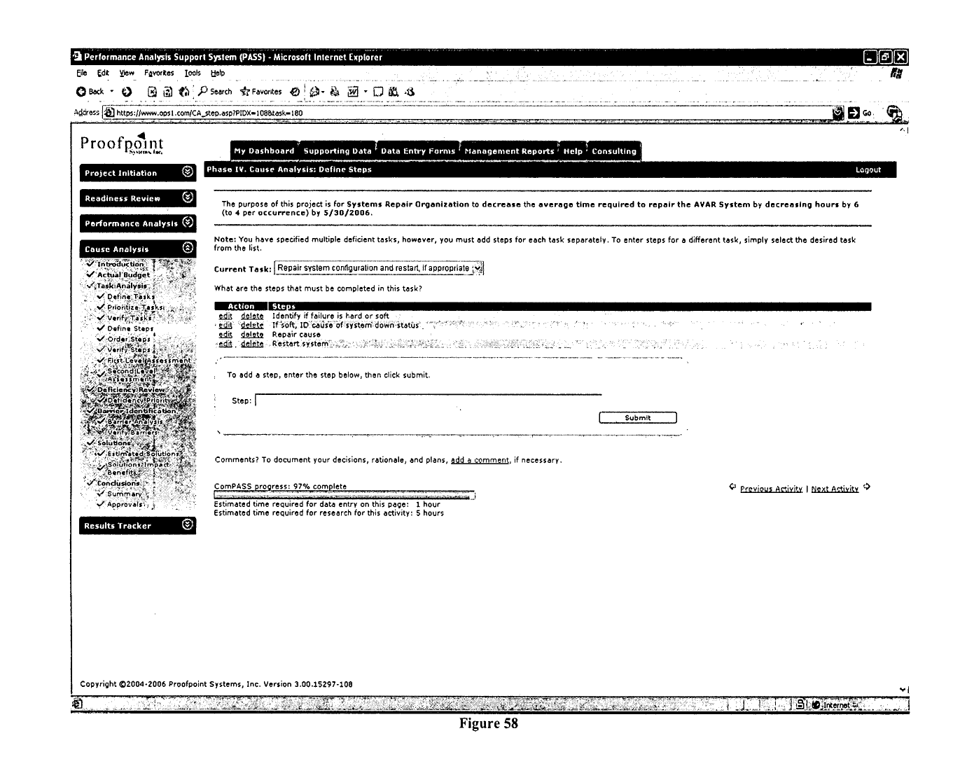

A similar approach is employed respecting the steps to accomplish each task. As shown in FIG. 58, a “Define Steps” screen is displayed by the performance analysis support system 1 to enable the user to identify the steps that must be completed to accomplish each previously specified task. The list of tasks appears in a drop down list associated with a box labeled “Current Task.” For example, the specified task may be “Repair system configuration and restart, if appropriate.” The user enters each required step in a data entry box labeled “Step” shown in FIG. 58 and then positions the cursor of the mouse 6 on the submit button and clicks the left mouse button to add the step to a list of steps needed to accomplish the specified task. For example, the steps may include “Identify if failure is hard or soft,” “If soft, ID cause of system down status,” “Repair cause,” and “Restart system.” As shown in FIG. 58, the user may also add comments to document his or her decisions, rationale, and plans.

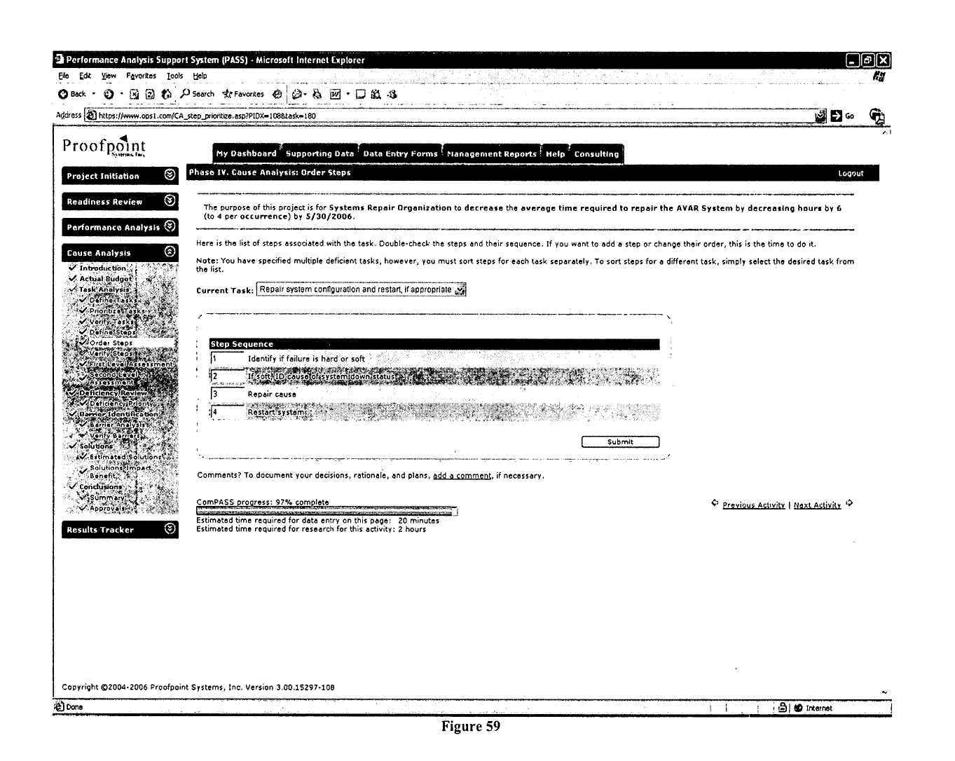

After the steps for each task are delineated by the user, an “Order Steps” screen is displayed by the performance analysis support system 1 to enable the user to specify the sequence of the steps that must be completed to accomplish the identified task, as shown in FIG. 59. The list of tasks appears in a drop down list associated with a box labeled “Current Task.” For example, the specified task may be “Repair system configuration and restart, if appropriate.” The user defines an order for the required steps previously entered by the user in the “Define Steps” screen shown in FIG. 58 and then positions the cursor of the mouse 6 on the submit button and clicks the left mouse button to define the sequence of the steps needed to accomplish the specified task. For example, the sequence of steps may include a first step of “Identify if failure is hard or soft,” a second step of “If soft, ID cause of system down status,” a third step of “Repair cause,” and a fourth step of “Restart system.” By default, the steps are ordered in the sequence in which they were entered by the user, as is apparent from a comparison of FIG. 58 to FIG. 59. As shown in FIG. 59, the user may also add comments to document his or her decisions, rationale, and plans.

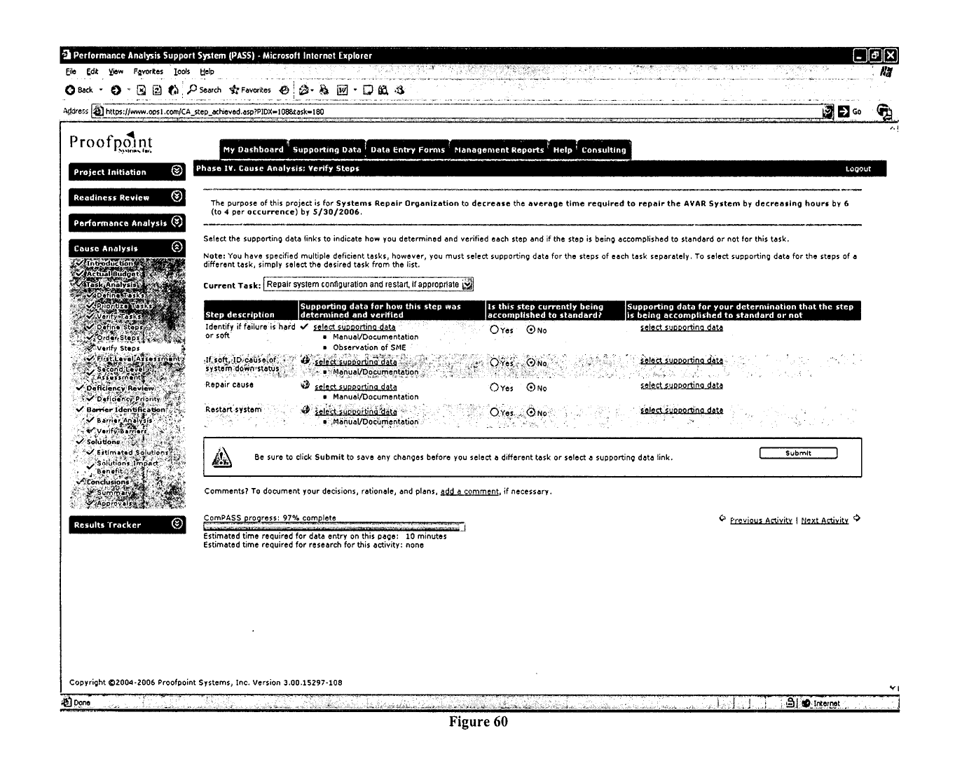

As shown in FIG. 60, a “Verify Steps” screen is displayed by the performance analysis support system 1 to enable the user to indicate how he or she determined the steps for each task, as well as to add comments to document his or her decisions, rationale, and plans. The user positions the cursor of the mouse 6 on the select supporting data link and clicks the left mouse button to display the selection screen of all available supporting data points. The type of data source is then specified by the user, for example, based on database, manual or documentation, report, technical reviewer, or observations, interviews, or surveys of the general population, master performer, SME, or manager. For example, in the example in which the task is “Repair system configuration and restart, if appropriate,” the step of “Identify if failure is hard or soft” was determined by reference to “Manual/Documentation” and “Observation of SME.” The user also positions the cursor of the mouse 6 and clicks the left mouse button to indicate whether or not the task is currently being accomplished to a standard and enters the supporting data used to arrive at that determination. After all data sources are appropriately checked for all identified steps for the specified task, the user positions the cursor of the mouse 6 on the submit button and clicks the left mouse button to input the step determination information to the performance analysis support system 1. As shown in FIG. 60, the user may also add comments to document his or her decisions, rationale, and plans. Preferably, at least two data sources must be identified to signify that the determination has been verified.

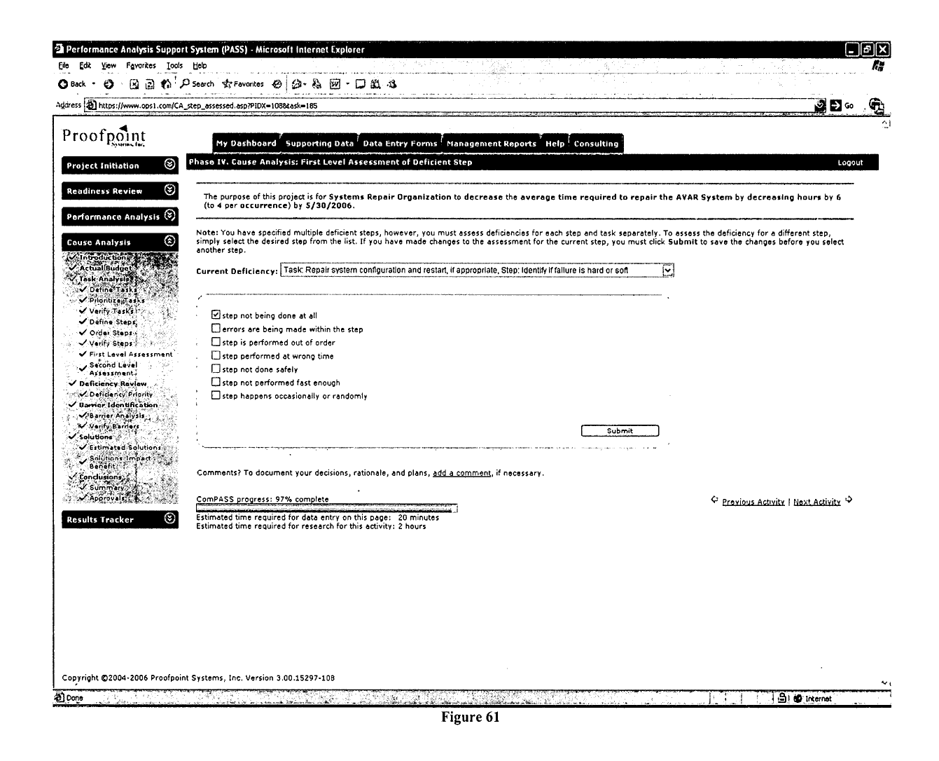

After the steps for each task are verified, a “First Level Assessment” screen is displayed by the performance analysis support system 1 to enable the user to perform a first level assessment of a deficient step, as shown in FIG. 61. The user assesses deficiencies for each step of each task. Each step for each specified task appears in a drop down list associated with a box labeled “Current Deficiency,” as shown in FIG. 61. For example, the step may be “Identify if failure is hard or soft,” which is one of the steps corresponding to the task “Repair system configuration and restart, if appropriate.” The user positions the cursor of the mouse 6 on one or more of the check boxes that appear in the “First Level Assessment” screen shown in FIG. 61 and clicks the left mouse button on each check box to select the bases for the deficiency of each step. For example, the deficiency may be “step not being done at all,” as shown in FIG. 61. Other deficiencies may include “errors are being made within the step,” “step is performed out of order,” “step performed at wrong time,” “step not done safely,” “step not performed fast enough,” and “step happens occasionally or randomly.” After all deficiencies are appropriately checked for each step for the specified task, the user positions the cursor of the mouse 6 on the submit button and clicks the left mouse button to input the step deficiency information to the performance analysis support system 1. As shown in FIG. 61, the user may also add comments to document his or her decisions, rationale, and plans.

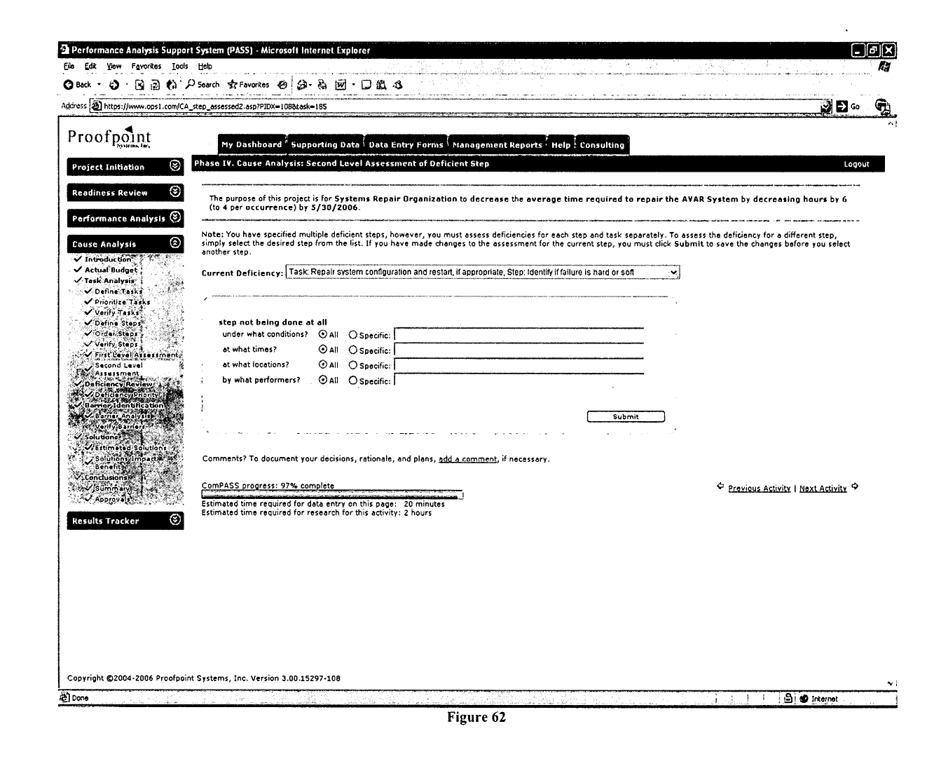

After a first level assessment has been performed by the user, a “Second Level Assessment” screen is displayed by the performance analysis support system 1 to enable the user to perform a second level assessment of a deficient step, as shown in FIG. 62. The user assesses bases for deficiencies for each step of each task. Each step for each specified task appears in a drop down list associated with a box labeled “Current Deficiency,” as shown in FIG. 62. For example, the step may be “Identify if failure is hard or soft,” which is one of the steps corresponding to the task “Repair system configuration and restart, if appropriate.” The user positions the cursor of the mouse 6 on one or more of the bubbles that appear in the “Second Level Assessment” screen shown in FIG. 62 for each of the previously identified deficiencies selected using the “First Level Assessment” screen shown in FIG. 61 and clicks the left mouse button on each bubble to select the bases for the deficiency of each step. The bases for the deficiencies may include “under what conditions?,” “at what times?,” “at what locations?,” and “by what performers?” For example, “step not being done at all” occurs under “All” conditions at “All” times and locations by “All” performers, as shown in FIG. 62. After all bases for each deficiency of each step for the specified task are appropriately selected, the user positions the cursor of the mouse 6 on the submit button and clicks the left mouse button to input the step deficiency information to the performance analysis support system 1.

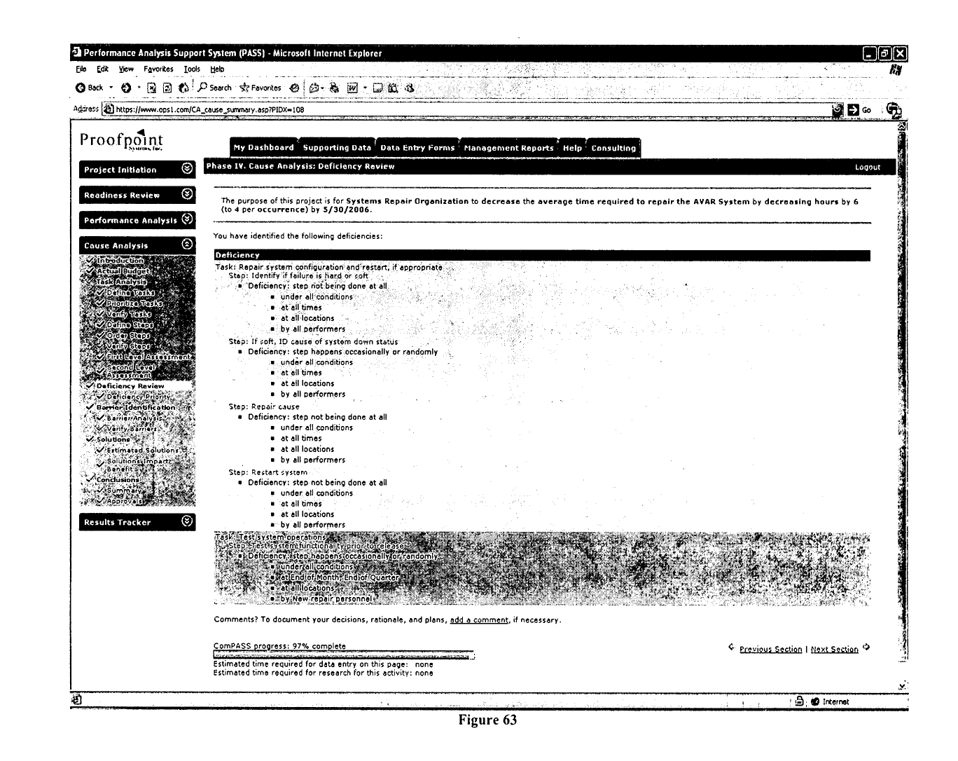

As shown in FIG. 63, a “Deficiency Review” screen is displayed by the performance analysis support system 1 to summarize the deficiencies identified by the user. The “Deficiency Review” lists all tasks, each step required to perform the task, and identified deficiencies in performing each step.

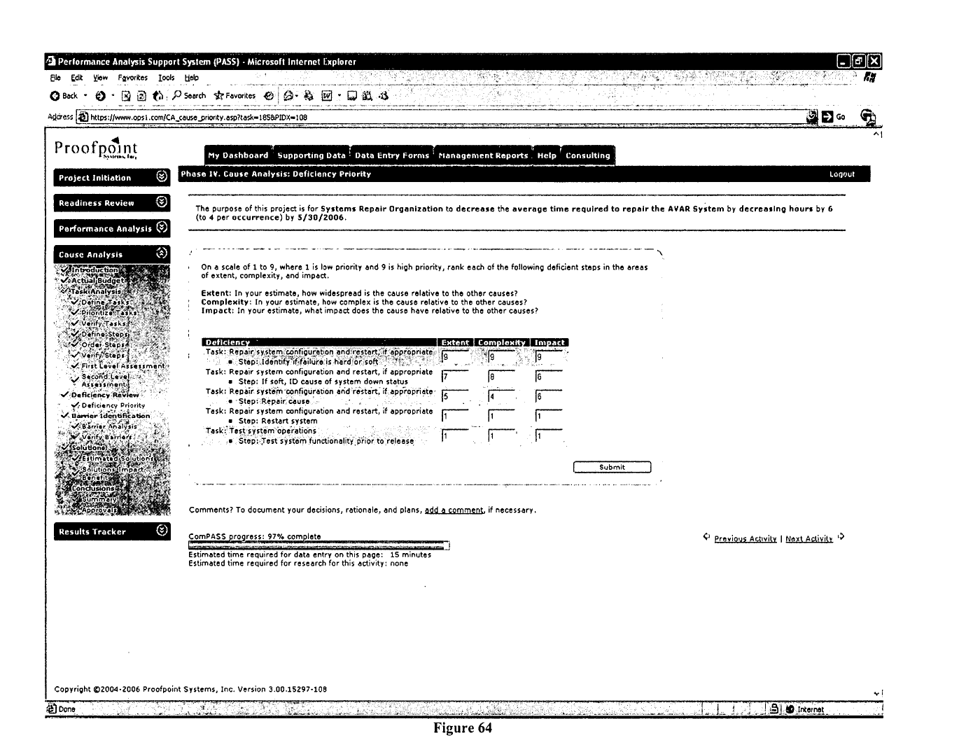

A “Deficiency Priority” screen is then displayed by the performance analysis support system 1 to enable the user to rank each of the deficient steps required to perform each task, as shown in FIG. 64. The user ranks each of the deficient steps in the areas of “Extent,” “Complexity,” and “Impact” on a scale of “1” to “9”, where “1” is low priority and “9” is high priority. In ranking the “Extent” for each deficient step, the user estimates how widespread is the cause relative to the other causes for the deficiency. In ranking “Complexity” for each deficient step, the user estimates how complex is the cause relative to other causes for the deficiency. Finally, in ranking “Impact” for each deficiency, the user estimates what impact the cause has relative to the other causes for the deficiency. The user enters the appropriate rank (“1” to “9”) in the data boxes for “Extent,” “Complexity,” and “Impact” shown in FIG. 64. After the user has completed the ranking, the user positions the cursor of the mouse 6 on the submit button and clicks the left mouse button to input the ranking information to the performance analysis support system 1.

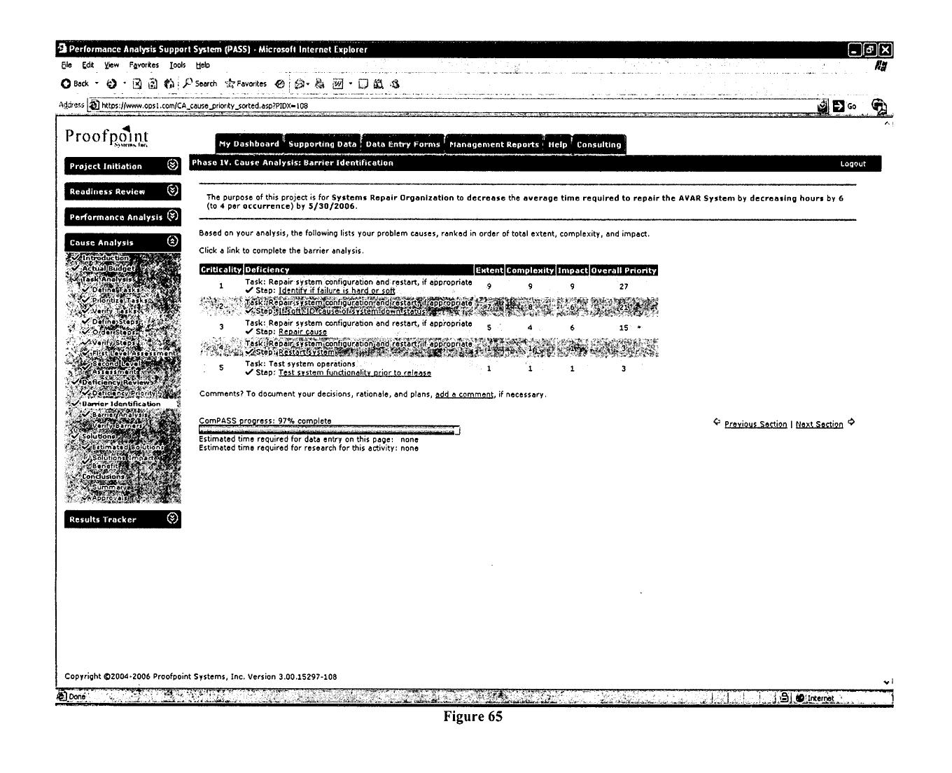

As shown in FIG. 65, a “Barrier Identification” screen displays the deficiencies sorted by the extent, complexity, and impact values entered using the “Deficiency Priority” screen shown in FIG. 64.

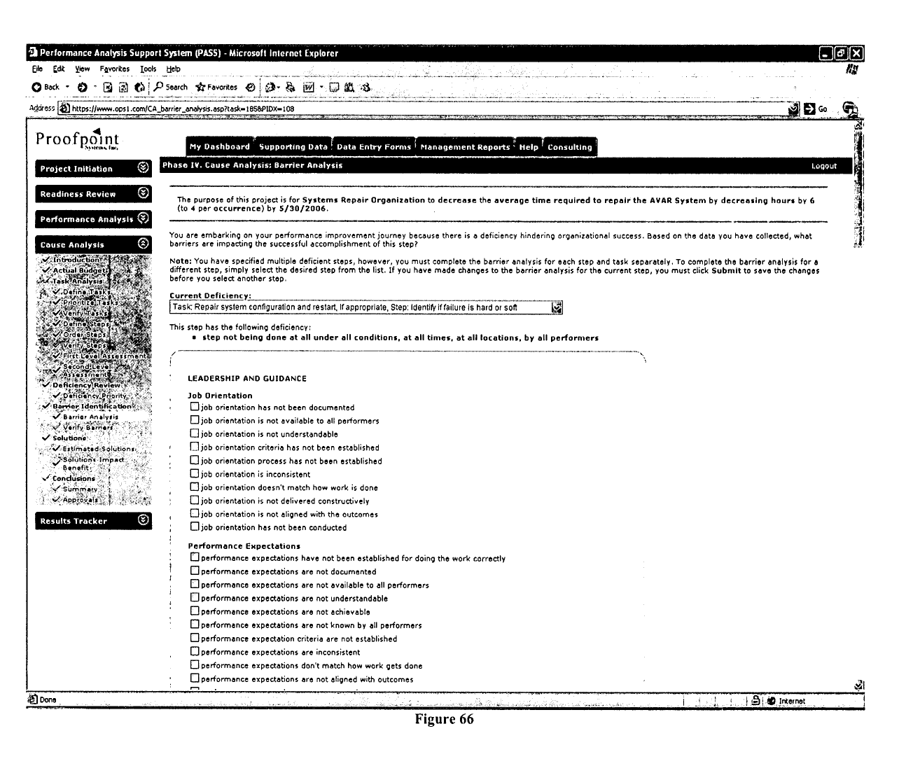

The user then performs an analysis of perceived barriers that could potentially impede attainment of the purpose of the performance improvement project. As shown in FIG. 66, a “Barrier Analysis” screen is displayed by the performance analysis support system 1 to enable the user to enter what barriers are impacting the successful accomplishment of each deficient step required to perform each task. The user selects each deficient step required to perform each task from a drop down list associated with the “Current Deficiency” box shown in FIG. 66. When the deficient step is selected, the performance analysis support system and method display the deficiencies related to that deficient step, as shown in FIG. 66. The user then positions the cursor of the mouse 6 on each applicable check box to identify barriers that potentially impact a successful performance improvement. For example, one category of potential barriers is “LEADERSHIP AND GUIDANCE,” which may include associated barriers comprising “job orientation has not been documented,” “job orientation is not available to all performers,” “job orientation is not understandable,” “job orientation criteria has not been established,” “job orientation process has not been established, “job orientation is inconsistent,” etc., as shown in FIG. 66. After all barriers are appropriately selected for each step for the specified task, the user positions the cursor of the mouse 6 on the submit button and clicks the left mouse button to input the barrier information to the performance analysis support system 1.

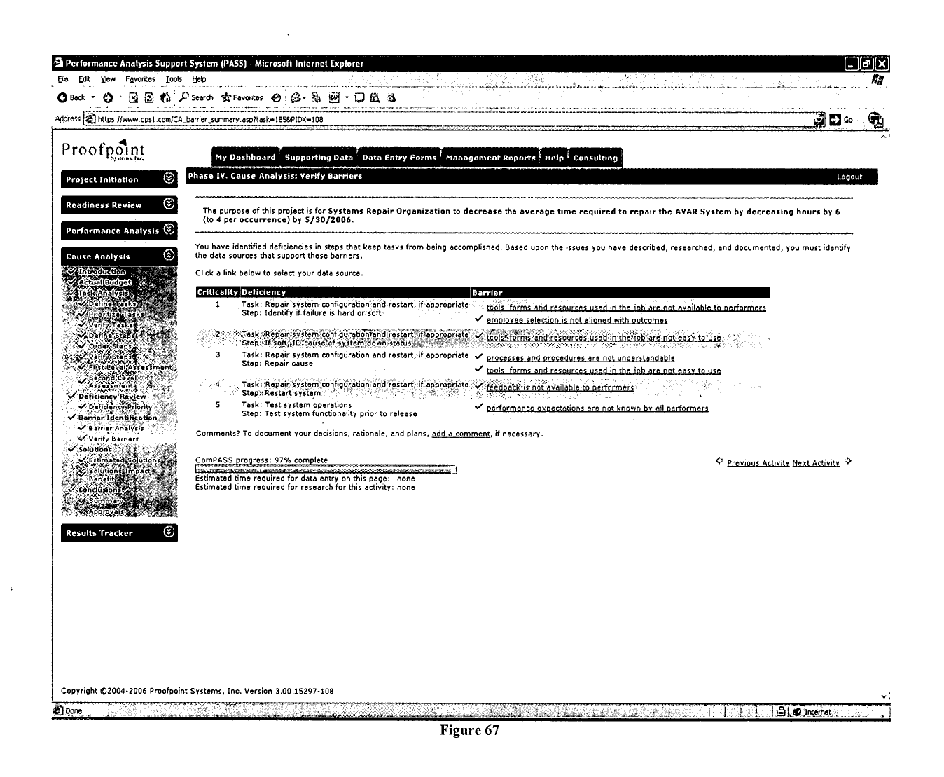

As shown in FIG. 67, a “Verify Barriers” screen is then displayed to the user by the performance analysis support system 1 to enable the user to specify the data sources that support the barriers identified by the user. The user positions the cursor of the mouse 6 on the link corresponding to each identified barrier and clicks the left mouse button to select the data source to support the barrier. As shown in FIG. 67, the user may also add comments to document his or her decisions, rationale, and plans.

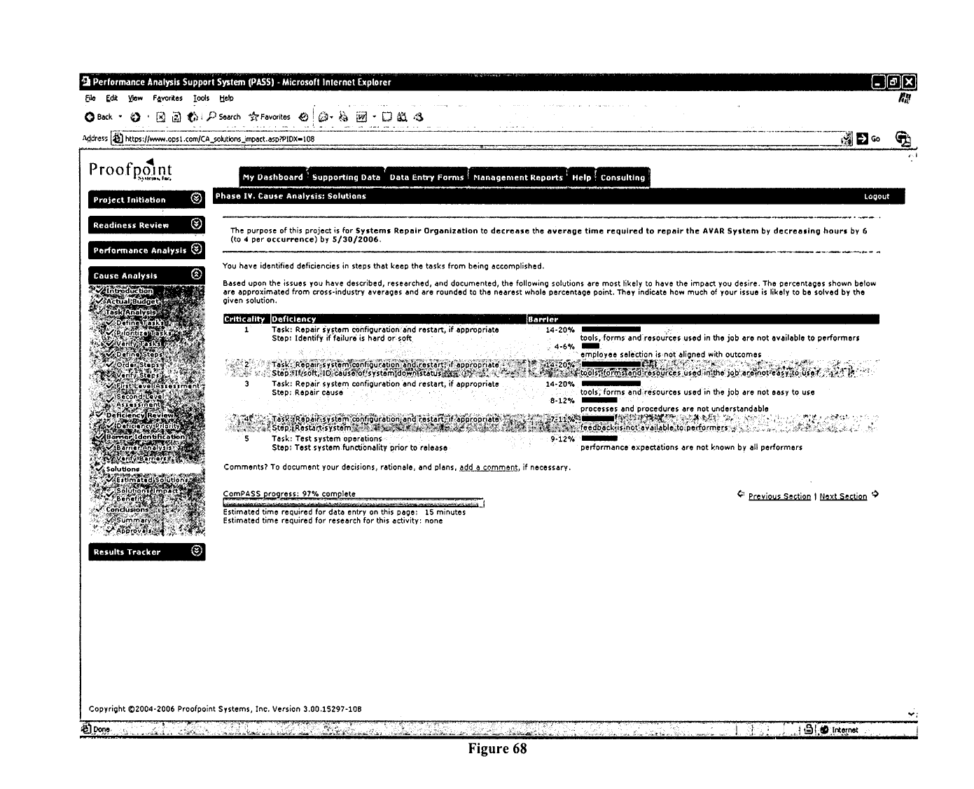

The performance analysis support system and method in accordance with one embodiment of the present invention then derive one or more solutions and perform calculations to ascertain the potential impact of each of the one or more solutions. As shown in FIG. 68, a “Solutions” screen is displayed by the performance analysis support system 1, which lists prospective solutions to the performance issue that are most likely to have an impact based on the issues identified, researched, and documented by the user.

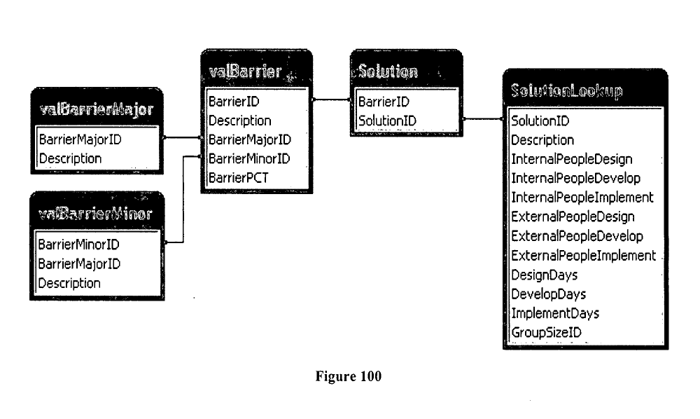

FIG. 100 illustrates the relationship between the identified barriers and the solutions recommended by the performance analysis support system and method in accordance with one embodiment of the present invention. The valBarrier database table holds the list of barriers listed below. The Solution database table holds the relationships between barriers and the available solutions listed below. A single barrier may be related to one or more solutions. The Solution table is related to the SolutionLookup via the SolutionID. The SolutionLookup table holds the information regarding internal and external resources required to design, develop, and implement a solution, based on the performer group size.

The major barrier category (valBarrierMajor) shown in FIG. 100 preferably comprises the following barriers:
incentives and consequences
leadership and guidance
people selection and capacity
tools, resources, and organizational structure

The minor barrier category (valBarrierMinor) shown in FIG. 100 preferably comprises the following barriers:
ergonomic support
feedback
incentives
increased responsibility/promotion
job orientation
job standards
knowledge development
motivation and mood
organizational culture and values
organizational goals
organizational structure
performance expectations
process and procedure
recognition
regulatory standards
rewards
selection
skill development
tools and resources

The barriers (valBarrier)shown in FIG. 100 preferably comprise the following barriers:
employee selection criteria are not established
employee selection is not aligned with outcomes
employee selection is not based on performance criteria
employee selection process is not established
ergonomic environment doesn't support how work gets done
ergonomic environment is noisy, congested and causes distractions, interruptions
ergonomic environment requires painful physical positions
feedback criteria are not established
feedback is inconsistent
feedback is not aligned with the desired outcomes
feedback is not available to performers
feedback is not based on performance standards
feedback is not delivered constructively
feedback is not distributed consistently
feedback is not sufficiently detailed
feedback is not valued by performers
feedback process is not established
feedback source is not well respected or reliable
incentives are not aligned with outcomes
incentives are not based on performance standards
incentives are not distributed consistently
incentives are not distributed fairly
incentives are not valued by the performers
incentives are not visible to the organization
incentives criteria are not established
incentives process is not established
incentives source is not respected or reliable
increased responsibility/promotion criteria are not established
increased responsibility/promotion is not available to performers
increased responsibility/promotion is not based on performance standards
increased responsibility/promotion is not distributed consistently
increased responsibility/promotion is not distributed fairly
increased responsibility/promotion opportunities are not known by performers
increased responsibility/promotion process is not established
job orientation criteria has not been established
job orientation doesn't match how work is done
job orientation has not been conducted
job orientation has not been documented
job orientation is inconsistent
job orientation is not aligned with the outcomes
job orientation is not available to all performers
job orientation is not delivered constructively
job orientation is not understandable
job orientation process has not been established
job standards are inconsistent
job standards are not achievable
job standards are not aligned with outcomes
job standards are not available to all performers
job standards are not based on performance standards
job standards are not documented
job standards are not known by performers
job standards are not understandable
job standards are not up-to-date
job standards are not valued by performers
job standards don't match how work is really done
job standards have not been established
knowledge criteria are not established
knowledge doesn't match how work gets done
knowledge is inconsistent
knowledge is insufficient
motivation, mood or attitude is insufficient
organizational culture and values are not aligned with outcomes
organizational culture and values are not known by performers
organizational culture and values are not respected
organizational culture and values are not visible throughout the organization
organizational goals are inconsistent
organizational goals are not achievable
organizational goals are not available to all performers
organizational goals are not documented
organizational goals are not known by performers
organizational goals are not understandable
organizational goals are not up-to-date
organizational goals are not valued by performers
organizational goals are not visible throughout the organization
organizational goals have not been established
organizational structure doesn't match how work gets done
organizational structure is not aligned with outcomes
organizational structure is not documented
organizational structure is not known by performers
organizational structure is not understandable
performance expectation criteria are not established
performance expectations are inconsistent
performance expectations are not achievable
performance expectations are not aligned with outcomes
performance expectations are not available to all performers
performance expectations are not documented
performance expectations are not known by all performers
performance expectations are not understandable
performance expectations are not up-to-date
performance expectations do not cover all likely situations
performance expectations don't match how work gets done
performance expectations have not been established for doing the work correctly
processes and procedures are inconsistent
processes and procedures are not aligned with the outcomes
processes and procedures are not based on performance standards
processes and procedures are not documented
processes and procedures are not established
processes and procedures are not known by performers
processes and procedures are not understandable
processes and procedures are not up-to-date
processes and procedures don't match how work is really done
recognition criteria are not established
recognition is not aligned with outcomes
recognition is not based on performance standards
recognition is not distributed consistently
recognition is not distributed fairly
recognition is not valued by the performers
recognition is not visible to the organization
recognition process is not established
recognition source is not respected or reliable
regulatory standards are inconsistent
regulatory standards are not achievable
regulatory standards are not available to all performers
regulatory standards are not known by performers
regulatory standards are not understandable
regulatory standards are not valued by performers
regulatory standards are not visible throughout the organization
regulatory standards don't match how work is really done
rewards are not aligned with outcomes
rewards are not based on performance standards
rewards are not distributed consistently
rewards are not distributed fairly
rewards are not valued by the performers
rewards are not visible to the organization
rewards criteria are not established
rewards process is not established
rewards source is not respected or reliable
skills are inconsistent
skills are insufficient
skills are negatively impacted by disability
skills are negatively impacted by lack of physical strength
skills are negatively impacted by language deficiency
skills criteria are not established
skills don't match how work gets done
skills not aligned with outcomes
time available is not aligned with the outcomes
tools and resources are not in good repair
tools, forms and resources are not used correctly
tools, forms and resources don't match how work is really done
tools, forms and resources used in the job are not available to performers
tools, forms and resources used in the job are not easy to use

The solutions (Solutions) shown in FIG. 100 preferably comprise the following solutions:
Align Performance Expectations to Work
Align Work to Culture
Align Work to Regulatory Standards
Communicate About Compensation structure
Communicate About Culture
Communicate About Feedback System
Communicate About Incentive/Recognition Program
Communicate About Job Standards
Communicate About Organizational Goals
Communicate About Performance Expectations
Communicate About Policy
Communicate About Procedure
Communicate About Process Map/Flow Chart
Communicate About Promotion Programs
Communicate About Regulatory Standards
Communicate About Selection Standards
Communicate About Strategic Plan
Develop Incentive/Recognition Program
Develop Job Aid
Develop Job Standards
Develop New Compensation Structure
Develop New Procedure
Develop New Process Map/Flow Chart
Develop Organizational Goals
Develop Orientation Program
Develop Performance Expectations
Develop Selection Standards
Develop Strategic Plan
Document Feedback System
Document Organizational Goals
Document Organizational Structure
Document Policy
Document Procedure
Document Strategic Plan
Ergonomic Improvement
Establish Feedback System
Establish Mentoring/Coaching
Establish Policy
Establish Training/Education Program
Modify Existing Job Aid
Modify Existing Procedure
Modify Existing Process Map/Flow Chart
Modify Existing Training/Education Program
Modify Feedback System
Modify Incentive/Recognition Program
Modify Organizational Structure
Modify Policy
Procure New Tool/Resource
Realign Work Groups
Revise Compensation structure
Revise Job Standards
Revise Organizational Goals
Revise Orientation Program
Revise Performance Expectations
Revise Selection Standards
Update New Tool/Resource

Preferably, percentages, which are approximated from cross-industry averages and rounded to the nearest whole percentage point, are provided to indicate how much of the performance issue is likely to be solved by the given solution, as shown in FIG. 68. For example, the task of “Repair system configuration and restart, if appropriate” requires the step of “Identify if failure is hard or soft” and the deficiency of “employee selection is not aligned with outcomes” to be corrected. The displayed percentage range of 4-6% indicates the impact this specific deficiency is having on the entirety of the performance problem. The sums of all deficiency percentages total 100%. As shown in FIG. 68, the user may also add comments to document his or her decisions, rationale, and plans.

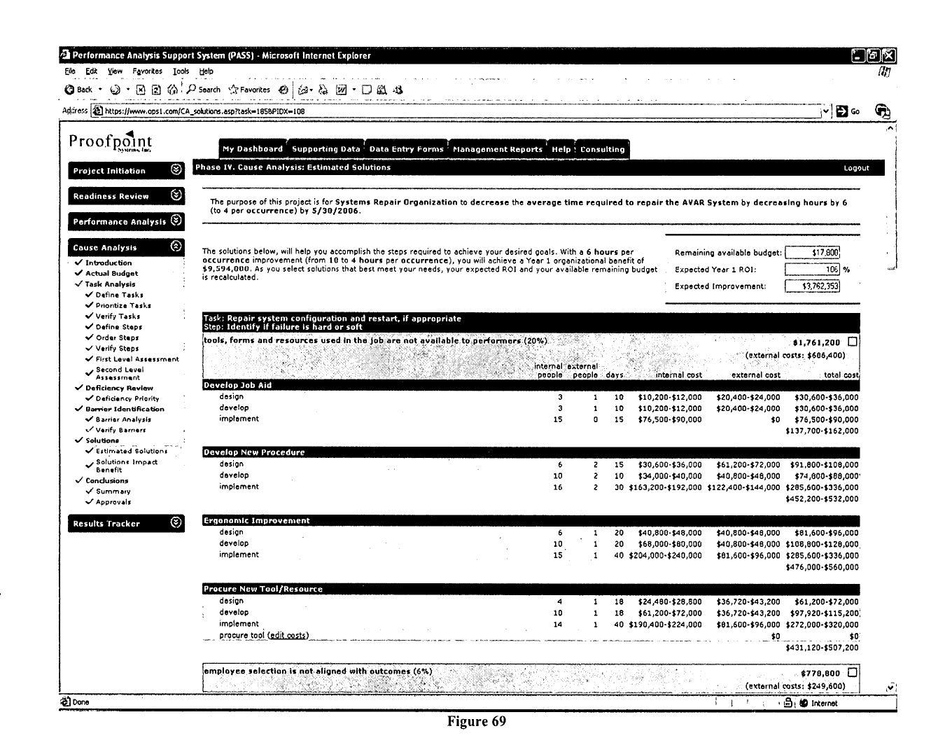

As shown in FIG. 69, the performance analysis support system and method in accordance with one embodiment of the present invention then perform calculations to ascertain the potential cost/benefit impact of one or more solutions. As shown in FIG. 69, an “Estimated Solutions” screen is displayed by the performance analysis support system 1, which lists each performance issue associated with the deficient step for each task and the estimated solutions to the performance issue. For example, the task of “Repair system configuration and restart, if appropriate” requires the step of “Identify if failure is hard or soft.” The maximum 20% indicates the impact that this solution is likely to have on the entirety of the performance issue if the problem of “tools, forms and resources used in the job are not available to performers” is corrected and is used in the calculations. The performance analysis support system and method determine the procedures, namely, “Develop Job Aid,” “Develop New Procedure,” “Ergonomic Improvement,” and “Procure New Tool/Resource,” and estimate the costs for “design,” “develop,” and “implement” phases to effect the corrective procedures. As shown in FIG. 69, the “total cost” includes both an “internal cost” and an “external cost” based on the number of both “internal people” and “external people” and the number of days required to carry out the “design,” “develop,” and “implement” phases to effect the corrective procedures. Based on the solutions selected by the user, the expected Return on Investment (ROI) and remaining available budget are recalculated by the performance analysis support system 1. For example, as shown in FIG. 69, the organizational benefit is $9,594,000, the “Expected Year 1 ROI” is 106%, and the “Remaining available budget” is $17,800.

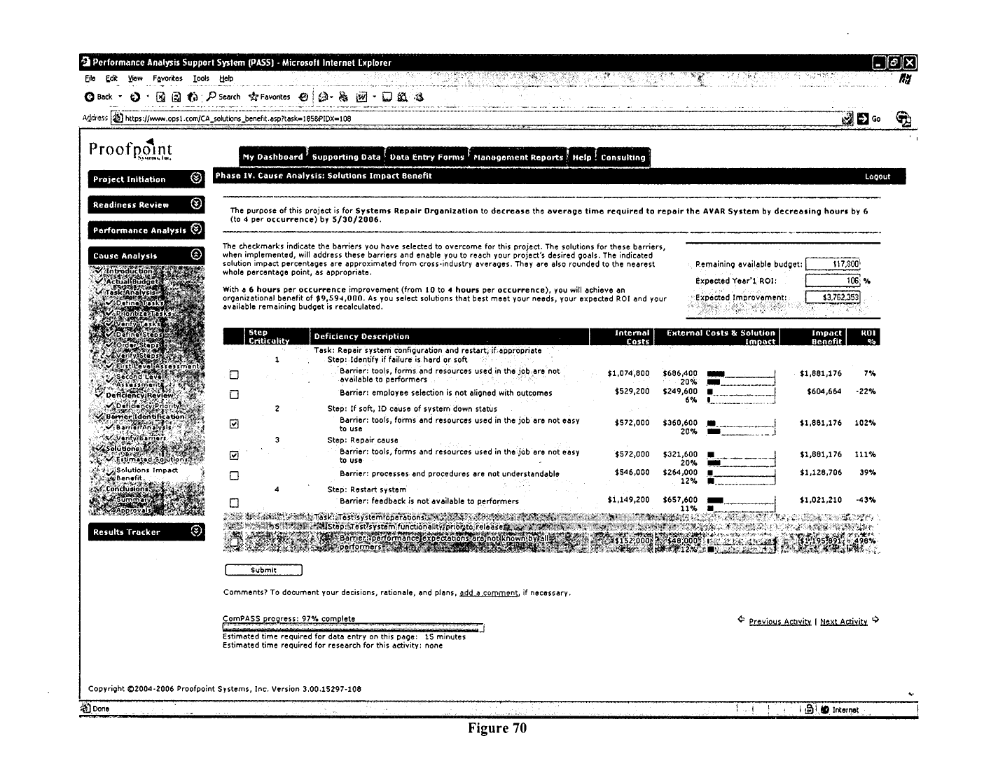

As shown in FIG. 70, a “Solutions Impact Benefit” screen is displayed by the performance analysis support system 1 to enable the user to select which of the barriers that he or she has selected to overcome for the performance improvement project. The “Solutions Impact Benefit” screen also includes the associated “Internal Costs,” “External Costs & Solution Impact,” the “Impact Benefit” expressed in monetary terms, and the “ROI” in percent. The indicated solution impact percentages are approximated from cross-industry averages and are preferably rounded to the nearest whole percentage point.

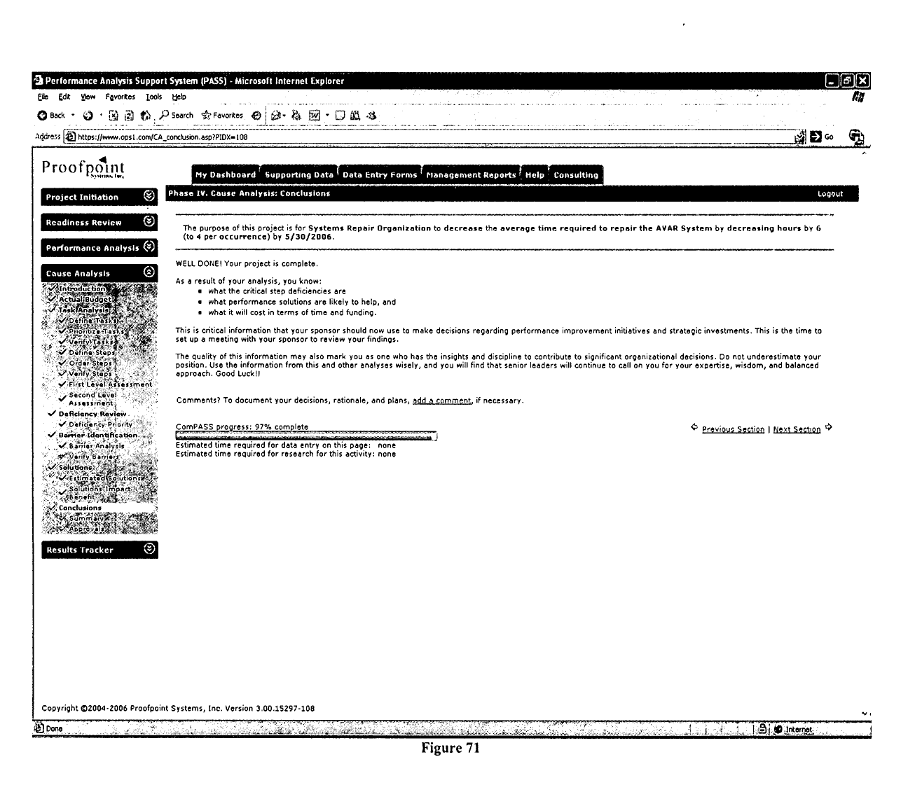

It is to be noted that although a series of screens and sequence of data entry and selections by the user have been described in connection with the Cause Analysis phase, the screens may be accessed in any order and at different times according to when the user accesses the performance analysis support system 1 and enters the data. The performance analysis support system and method track the entry of data and discern when the user has completed all of the required inputs to complete the Cause Analysis phase and display a “Conclusions” screen, as shown in FIG. 71.

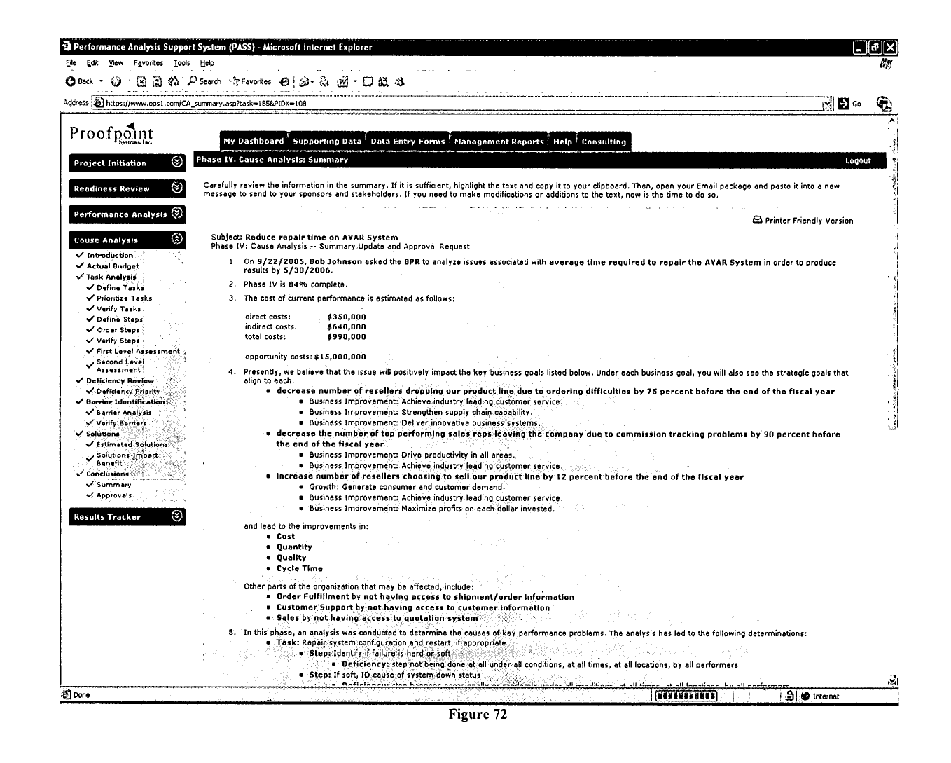

The performance analysis support system and method then assemble a summary of the Cause Analysis phase in a “Summary” screen, as shown in FIG. 72. The information assembled in the “Summary” screen shown in FIG. 72 is then preferably forwarded to the project sponsor(s) and other stakeholders. For example, the “Summary” may be included in an email and sent to the project sponsor(s) and stakeholders for review.

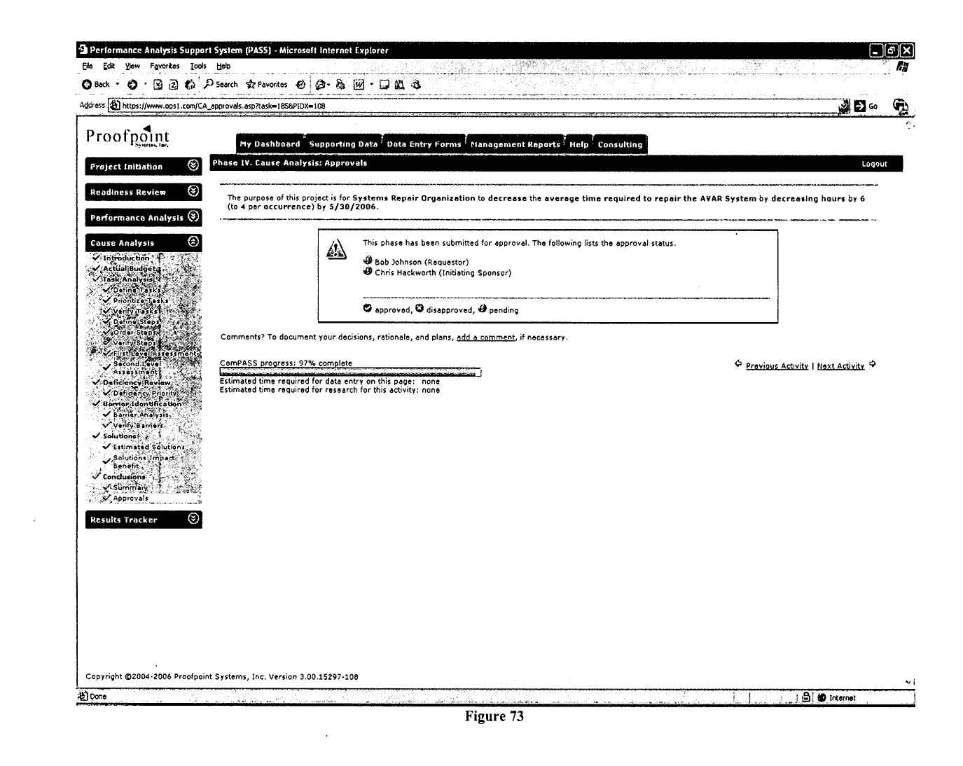

The performance analysis support system and method then display an “Approvals” screen for the Cause Analysis phase, as shown in FIG. 73. The “Approvals” screen includes a check box(es) on which the user positions the cursor of the mouse 6 and clicks the left mouse button to indicate which sponsor(s) and stakeholders will receive a task in the “My Messages” area of their dashboard shown in FIG. 3 directing them to approve or disapprove the status of the Cause Analysis phase. Once the request for approval has been submitted, the “Approvals” screen shown in FIG. 73 displays the current approval status by the sponsor(s) and stakeholders.

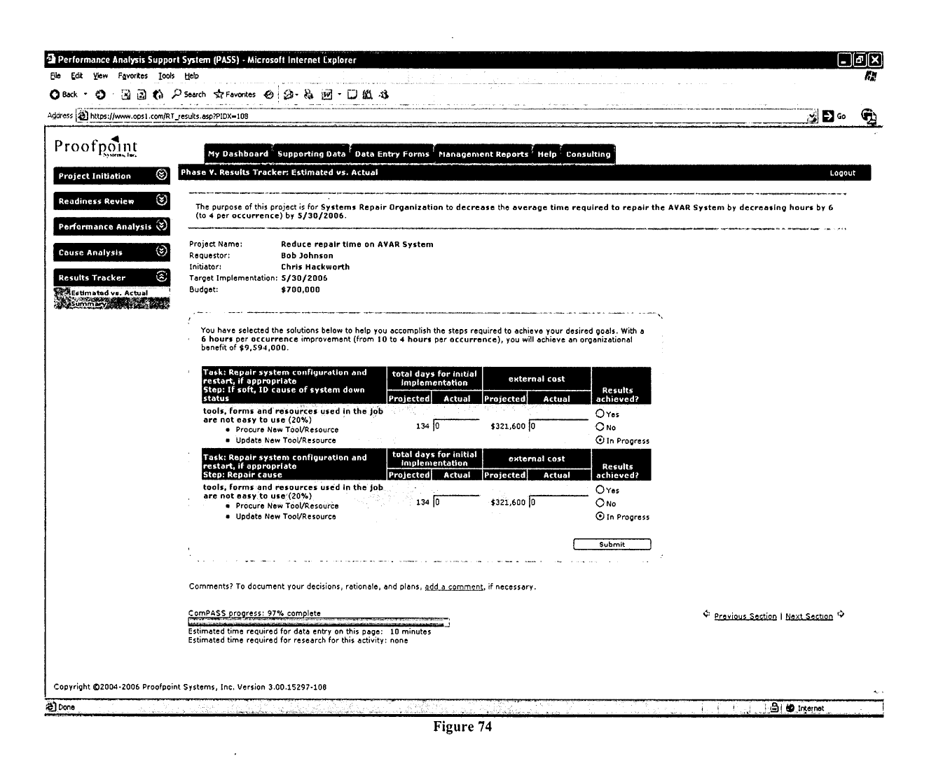

The performance analysis support system and method also preferably track results. A “Results Tracker” screen is displayed by the performance analysis support system 1 at the conclusion of the Cause Analysis phase to remind the user to schedule a meeting with the sponsor(s) to review the findings for the performance improvement project, as shown in FIG. 74. The user may also add comments to document his or her decisions, rationale, and plans.

The Results Tracker also enables the user to compare “Actual” costs for the performance improvement project to the estimated costs using an “Estimated vs. Actual” screen displayed by the performance analysis support system 1, as shown in FIG. 74. The “Estimated vs. Actual” screen also enables the user to document the status of the results achieved by positioning the cursor of the mouse 6 on the appropriate bubble under the heading “Results achieved?” and clicking the left mouse button to indicate “Yes,” “No,” or “In Progress.”

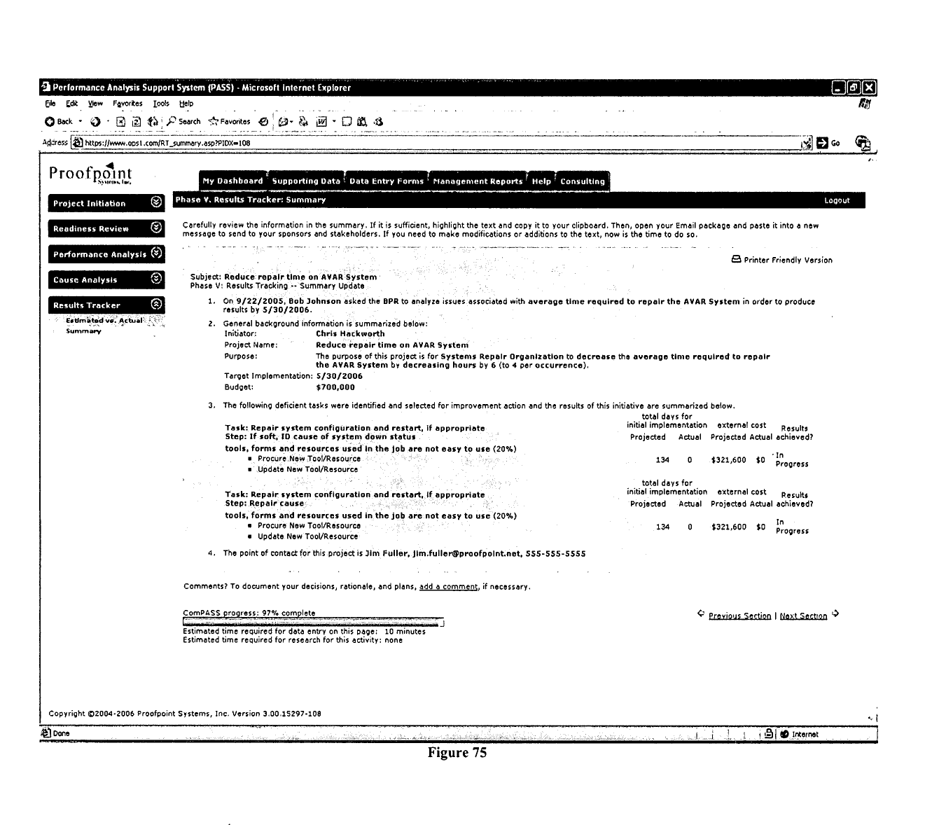

Additionally, the Results Tracker enables the user to provide an update to the sponsor(s) and stakeholders. As shown in FIG. 75, a “Summary” screen is displayed by the performance analysis support system 1 that includes “Projected” versus “Actual” costs and the status of the results achieved, namely, “Yes,” “No,” or “In Progress.” The information assembled in the “Summary” screen shown in FIG. 75 is then preferably forwarded to the project sponsor(s) and other stakeholders. For example, the “Summary” may be included in an email and sent to the project sponsor(s) and stakeholders for review.

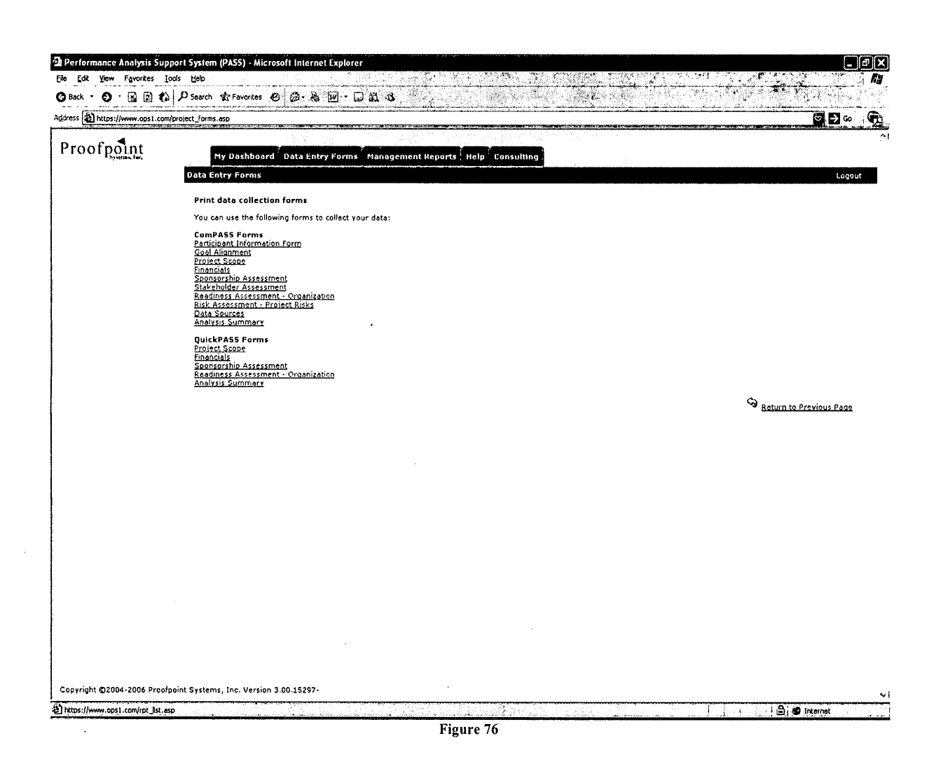

As shown in FIGS. 3 through 75, the dashboard and other screens include a “Data Entry Forms” tab. The user positions the cursor of the mouse 6 on the “Data Entry Forms” tab and clicks the left mouse button to access a “Data Entry Forms” screen which lists various data entry forms to facilitate collection of data, as shown in FIG. 76.

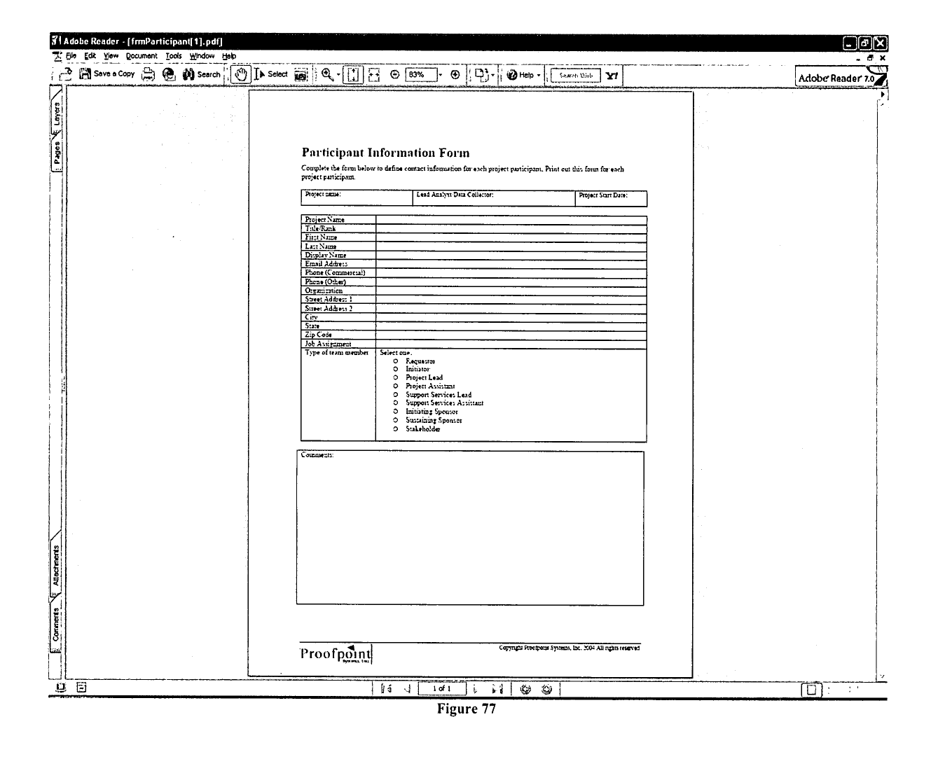

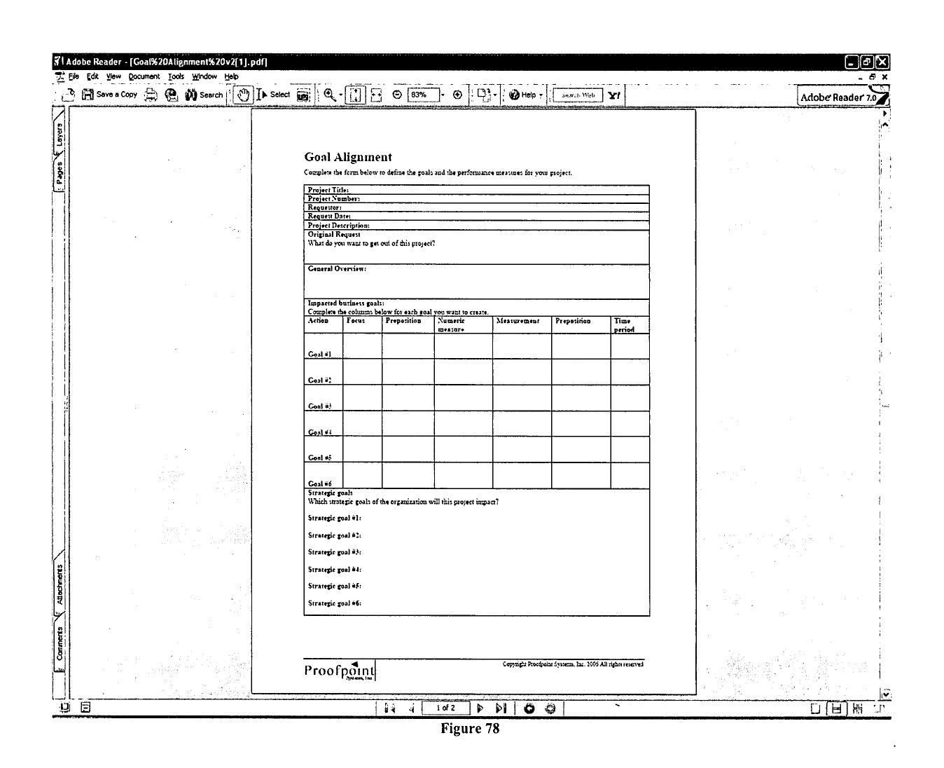

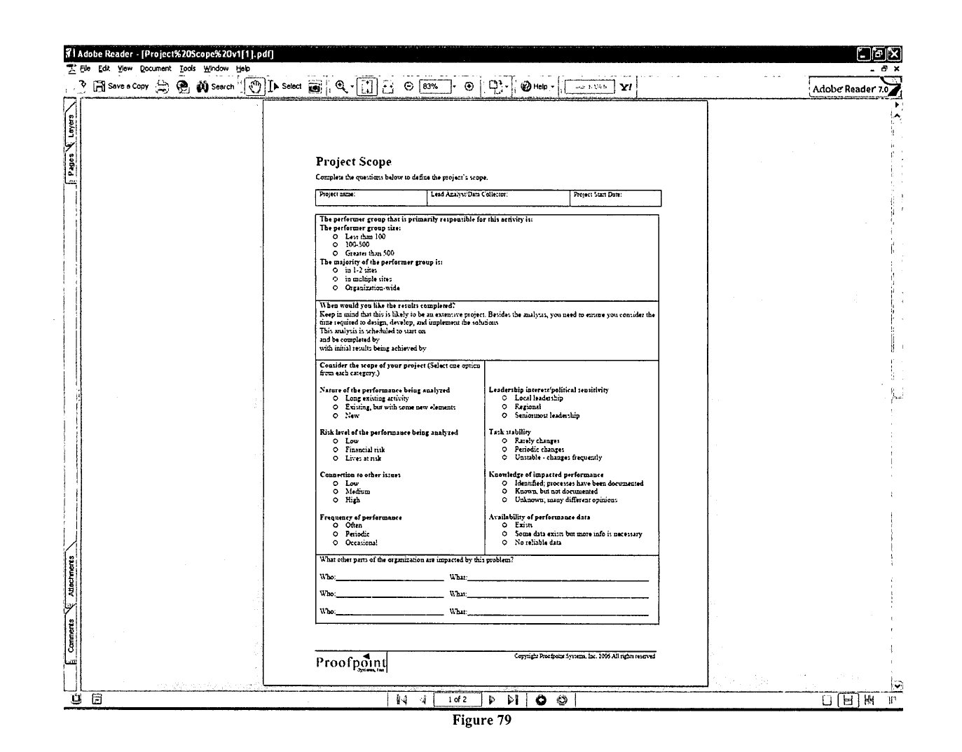

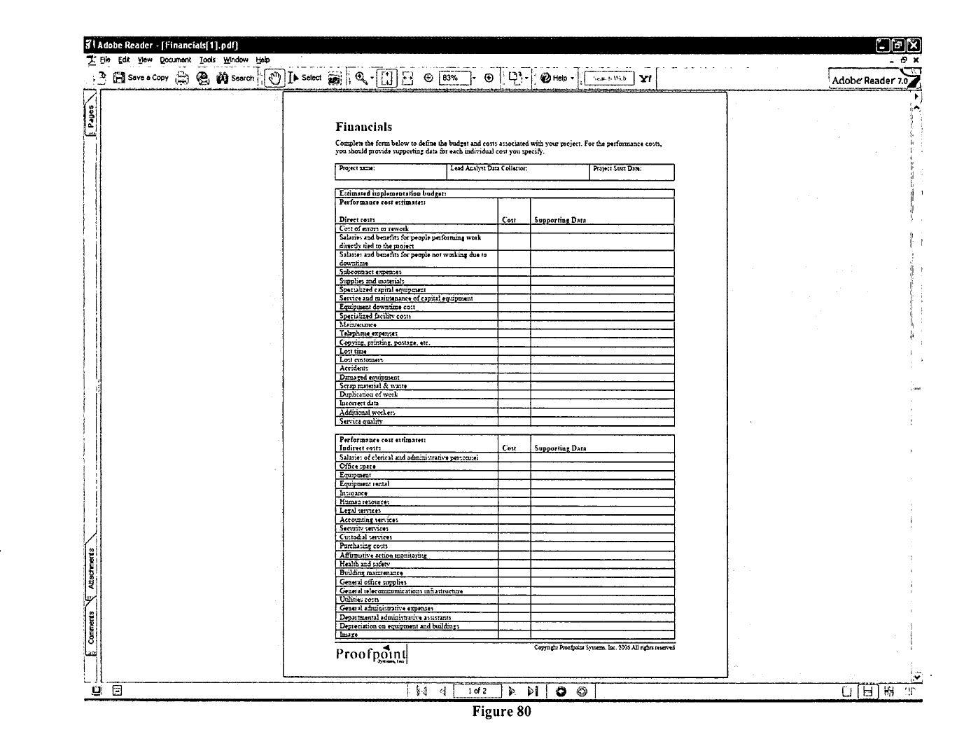

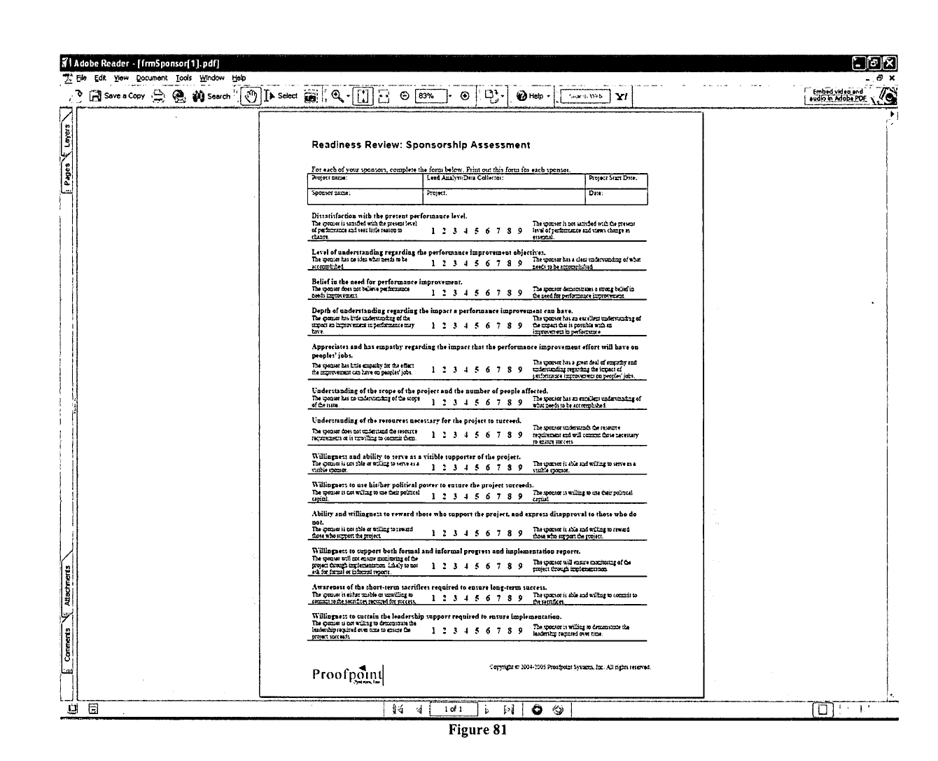

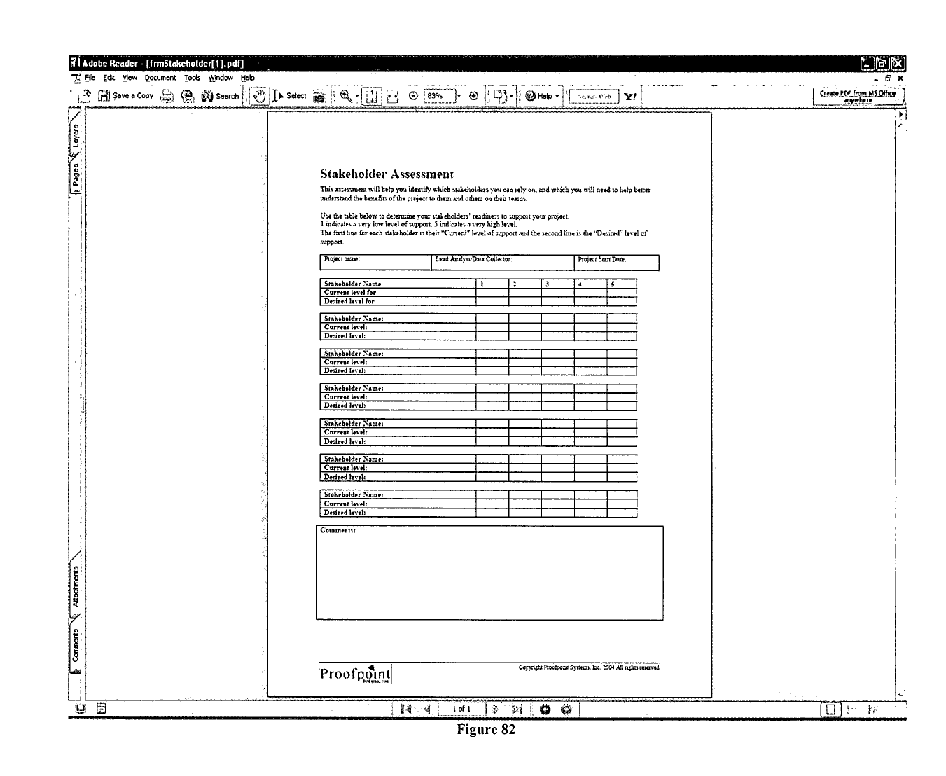

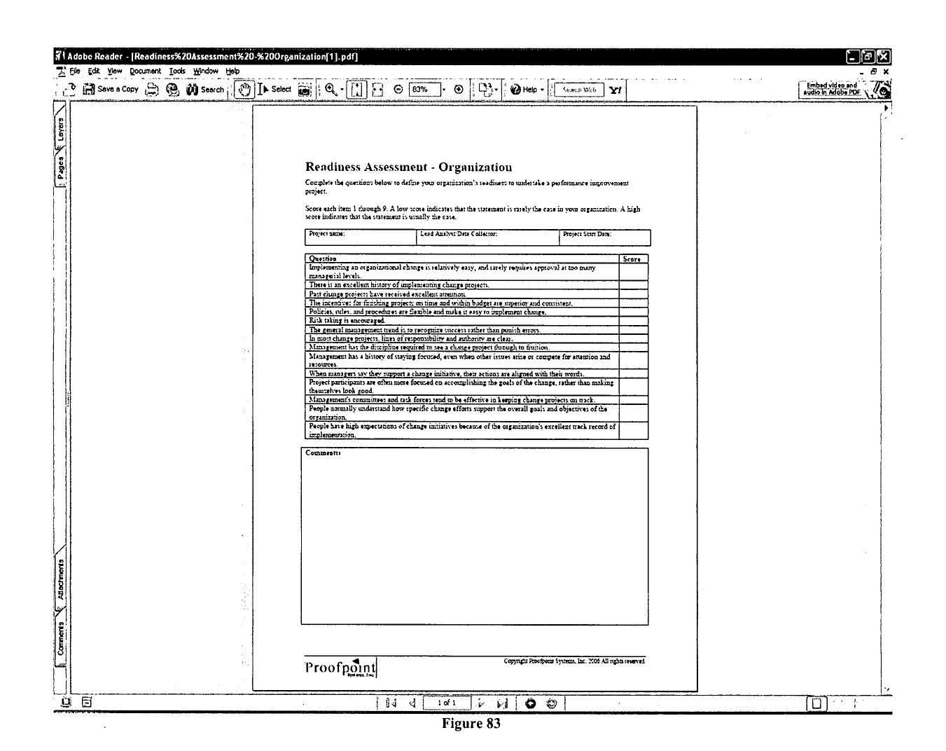

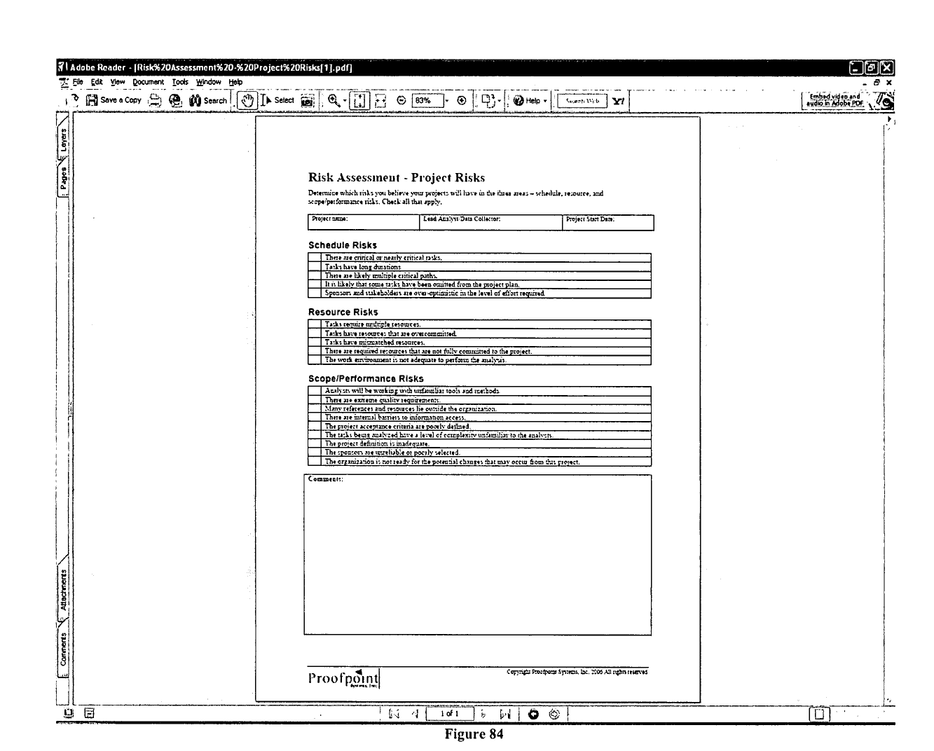

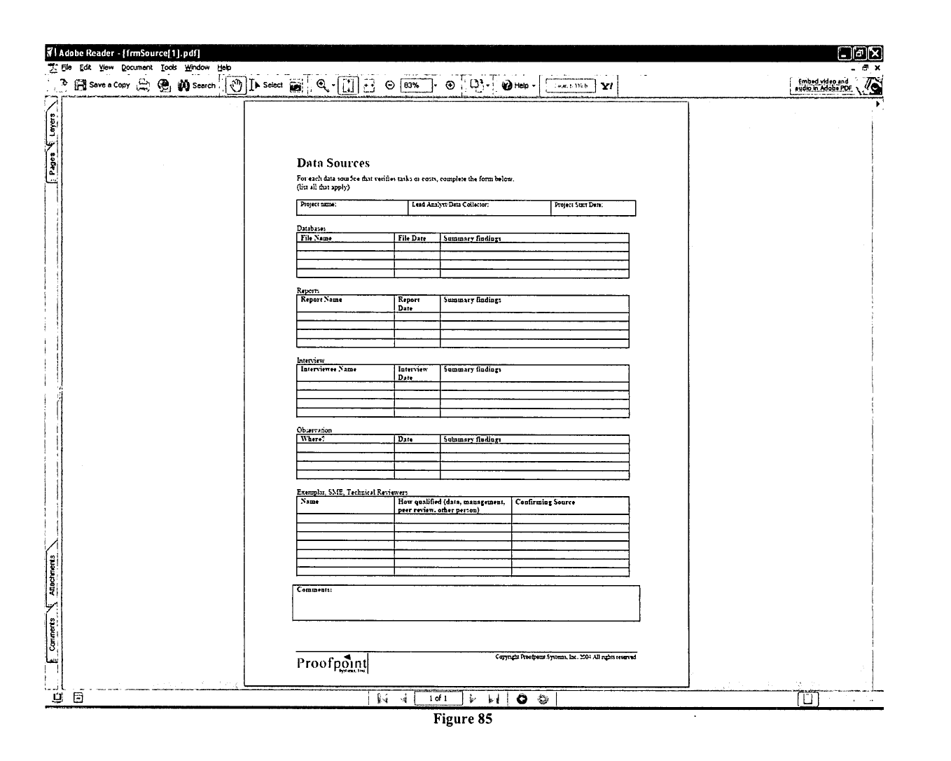

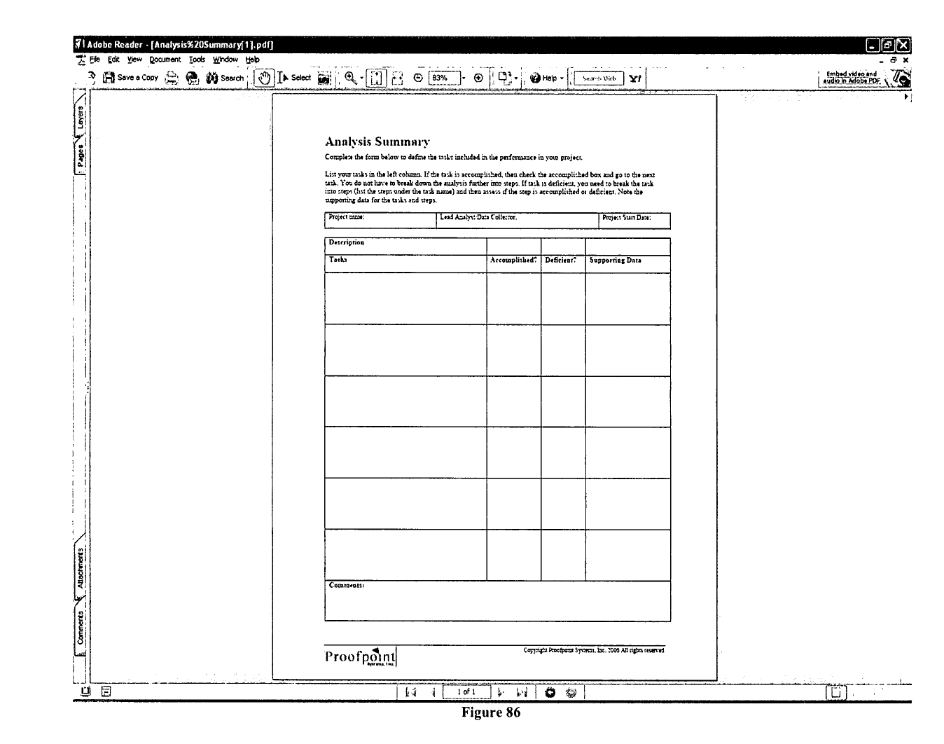

The forms preferably include a “Participant Information” form, as shown in FIG. 77; a “Goal Alignment” form, as shown in FIG. 78; a “Project Scope” form, as shown in FIG. 79; a “Financials” form, as shown in FIG. 80; a “Sponsorship Assessment” form, as shown in FIG. 81; a “Stakeholder Assessment” form, as shown in FIG. 82; an “Organization Assessment” form, as shown in FIG. 83; a “Project Risks Assessment” form, as shown in FIG. 84; a “Data Sources” form, as shown in FIG. 85; and an “Analysis Summary” form, as shown in FIG. 86.

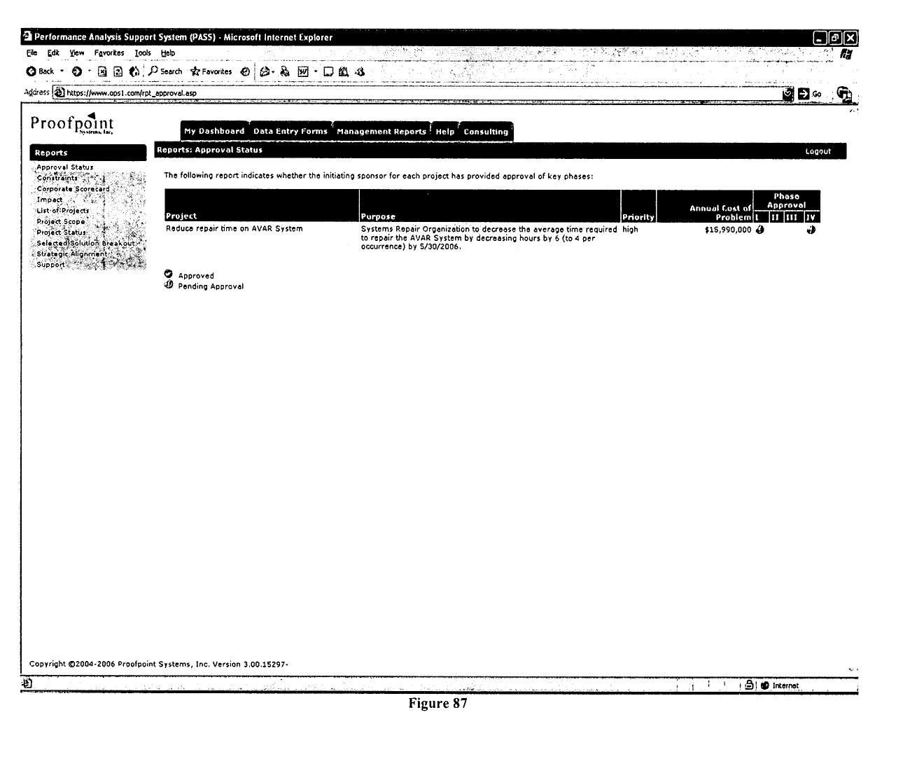

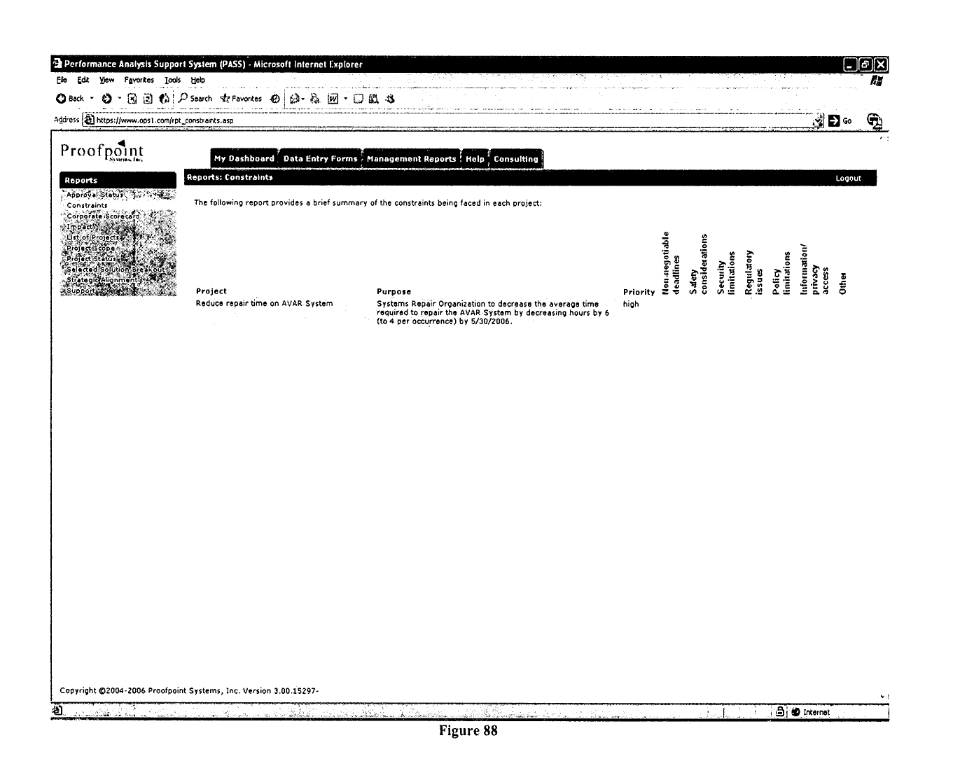

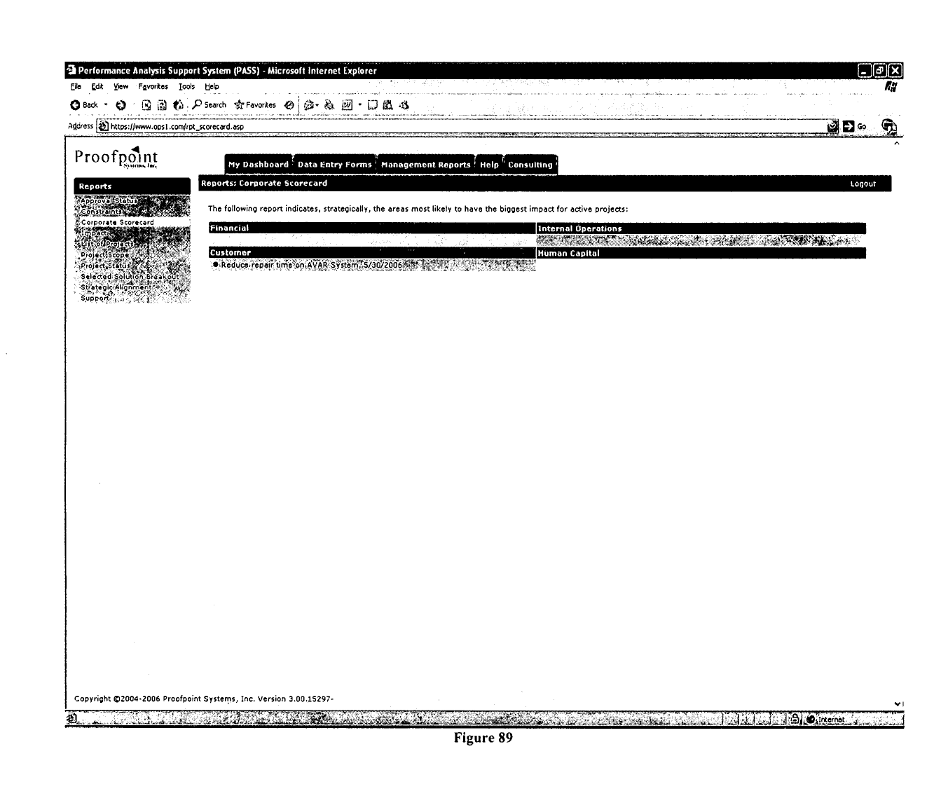

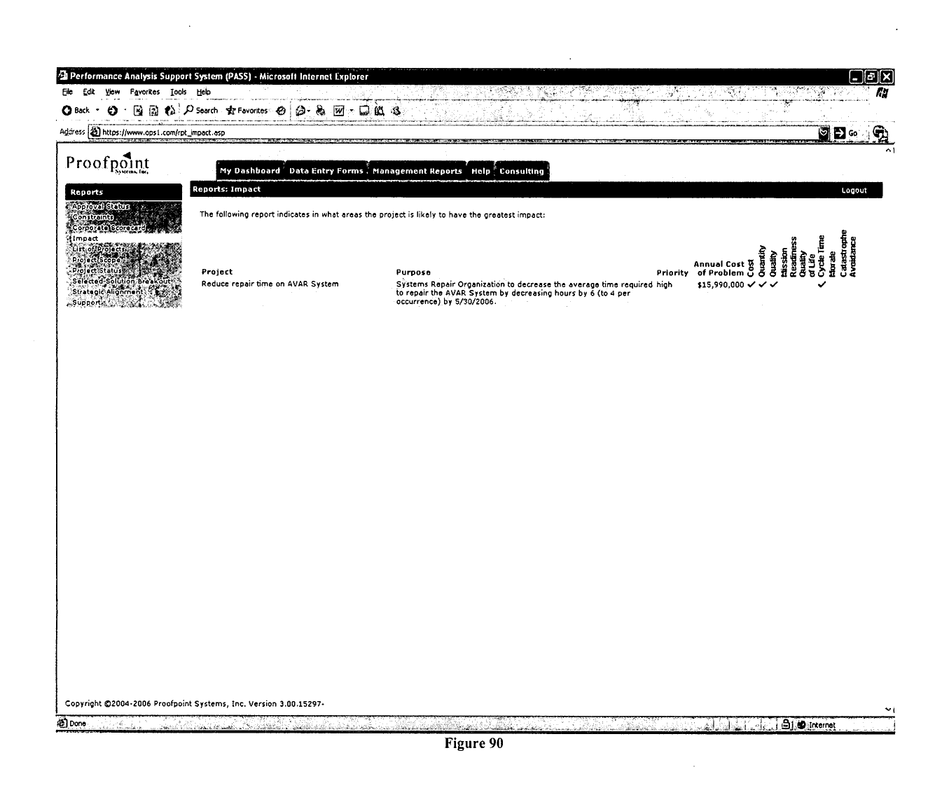

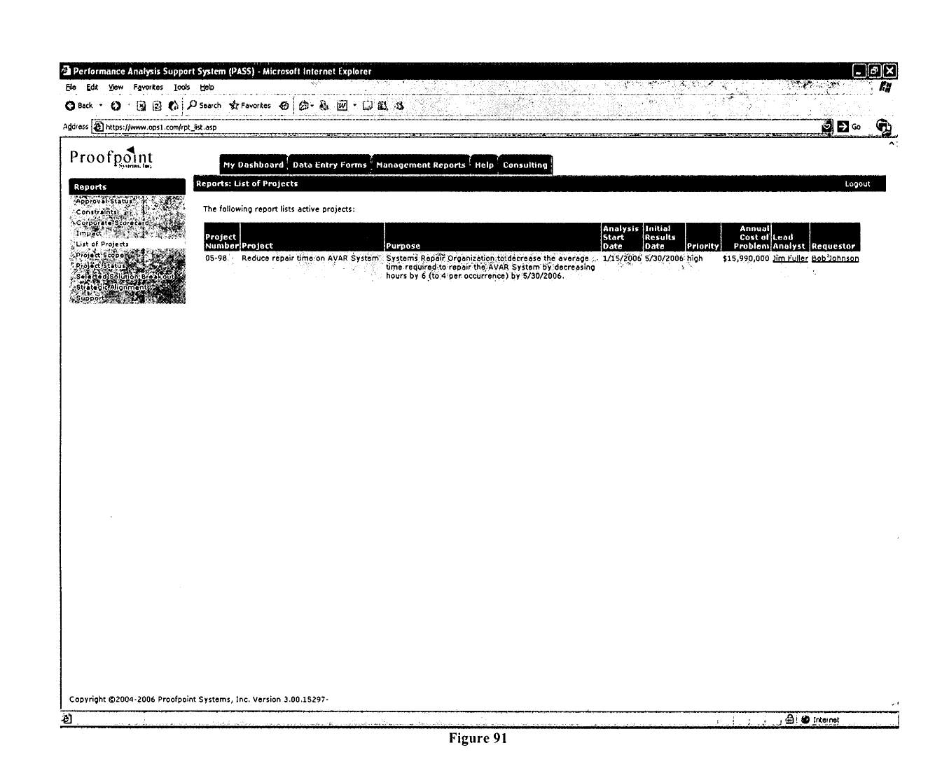

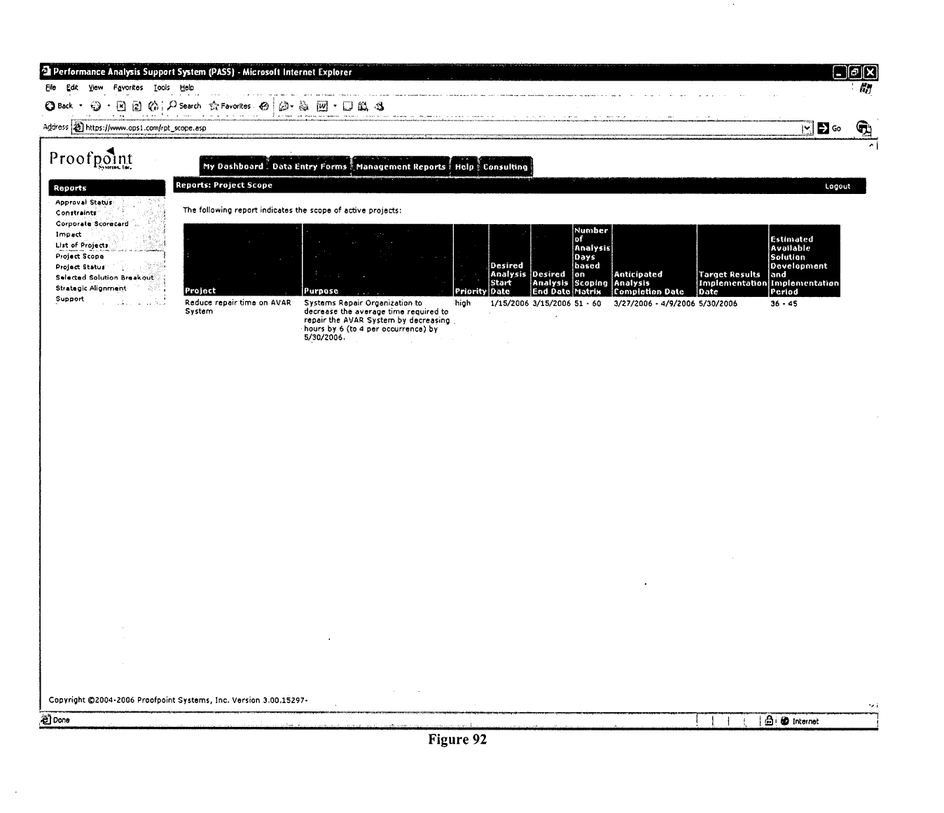

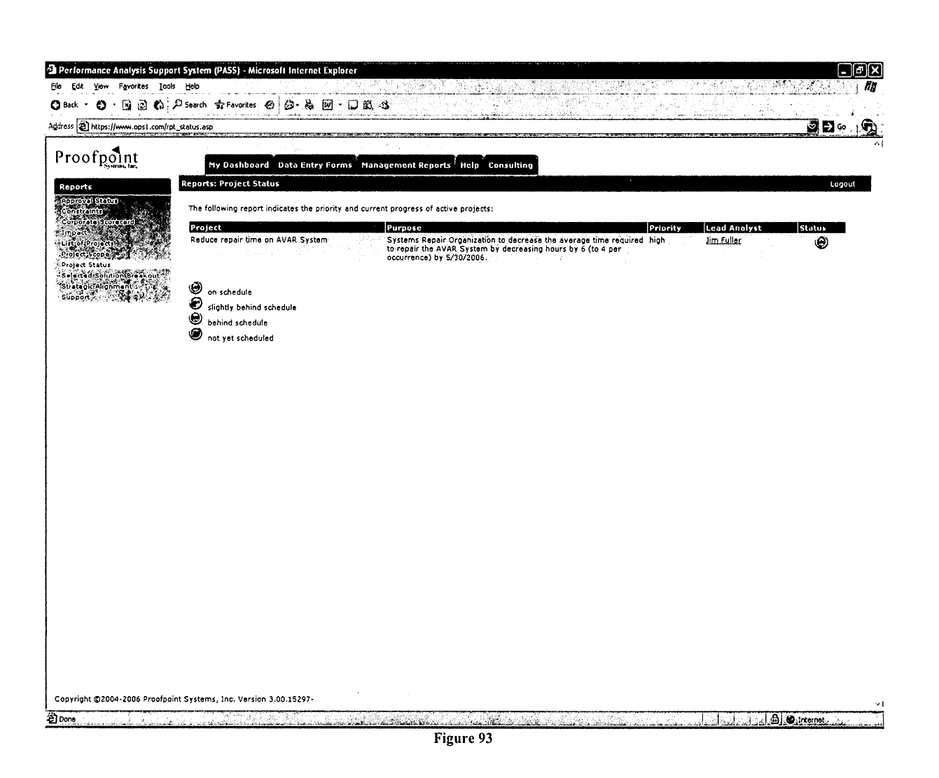

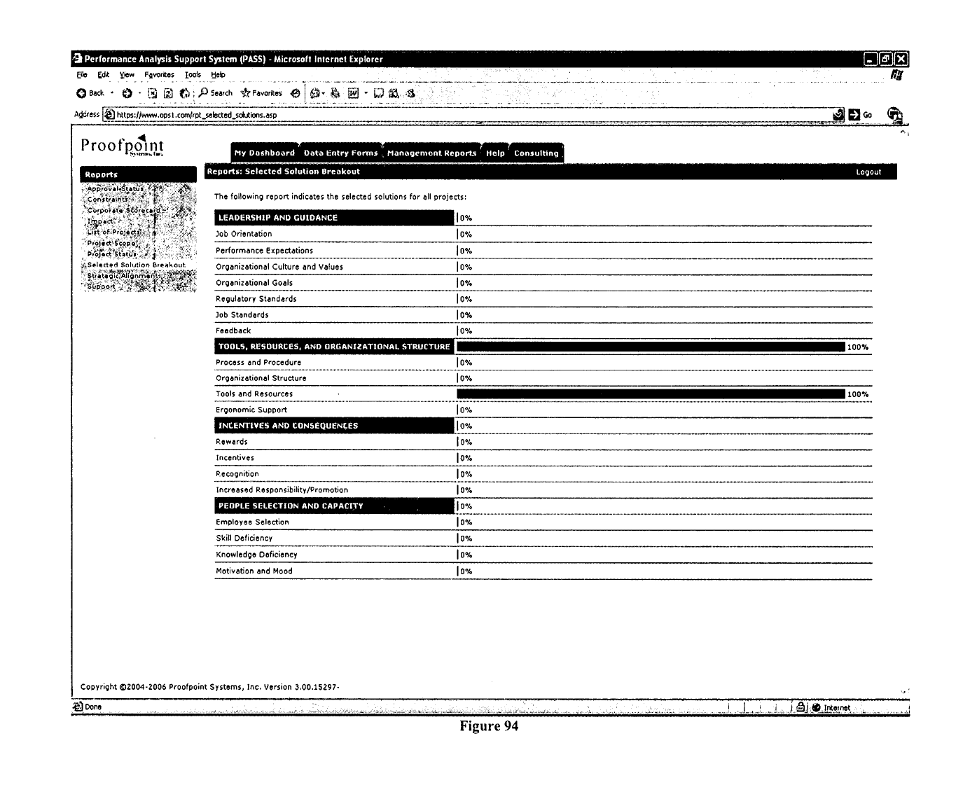

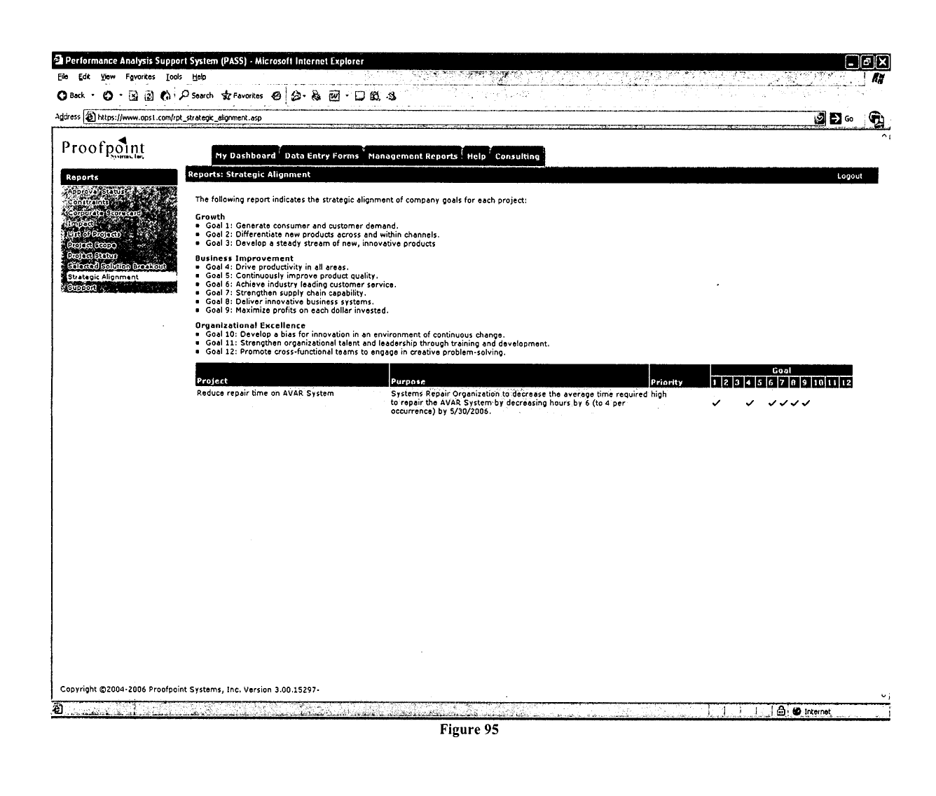

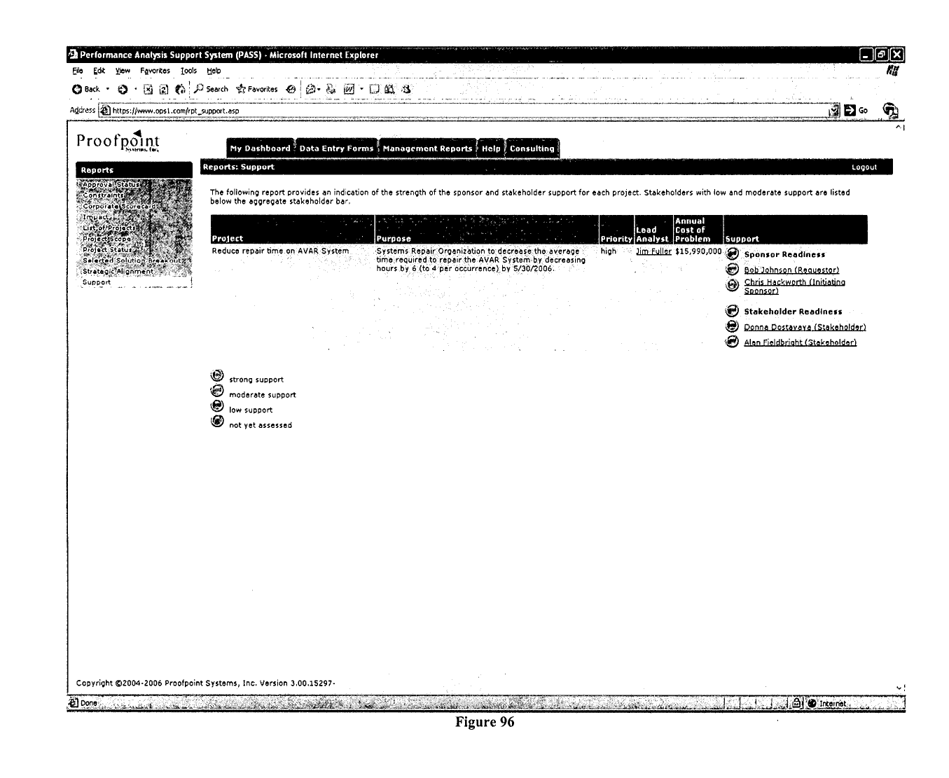

As shown in FIGS. 3 through 75, the dashboard and other screens include a “Management Reports” tab. The user positions the cursor of the mouse 6 on the “Management Reports” tab and clicks the left mouse button to access a list of various management reports, as shown in FIG. 87. The “Reports” preferably include an “Approval Status” report, as shown in FIG. 87; a “Constraints” report, as shown in FIG. 88; a “Corporate Scorecard” report, as shown in FIG. 89; an “Impact” report, as shown in FIG. 90; a “List of Projects” report, as shown in FIG. 91; a “Project Scope” report, as shown in FIG. 92; a “Project Status” report, as shown in FIG. 93; a “Selected Solution Breakout” report, as shown in FIG. 94; a “Strategic Alignment” report, as shown in FIG. 95; and a “Support” report, as shown in FIG. 96. These reports facilitate the ability of the management of the organization to monitor the progress of specific performance improvement projects, compare key projects, and aggregate data associated with one or more projects.

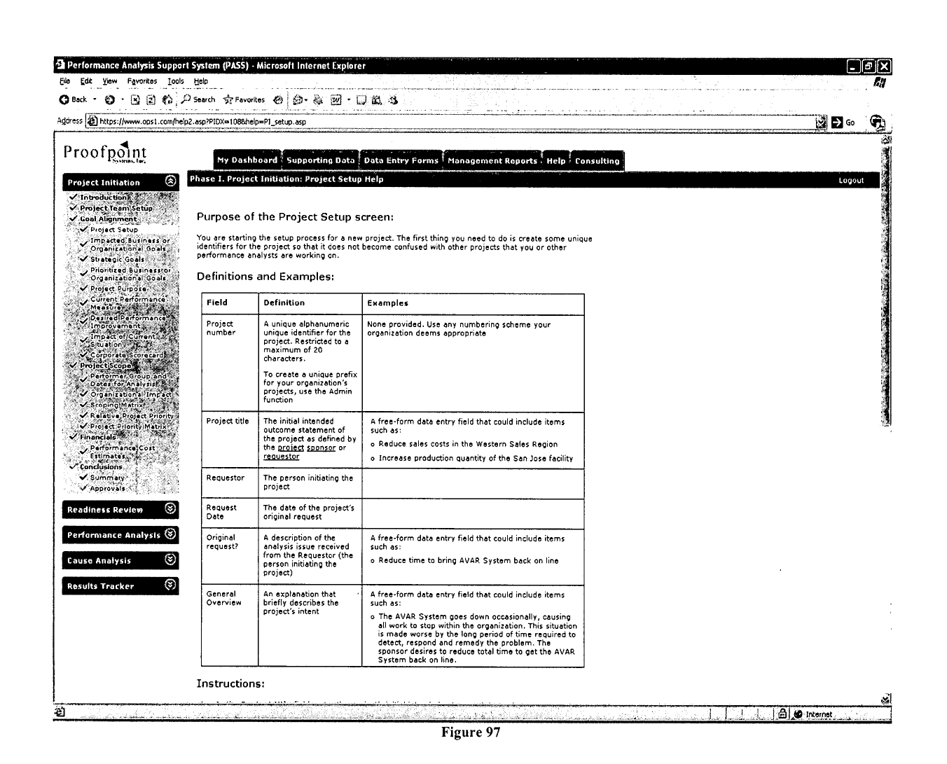

As shown in FIGS. 3 through 75, the dashboard and other screens include a “Help” tab. The user positions the cursor of the mouse 6 on the “Help” tab and clicks the left mouse button to access help, as shown in FIG. 97. The help displayed corresponds to the current page that the user is accessing. This feature helps users complete the steps and enter data associated with each screen.

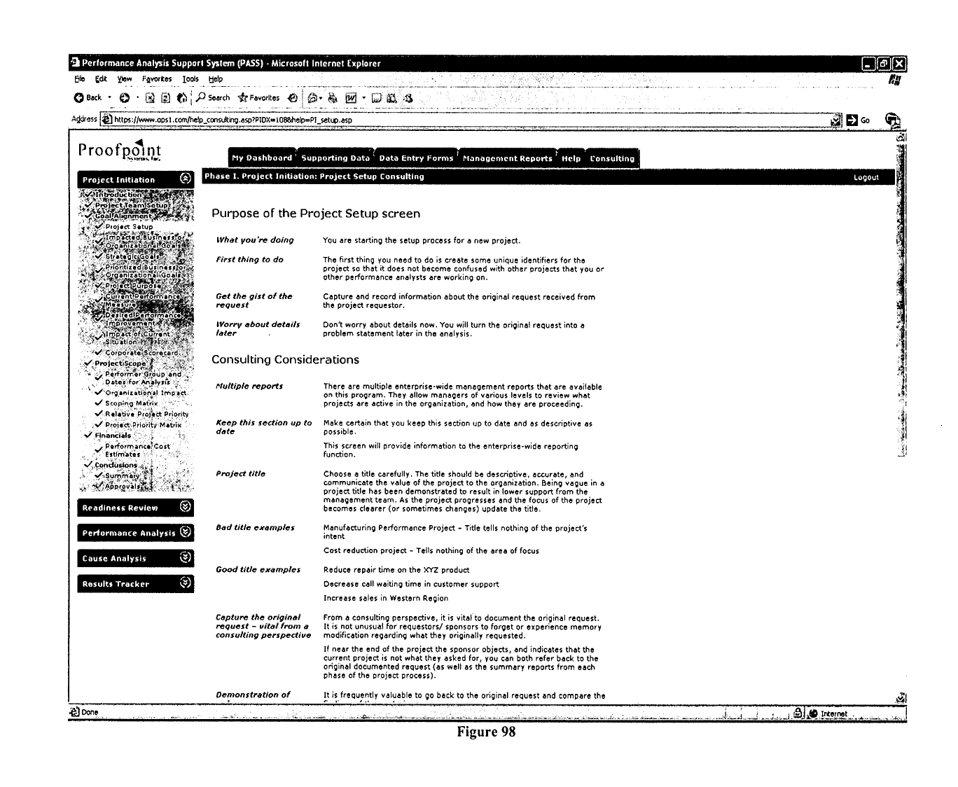

As shown in FIGS. 3 through 75, the dashboard and other screens include a “Consulting” tab. The user positions the cursor of the mouse 6 on the “Consulting” tab and clicks the left mouse button to access project setup consulting, as shown in FIG. 98. The consulting displayed corresponds to the current page that the user is accessing. This feature helps internal employees better serve in the role of analyst or internal consultant, reduces training and orientation time, and increases commonality of thought, process, and language associated with a key organizational function.

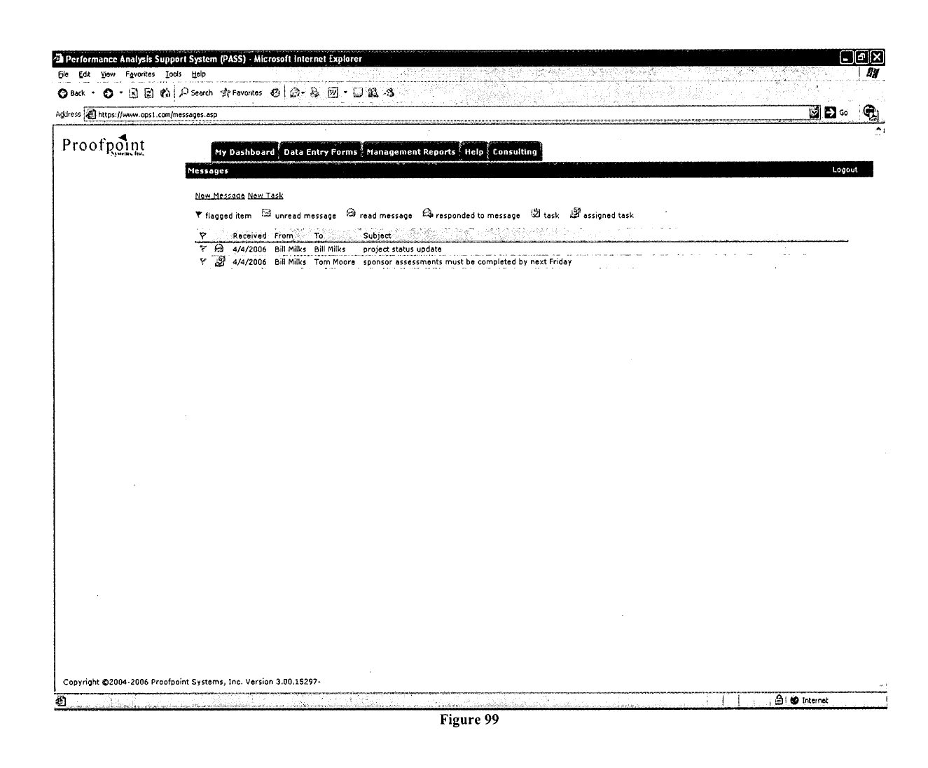

As shown in FIG. 3, the dashboard includes the “My Messages” section and a link to “go to messages.” The user positions the cursor of the mouse 6 on the “go to messages” link and clicks the left mouse button to access his or her messages, as shown in FIG. 99. Messages sent to the user and “Tasks” assigned to or assigned by the user are displayed. Messages or tasks that are overdue are “flagged.” A graphical image indicates the type of item, including “unread message,” “read message,” “responded to message,” “task,” and “assigned task.” To see detailed information about an item, the user positions the cursor of the mouse 6 on the line containing the message or task and clicks the left mouse button. From the “Messages” page, the user can also create a “New Message” or a “New Task.”

The value of the performance analysis support system and method in providing a structured, repeatable approach in analyzing a performance improvement project is enormous. Having an accurate understanding of performance issues can enable project sponsors and stakeholders to very quickly respond to a project's schedule. The assessment of performance issues in accordance with the performance analysis support system and method of the present invention based on objective metrics improves a team's ability to deliver solutions on time and on budget.

The performance analysis support system and method in accordance with the present invention use management decision support tools to enable project sponsors and stakeholders to make predictions and assessments during the analysis process. The performance analysis support system and method in accordance with the present invention provide a real-time view into the status and progress of a performance improvement project and make recommendations for remediation at a highly granular level.

The performance analysis support system 1 uses data to produce analysis, risk factors, and suggested risk remediation. The project's data are used as the baseline for ongoing verification and reporting of the project.

In summary, businesses have struggled for decades to solve performance problems on time and within budget with very little success. The fundamental cause for this is the lack of an objective, verifiable view into the process. The performance analysis support system 1 provides teams with a new tool to understand, manage, and deliver performance improvement with significant savings in time and effort.

While the foregoing description has been with reference to particular embodiments of the present invention, it will be appreciated by those skilled in the art that changes in these embodiments may be made without departing from the principles and spirit of the invention. For example, as shown in FIG. 3, the user may position the cursor of the mouse 6 on “new QuickPASS” and click the left mouse button to initiate an abbreviated analysis of a performance issue, which is less rigorous than the process described above, e.g., the abbreviated analysis may not require determination of data sources and entry of supporting data. Accordingly, the scope of the present invention can only be ascertained with reference to the appended claims.

What is claimed is:

1. A performance analysis support system for recommending one or more solutions to a performance issue, comprising computer software executed on a computer system for enabling a user to perform a project initiation phase to document an original request for improvement of a performance issue; for setting up an analysis team; for prioritizing business goals that are directly impacted when the performance issue is successfully addressed; for specifying a specific purpose to address the performance issue; and for establishing a project intent to deal with the performance issue.

2. The system of claim 1 wherein the specific purpose is defined as a decrease or increase of a metric.

3. The system of claim 1 wherein prioritizing the business goals includes aligning business goals with strategic goals.

4. The system of claim 1 wherein specifying a specific purpose assures that the purpose is consistent with aligned business and strategic goals.

5. The system of claim 1, further comprising computer software for enabling the user to complete a readiness assessment of personnel and of the organization during a readiness review phase.

6. The system of claim 5, further comprising computer software for collecting supporting data used in a performance analysis during a performance analysis phase.

7. The system of claim 6, further comprising computer software for completing a cause analysis of the performance issue to determine a problem; for determining barriers to successful performance; for defining one or more recommended solutions to address the performance issue associated with the problem and its impact benefit to the organization; and for documenting and validating the solutions during a cause analysis phase.

8. The system of claim 1 wherein the computer software provides a scoping matrix summary describing the complexity of a problem in which project intent is defined during the project initiation phase, and further comprising computer software for analyzing organizational impact, cost of the problem, and priority placed on the project by a requestor/initiating sponsor.

9. The system of claim 8, further comprising computer software for assessing readiness of a project team to make the change by assessing sponsors, stakeholders, and the organization during the readiness review phase.

10. The system of claim 9, further comprising computer software for assessing project risk and creating a risk mitigation plan; estimating a budget; projecting constraints that may prevent performing an analysis; and estimating costs for performing the analysis during the readiness review phase.

11. The system of claim 1, further comprising computer software for orchestrating determining data used in the performance analysis.

12. The system of claim 1 wherein the computer system comprises a Web-based computer system accessed via the Web or Internet using a browser.

13. The system of claim 12 wherein the browser comprises Microsoft Internet Explorer 6.0 or greater.

14. The system of claim 1 wherein the computer system comprises a networked computer system hosting an application developed with active server page(s) (ASP) code together with a SQL server database hosted and accessed via Microsoft Internet Explorer 6.0 or greater and available for Microsoft XP® and other operating systems.

15. The system of claim 1, further comprising built-in calculators, on-demand guidance, and graphic displays of automatically generated measures and metrics to aid making decisions.

16. The system of claim 1, further comprising computer software for auto-generating reports and summaries provided for distribution to team members and executives.

17. The system of claim 1, further comprising computer software for providing an expert reasoning subsystem to evaluate data to arrive at one or more recommended potential solutions.
